(19) United States
(12) Patent Application Publication
(10) Pub. No.: US 2013/0229396 A1
(43) Pub. Date: Sep. 5, 2013

(54) SURFACE AWARE, OBJECT AWARE, AND IMAGE AWARE HANDHELD PROJECTOR

(71) Applicant: Kenneth J. Huebner, Milwaukee, WI (US)

(72) Inventor: Kenneth J. Huebner, Milwaukee, WI (US)

(21) Appl. No.: 13/412,005

(22) Filed: Mar. 5, 2012

(51) Int. Cl. G09G 5/00

(52) U.S. Cl. 345/207

(57) ABSTRACT

A handheld image projecting device that modifies a visible image being projected based upon the position, orientation, and shape of remote surfaces, remote objects like a user's hand making a gesture, and/or images projected by other image projecting devices. The handheld projecting device utilizes at least one illuminated position indicator for 3D depth sensing of remote surfaces and optically indicating the location of its projected visible image. In some embodiments, a handheld projecting device enables a plurality of projected visible images to interact, often combining the visible images, reducing image distortion on multi-planar surfaces, and creating life-like graphic effects for a uniquely interactive, multimedia experience.

### FIELD OF THE DISCLOSURE

The present disclosure generally relates to handheld image projectors. In particular, the present disclosure relates to handheld image projecting devices that modify the visible image being projected based upon the position, orientation, and shape of remote surfaces, remote objects, and/or images projected by other image projecting devices.

### BACKGROUND OF THE INVENTION

There are many types of interactive video systems that allow a user to move a handheld controller device, which results in a displayed image to be modified. One type of highly popular video system is the WHO game machine and device manufactured by Nintendo, Inc. of Japan. This game system enables a user to interact with a video game by swinging a wireless device through the air. However, this type of game system requires a game machine, graphic display, and a sensing device to allow the player to interact with the display, often fixed to a wall or tabletop.

Further, manufacturers are currently making compact image projectors, often referred to as pico projectors, which can be embedded into handheld devices, such as mobile phones, portable projectors, and digital cameras. However, these projectors tend to only project images, rather than engage users with gesture aware, interactive images.

Currently marketed handheld projectors are often not aware of their environment and are therefore limited. For example, a typical handheld projector, when held at an oblique angle to a wall surface, creates a visible image having keystone distortion (a distorted wedge shape), among other types of distortion on curved or multi-planar surfaces. Such distortion is highly distracting when multiple handheld projecting devices are aimed at the same remote surface from different vantage points. Image brightness may be further non-uniform with hotspots for an unrealistic appearance.

Therefore, an opportunity exists to utilize handheld projecting devices that are surface aware, object aware, and image aware to solve the limitations of current art. Moreover, an opportunity exists for handheld projectors in combination with image sensors such that a handheld device can interact with remote surfaces, remote objects, and other projected images to provide a uniquely interactive, multimedia experience.

### SUMMARY

The present disclosure generally relates to handheld projectors. In particular, the present disclosure relates to handheld image projecting devices that have the ability to modify the visible image being projected based upon the position, orientation, and shape of remote surfaces, remote objects like a user's hand making a gesture, and projected images from other devices. The handheld projecting device may utilize an illuminated position indicator for 3D depth sensing of its environment, enabling a plurality of projected images to interact, correcting projected image distortion, and promoting hand gesture sensing.

For example, in some embodiments, a handheld projector creates a realistic 3D virtual world illuminated in a user's living space, where a projected image moves undistorted across a plurality of remote surfaces, such as a wall and a ceiling. In other embodiments, multiple users with handheld projectors may interact, creating interactive and undistorted images, such as two images of a dog and cat playing together. In other embodiments, multiple users with handheld projectors may interact, creating combined and undistorted images, irrespective of the angle of projection.

In at least one embodiment, a handheld projecting device may be comprised of a control unit that is operable to modify a projected visible image based upon the position, orientation, and shape of remote surfaces, remote objects, and projected images from other projecting devices. In certain embodiments, a handheld image projecting device includes a microprocessor-based control unit that is operatively coupled to a compact image projector for projecting an image from the device. Some embodiments of the device may utilize an integrated color and infrared (color-IR) image projector operable to project a “full-color” visible image and infrared invisible image. Certain other embodiments of the device may use a standard color image projector in conjunction with an infrared indicator projector. Yet other embodiments of the device may simply utilize visible light from a color image projector.

In some embodiments, a projecting device may further be capable of 3D spatial depth sensing of the user's environment. The device may create at least one position indicator (or pattern of light) for 3D depth sensing of remote surfaces. In some embodiments, a device may project an infrared position indicator (or pattern of infrared invisible light). In other embodiments, a device may project a user-imperceptible position indicator (or pattern of visible light that cannot be seen by a user). Certain embodiments may utilize an image projector to create the position indicator, while other embodiments may rely on an indicator projector.

Along with generating light, in some embodiments, a handheld projecting device may also include an image sensor and computer vision functionality for detecting an illuminated position indicator from the device and/or from other devices. The image sensor may be operatively coupled to the control unit such that the control unit can respond to the remote surface, remote objects, and/or other projected images in the vicinity. Hence, in certain embodiments, a handheld projecting device with an image sensor may be operable to observe a position indicator and create a 3D depth map of one or more remote surfaces (i.e., a wall, etc.) and remote objects (i.e., a user hand making a gesture) in the environment. In some embodiments, a handheld projecting device with an image sensor may be operable to observe a position indicator for sensing projected images from other devices.

In at least one embodiment, a handheld projecting device may include a motion sensor (e.g., accelerometer) affixed to the device and operable to generate a movement signal received by the control unit that is based upon the movement of the device. Based upon the sensed movement signals from the motion sensor, the control unit may modify the image from the device in accordance to the movement of the image projecting device relative to remote surfaces, remote objects, and/or projected images from other devices.

In some embodiments, wireless communication among a plurality of handheld projecting devices may enable the devices to interact. Whereby, a plurality of handheld projecting devices may modify their projected images such that the images appear to interact. Such images may be further modified and keystone corrected. Whereby, in certain embodiments, a plurality of handheld projecting devices located at different vantage points may create a substantially undistorted and combined image.

### BRIEF DESCRIPTION OF THE DRAWINGS

The drawings illustrate exemplary embodiments presently contemplated of carrying out the present disclosure. In the drawings:

FIG. 1 is a perspective view of a first embodiment of a color-IR handheld projecting device, illustrating its front end.

FIG. 2 is a perspective view of the projecting device of FIG. 1, where the device is being held by a user and is projecting a visible image.

FIG. 3 is a block diagram of the projecting device of FIG. 1, showing components.

FIG. 4A is a block diagram of a DLP-based color-IR image projector.

FIG. 4B is a block diagram of a LCOS-based color-IR image projector.

FIG. 4C is a block diagram of a laser-based color-IR image projector.

FIG. 5 is a diagrammatic top view showing a projecting device having a projector beam that converges with a camera view axis.

FIG. 6A is a diagrammatic top view of the projecting device of FIG. 1, having a camera view axis that substantially converges with a projector axis on the x-z plane.

FIG. 6B is a diagrammatic side view of the projecting device of FIG. 1, having a camera view axis that substantially converges with a projector axis on the y-z plane.

FIG. 6C is a diagrammatic front view of the projecting device of FIG. 1, where a camera view axis that substantially converges with a projector axis on both the x-z plane and y-z plane.

FIG. 7 is a top view of the projecting device of FIG. 1, where a light view angle is substantially similar to a light projection angle.

FIG. 8 is a perspective view of two projecting devices similar to the device of FIG. 7.

FIG. 9 is a top view of a projecting device, where a light view angle is substantially larger than a visible and infrared light projection angle.

FIG. 10 is a perspective view of two projecting devices similar to the device of FIG. 9.

FIG. 11 is a top view of a projecting device, where a light view angle is substantially larger than a visible light projection angle.

FIG. 12 is a perspective view of two projecting devices similar to the device of FIG. 11.

FIG. 13 is a perspective view of the projecting device of FIG. 1, wherein the device is using a position indicator for spatial depth sensing.

FIG. 14 is an elevation view of a captured image of the projecting device of FIG. 1, wherein the image contains a position indicator.

FIG. 15 is a detailed elevation view of a multi-sensing position indicator, used by the projecting device of FIG. 1.

FIG. 16 is an elevation view of a collection of alternative position indicators.

FIG. 17A is a perspective view of a projecting device sequentially illuminating, multiple position indicators.

FIG. 17B is a perspective view of a projecting device sequentially illuminating, multiple position indicators.

FIG. 18 is a flowchart of a computer readable method of the projecting device of FIG. 1, wherein the method describes high-level operations of the device.

FIG. 19 is a flowchart of a computer readable method of the projecting device of FIG. 1, wherein the method describes illuminating and capturing an image of a position indicator.

FIG. 20 is a flowchart of a computer readable method of the projecting device of FIG. 1, wherein the method describes spatial depth analysis using a position indicator.

FIG. 21 is a flowchart of a computer readable method of the projecting device of FIG. 1, wherein the method describes the creation of 2D surfaces and 3D objects.

FIG. 22A is a perspective view showing projected visible image distortion.

FIG. 22B is a perspective view showing projected visible images that are devoid of distortion.

FIG. 23 is a perspective view of the projecting device of FIG. 1, showing a projection region on a remote surface.

FIG. 24 is a perspective view of the projecting device of FIG. 1, showing a projected visible image on a remote surface.

FIG. 25 is a flowchart of a computer readable method of the projecting device of FIG. 1, wherein the method describes a means to substantially reduce image distortion.

FIG. 26A is a perspective view (of position indicator light) of the projecting device of FIG. 1, wherein a user is making a hand gesture.

FIG. 26B is a perspective view (of visible image light) of the projecting device of FIG. 1, wherein a user is making a hand gesture.

FIG. 27 is a flowchart of a computer readable method of the projecting device of FIG. 1, wherein the method enables the device to detect a hand gesture.

FIG. 28A is a perspective view (of position indicator light) of the projecting device of FIG. 1, wherein a user is making a touch hand gesture on a remote surface.

FIG. 28B is a perspective view (of visible image light) of the projecting device of FIG. 1, wherein a user is making a touch hand gesture on a remote surface.

FIG. 29 is a flowchart of a computer readable method of the projecting device of FIG. 1, wherein the method enables the device to detect a touch hand gesture.

FIG. 30 is a sequence diagram of two projecting devices of FIG. 1, wherein both devices create projected visible images that appear to interact.

FIG. 31A is a perspective view of two projecting devices of FIG. 1, wherein a first device is illuminating a position indicator and detecting at least one remote surface.

FIG. 31B is a perspective view of two projecting devices of FIG. 1, wherein a first device is illuminating a position indicator and a second device is detecting a projected image.

FIG. 32 is a perspective view of the projecting device of FIG. 1, illustrating the device's spatial orientation.

FIG. 33A is a perspective view of two projecting devices of FIG. 1, wherein a second device is illuminating a position indicator and detecting at least one remote surface.

FIG. 33B is a perspective view of two projecting devices of FIG. 1, wherein a second device is illuminating a position indicator and a first device is detecting a projected image.

FIG. 34 is a flowchart of a computer readable method of the projecting device of FIG. 1, wherein the method enables the device to detect a position indicator from another device.

FIG. 35 is a perspective view of two projecting devices of FIG. 1, wherein each device determines a projection region on a remote surface.

FIG. 36 is a perspective view of two projecting devices of FIG. 1, wherein both devices are projecting images that appear to interact.

FIG. 37 is a perspective view of a plurality of projecting devices of FIG. 1, wherein the projected visible images are combined.

FIG. 38 is a perspective view of a second embodiment of a color-IR-separated handheld projecting device, illustrating its front end.

FIG. 39 is a block diagram of the projecting device of FIG. 38, showing components.

FIG. 40A is a diagrammatic top view of the projecting device of FIG. 38, having a camera view axis that substantially converges with a projector axis on the x-z plane.

FIG. 40B is a diagrammatic side view of the projecting device of FIG. 38, having a camera view axis that substantially converges with a projector axis on the y-z plane.

FIG. 40C is a diagrammatic front view of the projecting device of FIG. 38, where a camera view axis that substantially converges with a projector axis on both the x-z plane and y-z plane.

FIG. 41 is a top view of the projecting device of FIG. 38, where a light view angle is substantially larger than a visible and infrared light projection angle.

FIG. 42 is a perspective view of two projecting devices similar to the device of FIG. 41.

FIG. 43 is a top view of a projecting device, where a light view angle is substantially similar to a light projection angle.

FIG. 44 is a perspective view of two projecting devices similar to the device of FIG. 43.

FIG. 45A is a perspective view of an infrared indicator projector of the projecting device of FIG. 38, with an optical filter.

FIG. 45B is an elevation view of an optical filter of the infrared indicator projector of FIG. 45A.

FIG. 45C is a section view of the infrared indicator projector of FIG. 45A.

FIG. 46A is a perspective view of an infrared indicator projector of a projecting device, with an optical medium.

FIG. 46B is an elevation view of an optical medium of the infrared indicator projector of FIG. 46A.

FIG. 46C is a section view of the infrared indicator projector of FIG. 46A.

FIG. 47A is a block diagram of a DLP-based infrared projector.

FIG. 47B is a block diagram of a LCOS-based infrared projector.

FIG. 47C is a block diagram of a laser-based infrared projector.

FIG. 48 is a perspective view of the projecting device of FIG. 38, wherein the device utilizes a multi-resolution position indicator for spatial depth sensing.

FIG. 49 is an elevation view of a captured image from the projecting device of FIG. 38, wherein the image contains a position indicator.

FIG. 50 is a detailed elevation view of a multi-resolution position indicator, used by the projecting device of FIG. 38.

FIG. 51 is a perspective view of a third embodiment of a color-interleave handheld projecting device, illustrating its front end.

FIG. 52 is a block diagram of the projecting device of FIG. 51, showing components.

FIG. 53 is a diagrammatic view of the projecting device of FIG. 51, showing interleaving of image and indicator display frames.

FIG. 54 is a perspective view of a fourth embodiment of a color-separated handheld projecting device, illustrating its front end.

FIG. 55 is a block diagram of the projecting device of FIG. 54, showing components.

FIG. 56 is a diagrammatic view of the projecting device of FIG. 54, showing interleaving of image and indicator display frames.

### DETAILED DESCRIPTION OF THE INVENTION

One or more specific embodiments will be discussed below. In an effort to provide a concise description of these embodiments, not all features of an actual implementation are described in the specification. It should be appreciated that when actually implementing embodiments of this invention, as in any product development process, many decisions must be made. Moreover, it should be appreciated that such a design effort could be quite labor intensive, but would nevertheless be a routine undertaking of design and construction for those of ordinary skill having the benefit of this disclosure. Some helpful terms of this discussion will be defined:

The terms “a”, “an”, and “the” refers to one or more items. Where only one item is intended, the terms “one”, “single”, or similar language is used. Also, the term “includes” means “comprises”. The term “and/or” refers to any and all combinations of one or more of the associated list items.

The terms “adapter”, “analyzer”, “application”, “circuit”, “component”, “control”, “interface”, “method”, “module”, “program”, and like terms are intended to include hardware, firmware, and/or software.

The term “barcode” refers to any optical machine-readable representation of data, such as one-dimensional (1D) or two-dimensional (2D) barcodes, or symbols.

The terms “computer readable medium” or the like refers to any kind of medium for retaining information in any form or combination of forms, including various kinds of storage devices (e.g., magnetic, optical, and/or solid state, etc.). The term “computer readable medium” also encompasses transitory forms of representing information, including various hardwired and/or wireless links for transmitting the information from one point to another.

The term “haptic” refers to tactile stimulus presented to a user, often provided by a vibrating or haptic device when placed near the user's skin. A “haptic signal” refers to a signal that activates a haptic device.

The terms “key”, “keypad”, “key press”, and like terms are meant to broadly include all types of user input interfaces and their respective action, such as, but not limited to, a gesture-sensitive camera, a touch pad, a keypad, a control button, a trackball, and/or a touch sensitive display.

The term “multimedia” refers to media content and/or its respective sensory action, such as, but not limited to, video, graphics, text, audio, haptic, user input events, program instructions, and/or program data.

The term “operatively coupled” refers to a wireless and/or a wired means of communication between items, unless otherwise indicated. The term “wired” refers to any type of physical communication conduit (e.g., electronic wire, trace, optical fiber, etc.). Moreover, the term “operatively coupled” may further refer to a direct coupling between items and/or an indirect coupling between items via an intervening item or items (e.g., an item includes, but not limited to, a component, a circuit, a module, and/or a device).

The term “optical” refers to any type of light or usage of light, both visible (e.g. white light) and/or invisible light (e.g., infrared light), unless specifically indicated.

The present disclosure illustrates examples of operations and methods used by the various embodiments described. Those of ordinary skill in the art will readily recognize that certain steps or operations described herein may be eliminated, taken in an alternate order, and/or performed concurrently. Moreover, the operations may be implemented as one or more software programs for a computer system and encoded in a computer readable medium as instructions executable on one or more processors. The software programs may also be carried in a communications medium conveying signals encoding the instructions. Separate instances of these programs may be executed on separate computer systems. Thus, although certain steps have been described as being performed by certain devices, software programs, processes, or entities, this need not be the case and a variety of alternative implementations will be understood by those having ordinary skill in the art.

The following detailed description refers to the accompanying drawings. The same reference numbers in different drawings may identify the same or similar elements.

### Color-IR Handheld Projecting Device

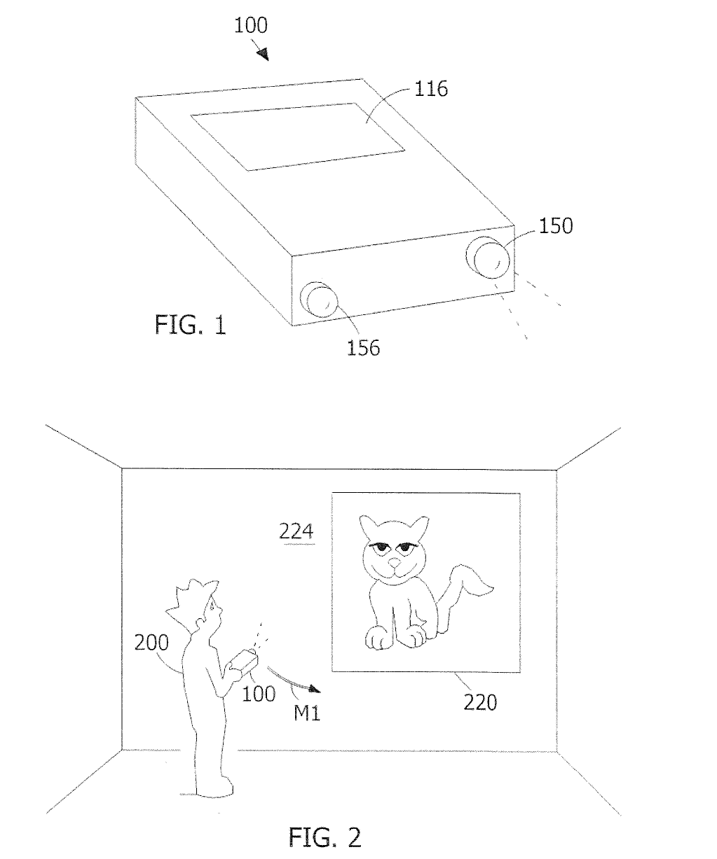

FIGS. 1 and 2 show perspective views of a first embodiment of the disclosure, referred to as a color-IR handheld projecting device 100. FIG. 2 shows the handheld projecting device 100, which may be compact and mobile, grasped and moved through 3D space (as shown by arrow MO, such as by a user 200 holding and moving the device 100. The device 100 may enable a user to make interactive motion and/or aim-and-click gestures relative to one or more remote surfaces in the user's environment. Device 100 may alternatively be attached to a user's clothing or body and worn as well. As shown, the projecting device 100 is illuminating a visible image 220 on a remote surface 224, such as a wall. Remote surface 224 may be representative of any type of physical surface (such as planar, non-planar, curved, or multi-planar surface) within the user's environment, such as, but not limited to, a wall, ceiling, floor, tabletop, chair, lawn, sidewalk, tree, and/or other surfaces in the user's environment, both indoors and outdoors.

Thereshown in FIG. 1 is a close-up, perspective view of the handheld projecting device 100, comprising a color-IR image projector 150, an infrared image sensor 156, and a user interface 116, as discussed below.

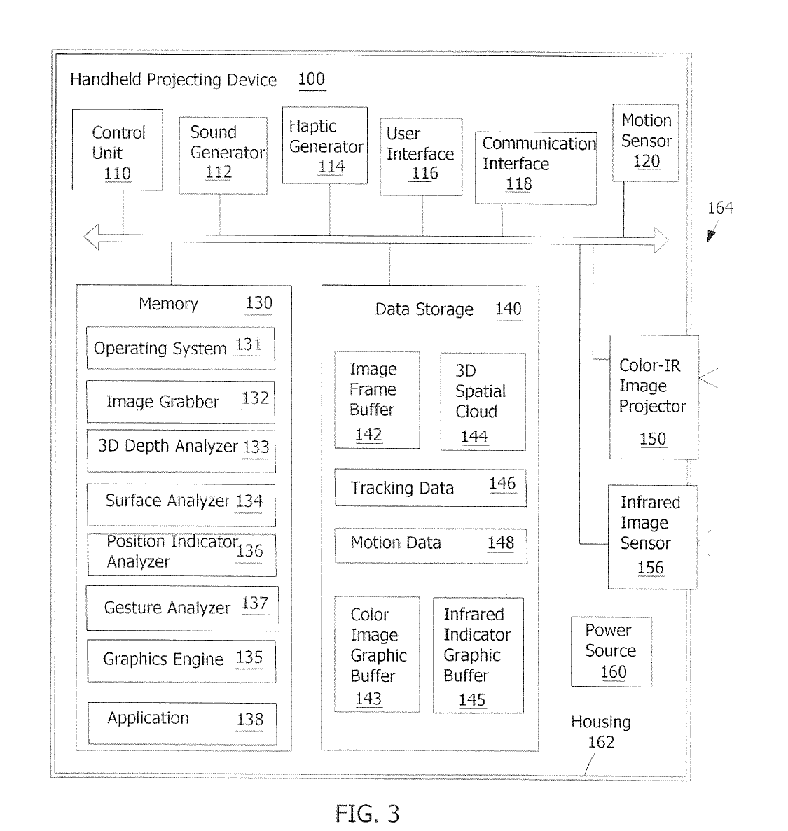

FIG. 3 presents a block diagram of components of the color-IR handheld projecting device 100, which may be comprised of, but not limited to, an outer housing 162, a control unit 110, a sound generator 112, a haptic generator 114, the user interface 116, a communication interface 118, a motion sensor 120, the color-IR image projector 150, the infrared image sensor 156, a memory 130, a data storage 140, and a power source 160.

The outer housing 162 may be of handheld size (e.g., 70 mm wide×110 mm deep×20 mm thick) and made of, for example, easy to grip plastic. The housing 162 may be constructed in any shape, such as a rectangular shape (as in FIG. 1) as well as custom shaped, such as a tablet, steering wheel, rifle, gun, golf club, or fishing reel.

Affixed to a front end 164 of device 100 is the color-IR image projector 150, which may be operable to, but not limited to, project a “full-color” (e.g., red, green, blue) image of visible light and at least one position indicator of invisible infrared light on a remote surface. Projector 150 may be of compact size, such as a pico projector or micro projector. The color-IR image projector 150 may be comprised of a digital light processor (DLP)-, a liquid-crystal-on-silicon (LCOS)-, or a laser-based color-IR image projector, although alternative color-IR image projectors may be used as well. The projector 150 may be operatively coupled to the control unit 110 such that the control unit 110, for example, may generate and transmit color image and infrared graphic data to projector 150 for display. In some alternative embodiments, a color image projector and an infrared indicator projector may be integrated and integrally form the color-IR image projector 150.

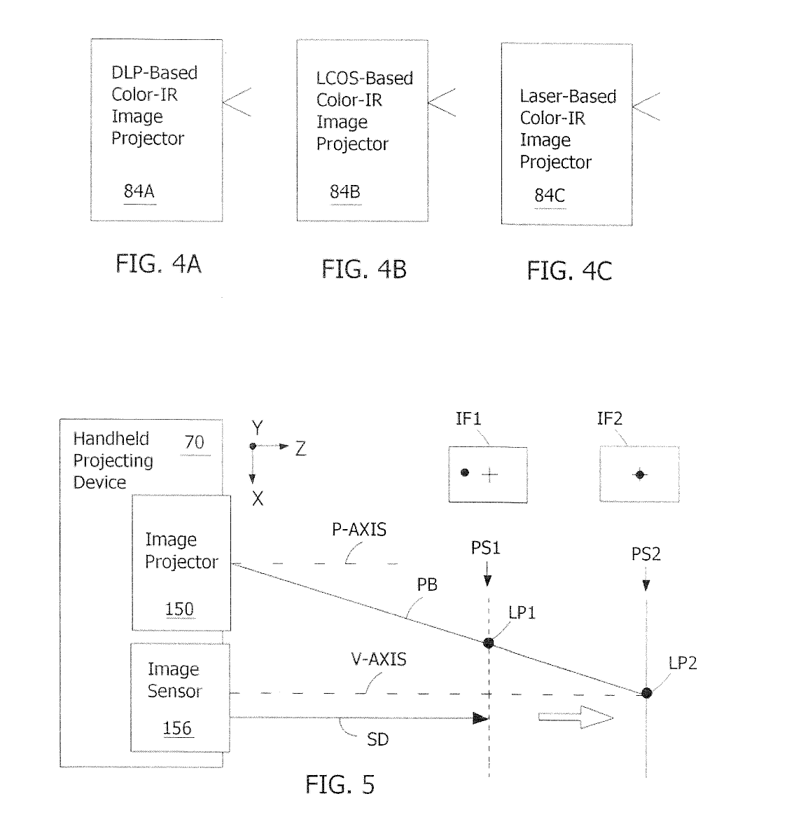

FIGS. 4A-4C show some examples of color-IR image projectors. Although at present day, color-IR image projectors appear to be unavailable or in limited supply, current art suggests that such projectors are feasible to build and may be forthcoming in the future. FIG. 4A shows a DLP-based color-IR image projector 84A. For example, Texas Instruments, Inc. of USA creates DLP technology. In FIG. 4B, a LCOS-based color-IR image projector 84B is shown. For example, Optoma Technologies, Inc, of USA constructs LCOS-based projectors. In FIG. 4C, a laser-based color-IR image projector 84C is shown. For example, Microvision, Inc. of USA builds laser-based projectors.

Turning back to FIG. 3, the projecting device 100 includes the infrared image sensor 156 affixed to device 100, wherein sensor 156 is operable to detect a spatial view outside of device 100. Moreover, sensor 156 may be operable to capture one or more image frames (or light views). Image sensor 156 is operatively coupled to control unit 110 such that control unit 110, for example, may receive and process captured image data. Sensor 156 may be comprised of at least one of a photo diode-, a photo detector-, a photo detector array-, a complementary metal oxide semiconductor (CMOS)-, a charge coupled device (CCD)-, or an electronic camera-based image sensor that is sensitive to at least infrared light, although other types, combinations, and/or numbers of image sensors may be considered. In some embodiments, sensor 156 may be a 3D depth camera, often referred to as a ranging, lidar, time-of-flight, stereo pair, or RGB-D camera, which creates a 3D spatial depth light view. In the current embodiment, infrared image sensor 156 may be comprised of a CMOS- or a CCD-based video camera that is sensitive to at least infrared light. Moreover, image sensor 156 may optionally contain an infrared pass-band filter, such that only infrared light is sensed (while other light, such as visible light, is blocked from view). The image sensor 156 may optionally contain a global shutter or high-speed panning shutter for reduced image motion blur.

The motion sensor 120 may be affixed to the device 100, providing inertial awareness. Whereby, motion sensor 120 may be operatively coupled to control unit 110 such that control unit 110, for example, may receive spatial position and/or movement data. Motion sensor 120 may be operable to detect spatial movement and transmit a movement signal to control unit 110. Moreover, motion sensor 120 may be operable to detect a spatial position and transmit a position signal to control unit 110. The motion sensor 120 may be comprised of one or more spatial sensing components, such as an accelerometer, a magnetometer (e.g., electronic compass), a gyroscope, a spatial triangulation sensor, and/or a global positioning system (UPS) receiver, as illustrative examples. Advantages exist for motion sensing in 3D space; wherein a 3-axis accelerometer and/or a 3-axis gyroscope may be utilized.

The user interface 116 may provide a means for a user to input information to the device 100. For example, the user interface 116 may generate one or more user input signals when a user actuates (e.g., presses, touches, taps, hand gestures, etc.) the user interface 116. The user interface 116 may be operatively coupled to control unit 110 such that control unit 110 may receive one or more user input signals and respond accordingly. User interface 116 may be comprised of, but not limited to, one or more control buttons, keypads, touch pads, rotating dials, trackballs, touch-sensitive displays, and/or hand gesture-sensitive devices.

The communication interface 118 provides wireless and/or wired communication abilities for device 100. Communication interface 118 is operatively coupled to control unit 110 such that control unit 110, for example, may receive and transmit data. Communication interface 118 may be comprised of, but not limited to, a wireless transceiver, data transceivers, processing units, codecs, and/or antennae, as illustrative examples. For wired communication, interface 118 provides one or more wired interface ports (e.g., universal serial bus (USB) port, a video port, a serial connection port, an IEEE-1394 port, an Ethernet or modem port, and/or an AC/DC power connection port). For wireless communication, interface 118 may use modulated electromagnetic waves of one or more frequencies (e.g., RF, infrared, etc.) and/or modulated audio waves of one or more frequencies (e.g., ultrasonic, etc.). Interface 118 may use various wired and/or wireless communication protocols (e.g., TCP/IP, WiFi, Zigbee, Bluetooth, Wireless USB, Ethernet, Wireless Home Digital Interface (WHDI), Near Field Communication, and/or cellular telephone protocol).

The sound generator 112 provides device 100 with audio or sound generation capability. Sound generator 112 is operatively coupled to control unit 110, such that control unit 110, for example, can control the generation of sound from device 100. Sound generator 112 may be comprised of, but not limited to, audio processing units, audio codecs, audio synthesizer, and/or at least one sound generating element, such as a loudspeaker.

The haptic generator 114 provides device 100 with haptic signal generation and output capability. Haptic generator 114 may be operatively coupled to control unit 110 such that control unit 110, for example, may control and enable vibration effects of device 100. Haptic generator 114 may be comprised of but not limited to, vibratory processing units, codecs, and/or at least one vibrator (e.g., mechanical vibrator).

The memory 130 may be comprised of computer readable medium, which may contain, but not limited to, computer readable instructions. Memory 130 may be operatively coupled to control unit 110 such that control unit 110, for example, may execute the computer readable instructions. Memory 130 may be comprised of RAM, ROM, Flash, Secure Digital (SD) card, and/or hard drive, although other types of memory in whole, part, or combination may be used, including fixed and/or removable memory, volatile and/or nonvolatile memory.

Data storage 140 may comprised of computer readable medium, which may contain, but not limited to, computer related data. Data storage 140 may be operatively coupled to control unit 110 such that control unit 110, for example, may read data from and/or write data to data storage 140. Storage 140 may be comprised of RAM, ROM, Flash, Secure Digital (SD) card, and/or hard drive, although other types of memory in whole, part, or combination may be used, including fixed and/or removable, volatile and/or nonvolatile memory. Although memory 130 and data storage 140 are presented as separate components, some embodiments of the projecting device may use an integrated memory architecture, where memory 130 and data storage 140 may be wholly or partially integrated. In some embodiments, memory 130 and/or data storage 140 may wholly or partially integrated with control unit 110.

Affixed to device 100, the control unit 110 may provide computing capability for device 100, wherein control unit 110 may be comprised, for example, of at least one or more central processing units (CPU) having appreciable processing speed (e.g., 2 gHz) to execute computer instructions. Control unit 110 may include one or more processing units that are general-purpose and/or special purpose (e.g., multi-core processing units, graphic processor units, video processors, and/or related chipsets). The control unit 110 may be operatively coupled to, but not limited to, sound generator 112, haptic generator 114, user interface 116, communication interface 118, motion sensor 120, memory 130, data storage 140, color-IR image projector 150, and infrared image sensor 156. Although an architecture to connect components of device 100 has been presented, alternative embodiments may rely on alternative bus, network, and/or hardware architectures.

Finally, device 100 includes a power source 160, providing energy to one or more components of device 100. Power source 160 may be comprised, for example, of a portable battery and/or a power cable attached to an external power supply. In the current embodiment, power source 160 is a rechargeable battery such that device 100 may be mobile.

### Computer Implemented Methods of the Projecting Device

FIG. 3 shows memory 130 may contain various computer functions defined as computer implemented methods having computer readable instructions, such as, but not limited to, an operating system 131, an image grabber 132, a depth analyzer 133, a surface analyzer 134, a position indicator analyzer 136, a gesture analyzer 137, a graphics engine 135, and an application 138. Such functions may be implemented in software, firmware, and/or hardware. In the current embodiment, these functions may be implemented in memory 130 and executed by control unit 110.

The operating system 131 may provide device 100 with basic functions and services, such as read/write operations with the hardware, such as controlling the projector 150 and image sensor 156.

The image grabber 132 may be operable to capture one or more image frames from the image sensor 156 and store the image frame(s) in data storage 140 for future reference.

The depth analyzer 133 may provide device 100 with 3D spatial sensing abilities. Wherein, depth analyzer 133 may be operable to detect at least a portion of a position indicator on at least one remote surface and determine one or more spatial distances to the at least one remote surface. Depth analyzer may be comprised of, but not limited to, a time-of-flight-, stereoscopic-, or triangulation-based 3D depth analyzer that uses computer vision techniques. In the current embodiment, a triangulation-based 3D depth analyzer will be used.

The surface analyzer 134 may be operable to analyze one or more spatial distances to an at least one remote surface and determine the spatial position, orientation, and/or shape of the at least one remote surface. Moreover, surface analyzer 134 may also detect an at least one remote object and determine the spatial position, orientation, and/or shape of the at least one remote object.

The position indicator analyzer 136 may be operable to detect at least a portion of a position indicator from another projecting device and determine the position, orientation, and/or shape of the position indicator and projected image from the other projecting device. The position indicator analyzer 136 may optionally contain an optical barcode reader for reading optical machine-readable representations of data, such as illuminated 1D or 2D barcodes.

The gesture analyzer 137 may be able to analyze at an least one remote object and detect one or more hand gestures and/or touch hand gestures being made by a user (such as user 200 in FIG. 2) in the vicinity of device 100.

The graphics engine 135 may be operable to generate and render computer graphics dependent on, but not limited to, the location of remote surfaces, remote objects, and/or projected images from other devices.

Finally, the application 138 may be representative of one or more user applications, such as, but not limited to, electronic games or educational programs. Application 138 may contain multimedia operations and data, such as graphics, audio, and haptic information.

### Computer Readable Data of the Projecting Device

FIG. 3 also shows data storage 140 that includes various collections of computer readable data (or data sets), such as, but not limited to, an image frame buffer 142, a 3D spatial cloud 144, a tracking data 146, a color image graphic buffer 143, an infrared indicator graphic buffer 145, and a motion data 148. These data sets may be implemented in software, firmware, and/or hardware. In the current embodiment, these data sets may be implemented in data storage 140, which can be read from and/or written to (or modified) by control unit 110.

For example, the image frame buffer 142 may retain one or more captured image frames from the image sensor 156 for pending image analysis. Buffer 142 may optionally include a look-up catalog such that image frames may be located by type, time stamp, and other image attributes.

The 3D spatial cloud 144 may retain data describing, but not limited to, the 3D position, orientation, and shape of remote surfaces, remote objects, and/or projected images (from other devices). Spatial cloud 144 may contain geometrical figures in 3D Cartesian space. For example, geometric surface points may correspond to points residing on physical remote surfaces external of device 100. Surface points may be associated to define geometric 2D surfaces (e.g., polygon shapes) and 3D meshes (e.g., polygon mesh of vertices) that correspond to one or more remote surfaces, such as a wall, table top, etc. Finally, 3D meshes may be used to define geometric 3D objects (e.g., 3D object models) that correspond to remote objects, such as a user's hand.

Tracking data 146 may provide storage for, but not limited to, the spatial tracking of remote surfaces, remote objects, and/or position indicators. For example, device 100 may retain a history of previously recorded position, orientation, and shape of remote surfaces, remote objects (such as a user's hand), and/or position indicators defined in the spatial cloud 144. This enables device 100 to interpret spatial movement (e.g., velocity, acceleration, etc.) relative to external remote surfaces, remote objects (such as a hand making a gesture), and projected images from other devices.

The color image graphic buffer 143 may provide storage for image graphic data (e.g., red, green, blue) for projector 150. For example, application 138 may render off-screen graphics, such as a picture of a dragon, in buffer 143 prior to visible light projection by projector 150.

The infrared indicator graphic buffer 145 may provide storage for indicator graphic data for projector 150. For example, application 138 may render off-screen graphics, such as a position indicator or barcode, in buffer 145 prior to invisible, infrared light projection by projector 150.

The motion data 148 may be representative of spatial motion data collected and analyzed from the motion sensor 120. Motion data 148 may define, for example, in 3D space the spatial acceleration, velocity, position, and/or orientation of device 100.

### Example of 3D Depth Sensing of a Remote Surface

Turning now to FIG. 5, a diagrammatic top view is presented of a handheld projecting device 70, which illustrates an example of 3D depth sensing to a surface using the projector 150 and image sensor 156. Geometric triangulation will be described, although alternative 3D sensing techniques (e.g., time-of-flight, stereoscopic, etc.) may be utilized as well. To discuss some mathematical aspects, projector 150 has a project axis P-AXIS, which is an imaginary orthogonal line or central axis of the projected light cone angle (not shown). Moreover, the image sensor 156 has a view axis V-AXIS, which is an imaginary orthogonal line or central axis of the image sensor's view cone angle (not shown). The projector 150 and camera 156 are affixed to device 70 at predetermined locations.

FIG. 5 shows a remote surface PS1 situated forward of projector 150 and image sensor 156. In an example operation, projector 150 may illuminate a narrow projection beam P13 at an angle that travels from projector 150 outward to a light point LP1 that coincides on remote surface PS1. As can be seen, light point LP1 is not located on the view axis V-AXIS, but appears above it. This suggests that if the image sensor 156 captures an image of surface PS1, light point LP1 will appear offset from the center of the captured image, as shown by image frame IF1.

Then in another example operation, device 70 may be located at a greater distance from an ambient surface, as represented by a remote surface PS2. Now the illuminated projection beam PB travels at the same angle from projector 150 outward to a light point LP2 that coincides on remote surface PS2. As can be seen, light point LP2 is now located on view axis V-AXIS. This suggests that if the image sensor 156 captures an image of surface PS2, light point LP2 will appear in the center of the captured image, as shown by image frame IF2.

Hence, using computer vision techniques (e.g., structured light, geometric triangulation, projective geometry, etc.) adapted from current art, device 70 may be able to compute at least one spatial surface distance SD to a remote surface, such as surface PS1 or PS2.

### Configurations for 3D Depth Sensing

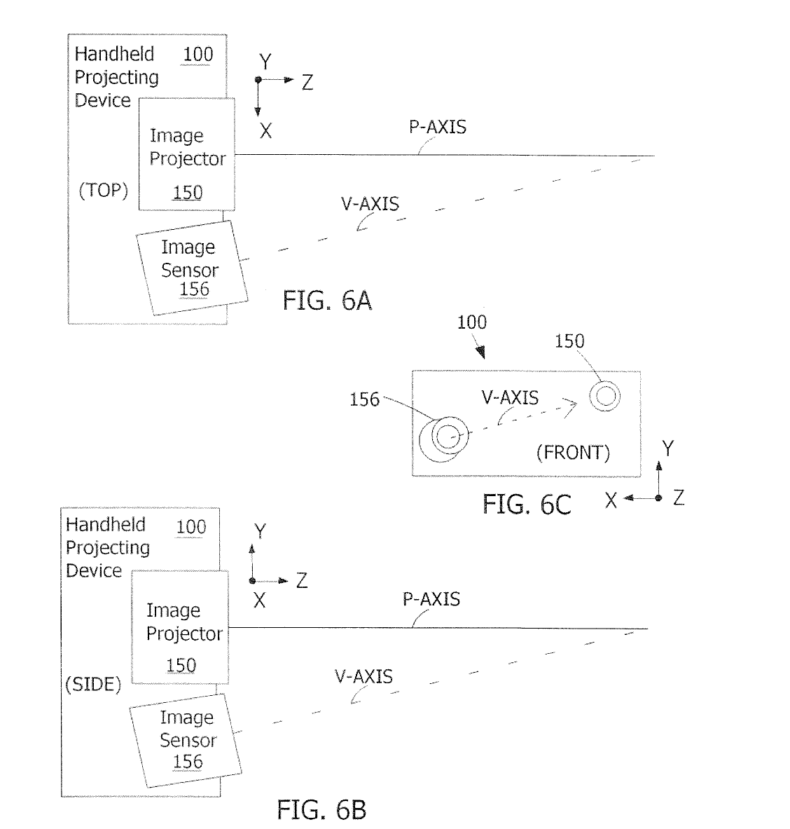

Turning now to FIGS. 6A-6C, there presented are diagrammatic views of an optional configuration of the projecting device 100 for improving precision and breadth of 3D depth sensing, although alternative configurations may work as well. The color-IR image projector 150 and infrared image sensor 156 are affixed to device 100 at predetermined locations.

FIG. 6A is a top view that shows image sensor's 156 view axis V-AXIS and projector's 150 projection axis P-AXIS are non-parallel along at least one dimension and may substantially converge forward of device 100. The image sensor 156 may be tilted (e.g., 2 degrees) on the x-z plane, increasing sensing accuracy. FIG. 6B is a side view that shows image sensor 156 may also be tilted (e.g., 1 degree) on the y-z plane. Whereby, FIG. 6C is a front view that shows image sensor's 156 view axis V-AXIS and projector's 150 projection axis P-AXIS are non-parallel along at least two dimensions and substantially converge forward of device 100. Some alternative configurations may tilt the projector 150, or choose not to tilt the projector 150 and image sensor 156.

### Configurations of Light Projection and Viewing

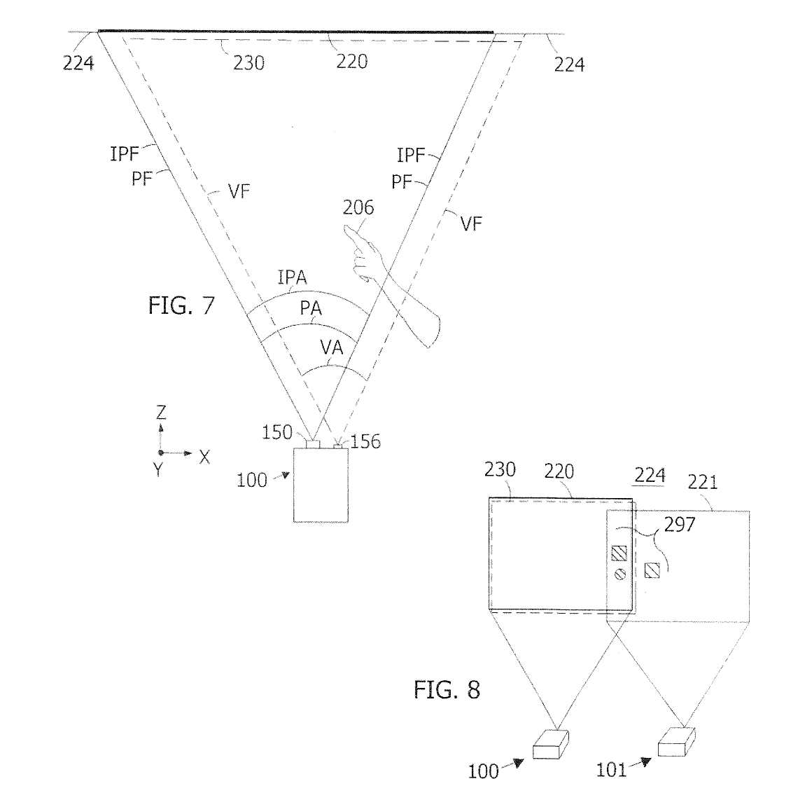

FIGS. 7-12 discuss apparatus configurations for light projection and light viewing by handheld projecting devices, although alternative configurations may be used as well.

### First Configuration—Infrared Projection and View

FIG. 7 shows a top view of a first configuration of the projecting device 100, along with the color-IR image projector 150 and infrared image sensor 156. Projector 150 illuminates visible image 220 on remote surface 224, such as a wall. Projector 150 may have a predetermined visible light projection angle PA creating a projection field PF and a predetermined infrared light projection angle IPA creating an infrared projection field IPF. As shown, projector's 150 infrared light projection angle IPA (e.g., 40 degrees) may be substantially similar to the projector's 150 visible light projection angle PA (e.g., 40 degrees).

Further, image sensor 156 may have a predetermined light view angle VA with view field VF such that a view region 230 and remote objects, such as user hand 206, may be observable by device 100. As illustrated, the image sensor's 156 light view angle VA (e.g., 40 degrees) may be substantially similar to the projector's 150 visible light projection angle PA and infrared light projection angle IPA (e.g., 40 degrees). Such a configuration enables remote objects (such as a user hand 206 making a hand gesture) to enter the view field VF and projection fields PF and IPF at substantially the same time.

FIG. 8 shows a perspective view of two projecting devices 100 and 101 (of similar construction to device 100 of FIG. 7). First device 100 illuminates its visible image 220, while second device 101 illuminates its visible image 221 and an infrared position indicator 297 on surface 224. Then in an example operation, device 100 may enable its image sensor (not shown) to observe view region 230 containing the position indicator 297. An advantageous result occurs: The first device 100 can determine the position, orientation, and shape of indicator 297 and image 221 of the second device 101.

### Alternative Second Configuration—Infrared Projection and Wide View

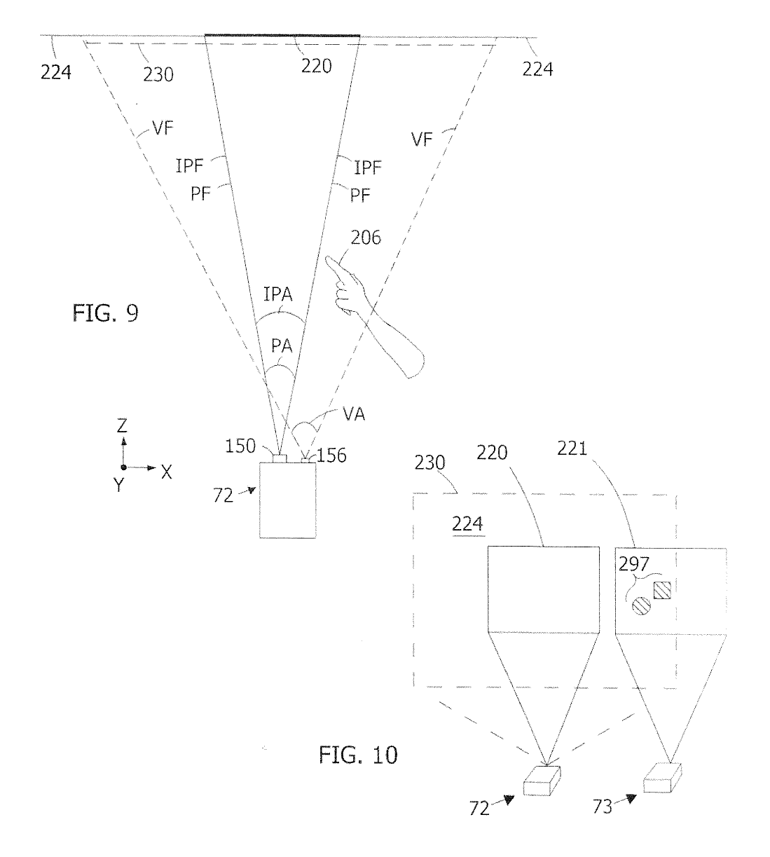

Turning now to FIG. 9, thereshown is a top view of a second configuration of an alternative projecting device 72, along with color-IR image projector 150 and infrared image sensor 156. Projector 150 illuminates visible image 220 on remote surface 224, such as a wall. Projector 150 may have a predetermined visible light projection angle PA creating projection field PF and a predetermined infrared light projection angle IPA creating projection field IPF. As shown, the projector's 150 infrared light projection angle IPA (e.g., 30 degrees) may be substantially similar to the projector's 150 visible light projection angle PA (e.g., 30 degrees).

Further affixed to device 72, the image sensor 156 may have a predetermined light view angle VA where remote objects, such as user hand 206, may be observable within view field VF. As illustrated, the image sensor's 156 light view angle VA (e.g., 70 degrees) may be substantially larger than both the projector's 150 visible light projection angle PA (e.g., 30 degrees) and infrared light projection angle IPA (e.g., 30 degrees). The image sensor 156 may be implemented, for example, using a wide-angle camera lens or fish-eye lens. In some embodiments, the image sensor's 156 light view angle VA (e.g., 70 degrees) may be at least twice as large as the projector's 150 visible light projection angle PA (e.g., 30 degrees) and infrared light projection angle IPA (e.g., 30 degrees). Whereby, remote objects (such as user hand 206 making a hand gesture) may enter the view field VF without entering the visible light projection field PF. An advantageous result occurs: No visible shadows may appear on the visible image 220 when a remote object (i.e., a user hand 206) enters the view field VF.

FIG. 10 shows a perspective view of two projecting devices 72 and 73 (of similar construction to device 72 of FIG. 9). First device 72 illuminates visible image 220, while second device 73 illuminates visible image 221 and an infrared position indicator 297 on surface 224. Then in an example operation, device 72 may enable its image sensor (not shown) to observe the wide view region 230 containing the infrared position indicator 297. An advantageous result occurs: The visible images 220 and 221 may be juxtaposed or even separated by a space on the surface 224, yet the first device 72 can determine the position, orientation, and shape of indicator 297 and image 221 of the second device 73.

### Alternative Third Configuration—Wide Infrared Projection and Wide View

Turning now to FIG. 11, thereshown is a top view of a third configuration of an alternative projecting device 74, along with color-IR image projector 150 and infrared image sensor 156. Projector 150 illuminates visible image 220 on remote surface 224, such as a wall. Projector 150 may have a predetermined visible light projection angle PA creating projection field PF and a predetermined infrared light projection angle IPA creating projection field IPF. As shown, the projector's 150 infrared light projection angle IPA (e.g., 70 degrees) may be substantially larger than the projector's 150 visible light projection angle PA (e.g., 30 degrees). Projector 150 may be implemented, for example, with optical elements that broaden the infrared light projection angle IPA.

Further affixed to device 74, the image sensor 156 may have a predetermined light view angle VA where remote objects, such as user hand 206, may be observable within view field VF. As illustrated, the image sensor's 156 light view angle VA (e.g., 70 degrees) may be substantially larger than the projector's 150 visible light projection angle PA (e.g., 30 degrees). Image sensor 156 may be implemented, for example, using a wide-angle camera lens or fish-eye lens. In some embodiments, the image sensor's 156 light view angle VA (e.g., 70 degrees) may be at least twice as large as the projector's 150 visible light projection angle PA (e.g., 30 degrees). Such a configuration enables remote objects (such as user hand 206 making a hand gesture) to enter the view field VF and infrared projection field IPF without entering the visible light projection field PF. An advantageous result occurs: No visible shadows may appear on the visible image 220 when a remote object (such as user hand 206) enters the view field VF and infrared projection field IPF.

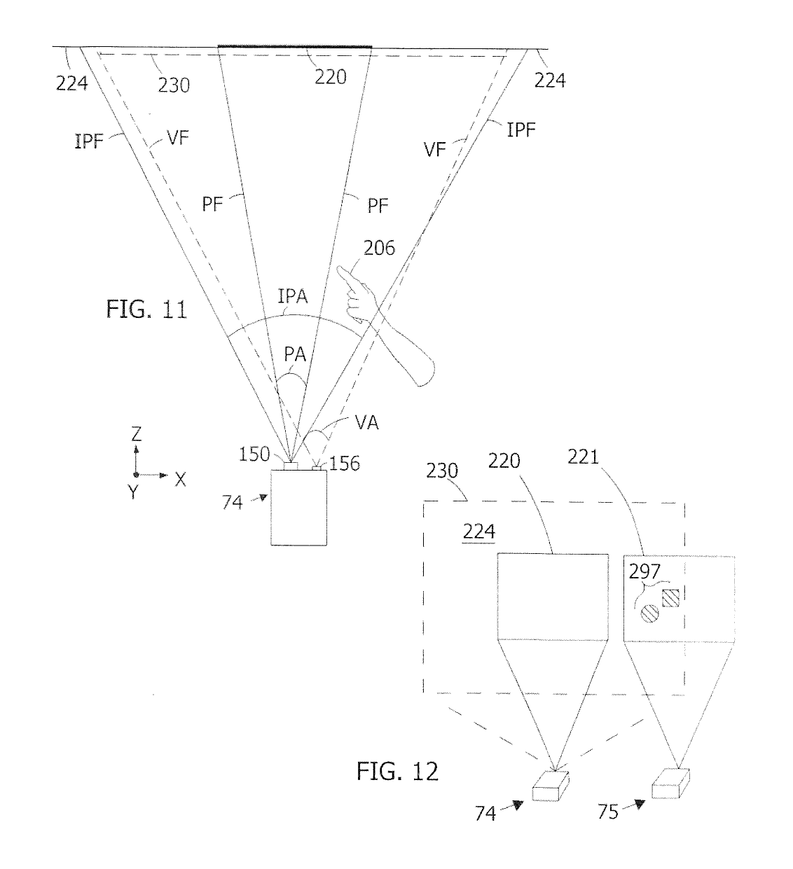

FIG. 12 shows a perspective view of two projecting devices 74 and 75 (of similar construction to device 74 of FIG. 11). First device 74 illuminates visible image 220, while second device 75 illuminates visible image 221 and an infrared position indicator 297 on surface 224. Then in an example operation, device 74 may enable its image sensor (not shown) to observe the wide view region 230 containing the infrared position indicator 297. An advantageous result occurs: The visible images 220 and 221 may be juxtaposed or even separated by a space on the surface 224, yet the first device 74 can determine the position, orientation, and shape of indicator 297 and image 221 of the second device 75.

### Start-up the Handheld Projecting Device

Referring briefly to FIG. 3, the device 100 may begin its operation, for example, when a user actuates the user interface 116 (e.g., presses a keypad) on device 100 causing energy from power source 160 to flow to components of the device 100. The device 100 may then begin to execute computer implemented methods, such as a high-level method of operation.

### High-level Method of Operation for the Projecting Device

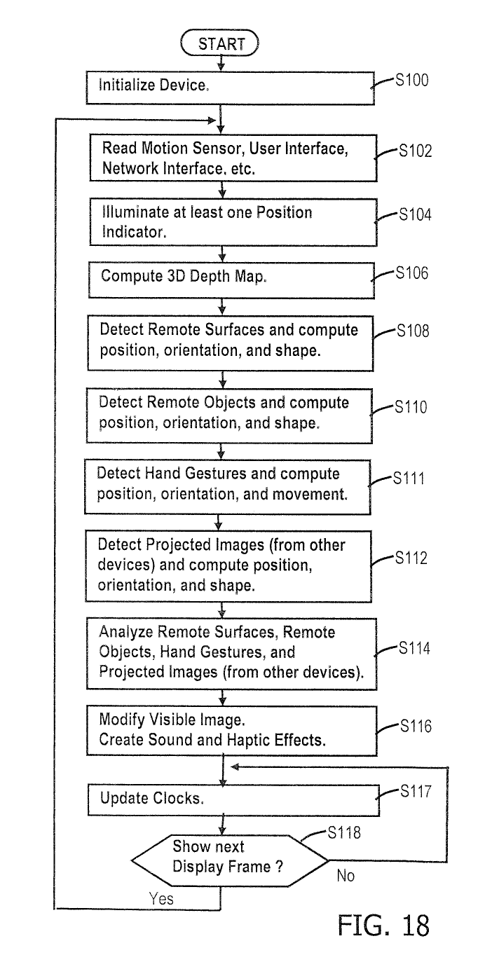

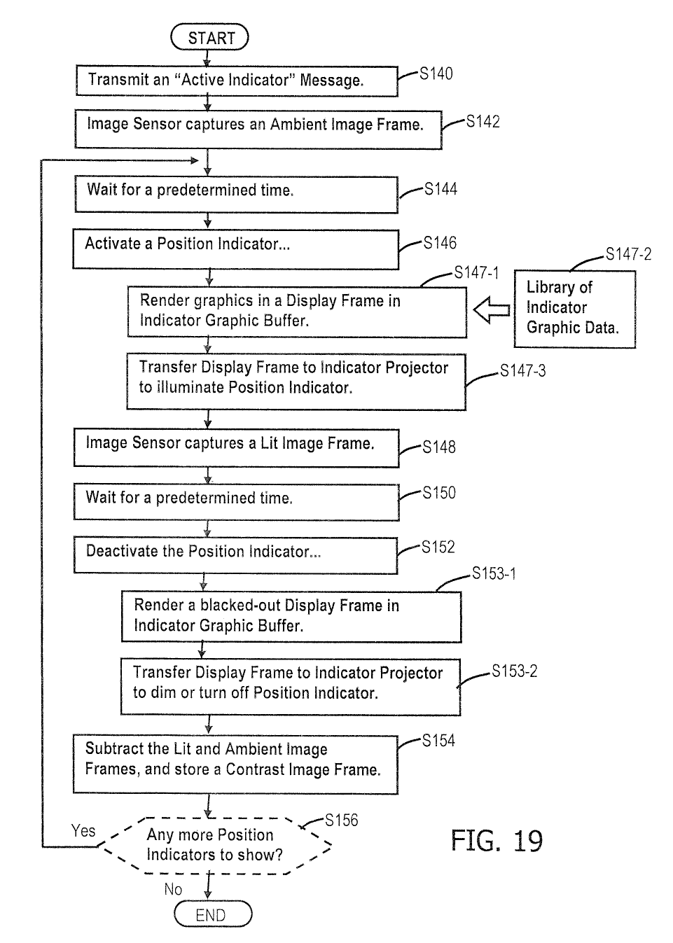

In FIG. 18, a flowchart of a high-level, computer implemented method of operation for the projecting device is presented, although alternative methods may also be considered. The method may be implemented, for example, in memory (reference numeral 130 of FIG. 3) and executed by at least one control unit (reference numeral 110 of FIG. 3).

Beginning with step S100, the projecting device may initialize its operating state by setting, but not limited to, its computer readable data storage (reference numeral 140 of FIG. 3) with default data (i.e., data structures, configuring libraries, etc.).

In step S102, the device may receive one or more movement signals from the motion sensor (reference numeral 120 of FIG. 3) in response to device movement; whereupon, the signals are transformed and stored as motion data (reference numeral 148 of FIG. 3). Further, the device may receive user input data (e.g., button press) from the device's user interface (reference numeral 116 of FIG. 3); whereupon, the input data is stored in data storage. The device may also receive (or transmit) communication data using the device's communication interface (reference numeral 118 of FIG. 3); whereupon, communication data is stored in (or retrieved from) data storage.

In step S104, the projecting device may illuminate at least one position indicator for 3D depth sensing of surfaces and/or optically indicating to other projecting devices the presence of the device's own projected visible image.

In step S106, while at least one position indicator is illuminated, the device may capture one or more image frames and compute a 3D depth map of the surrounding remote surfaces and remote objects in the vicinity of the device.

In step S108, the projecting device may detect one or more remote surfaces by analyzing the 3D depth map (from step S106) and computing the position, orientation, and shape of the one or more remote surfaces.

In step S110, the projecting device may detect one or more remote objects by analyzing the detected remote surfaces (from step S108), identifying specific 3D objects (e.g. a user hand), and computing the position, orientation, and shape of the one or more remote objects.

In step S111, the projecting device may detect one or more hand gestures by analyzing the detected remote objects (from step S110), identifying hand gestures (e.g., thumbs up), and computing the position, orientation, and movement of the one or more hand gestures.

In step S112, the projecting device may detect one or more position indicators (from other devices) by analyzing the image sensor's captured view forward of the device. Whereupon, the projecting device can compute the position, orientation, and shape of one or more projected images (from other devices) appearing on one or more remote surfaces.

In step S114, the projecting device may analyze the previously collected information (from steps S102-S112), such as the position, orientation, and shape of the detected remote surfaces, remote objects, hand gestures, and projected images from other devices.

In step S116, the projecting device may then generate or modify a projected visible image such that the visible image adapts to the position, orientation, and/or shape of the one or more remote surfaces (detected in step S108), remote objects (detected in step S110), hand gestures (detected in step S111), and/or projected images from other devices (detected in step S112). To generate or modify the visible image, the device may retrieve graphic data (e.g., images, etc.) from at least one application (reference numeral 138 of FIG. 3) and render graphics in a display frame in the image graphic buffer (reference 143 of FIG. 3). The device then transfers the display frame to the image projector (reference 150 of FIG. 3), creating a projected visible image to the user's delight.

Also, the projecting device may generate or modify a sound effect such that the sound effect adapts to the position, orientation, and/or shape of the one or more remote surfaces, remote objects, hand gestures, and/or projected images from other devices. To generate a sound effect, the projecting device may retrieve audio data (e.g., MP3 file) from at least one application (reference numeral 138 of FIG. 3) and transfer the audio data to the sound generator (reference numeral 112 of FIG. 3), creating audible sound enjoyed by the user.

Also, the projecting device may generate or modify a haptic vibratory effect such that the haptic vibratory effect adapts to the position, orientation, and/or shape of the one or more remote surfaces, remote objects, hand gestures, and/or projected images from other devices. To generate a haptic vibratory effect, the projecting device may retrieve haptic data (e.g., wave data) from at least one application (reference numeral 138 of FIG. 3) and transfer the haptic data to the haptic generator (reference numeral 114 of FIG. 3), creating a vibratory effect that may be felt by a user holding the projecting device.

In step S117, the device may update clocks and timers so the device operates in a time-coordinated manner.

Finally, in step S118, if the projecting device determines, for example, that its next video display frame needs to be presented (e.g., once every 1/30 of a second), then the method loops to step S102 to repeat the process. Otherwise, the method returns to step S117 to wait for the clocks to update, assuring smooth display frame animation.

### Illuminated Multi-Sensing Position Indicator

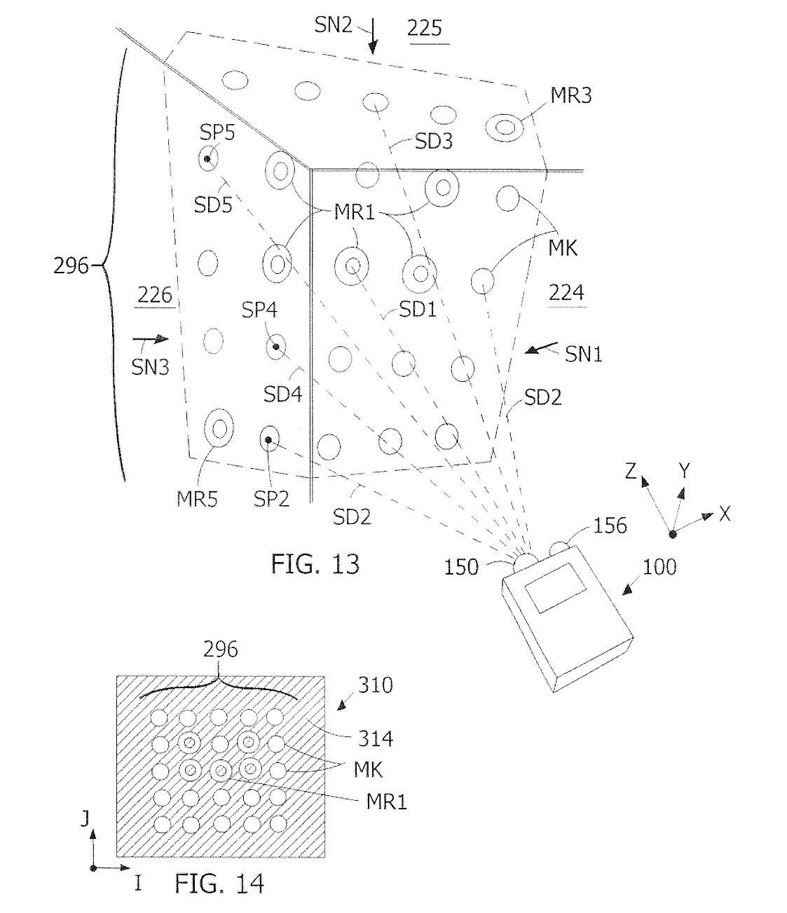

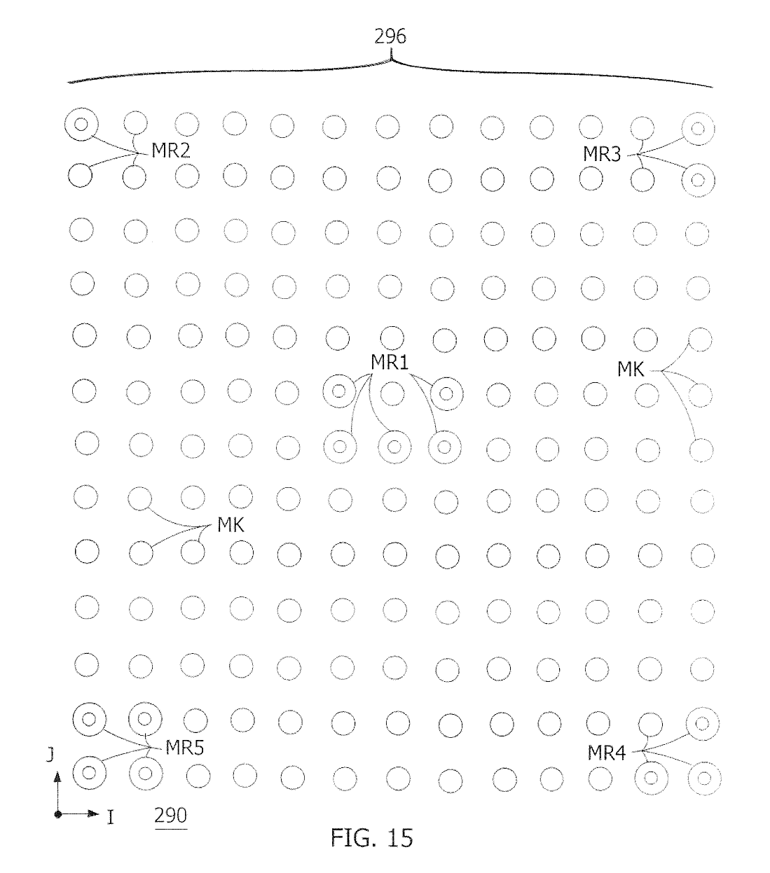

FIG. 13 shows a perspective view of the projecting device 100 illuminating a multi-sensing position indicator 296. As illustrated, the handheld device 100 (with no user shown) is illuminating the position indicator 296 onto multi-planar remote surfaces 224-226, such as the corner of a living room or office space. In the current embodiment, the position indicator 296 is comprised of a predetermined infrared pattern of light being projected by the color-IR image projector 150. Thus, the infrared image sensor 156 can observe the position indicator 296 within the user's environment, such as on surfaces 224-226. (For purposes of illustration, the position indicator 296 shown in FIGS. 13-14 has been simplified, while FIG. 15 shows a detailed view of the position indicator 296.)

Continuing with FIG. 13, the position indicator 296 includes a pattern of light that enables device 100 to remotely acquire 3D spatial depth information of the physical environment and to optically indicate the position and orientation of the device's 100 own projected visible image (not shown) to other projecting devices.

To accomplish such a capability, the position indicator 296 is comprised of a plurality of illuminated fiducial markers, such as distance markers MK and reference markers MR1, MR3, and MR5. The term “reference marker” generally refers to any optical machine-discernible shape or pattern of light that may be used to determine, but not limited to, a spatial distance, position, and orientation. The term “distance marker” generally refers to any optical machine-discernible shape or pattern of light that may be used to determine, but not limited to, a spatial distance. In the current embodiment, the distance markers MK are comprised of circular-shaped spots of light, and the reference markers MR1, MR3, and MR5 are comprised of ring-shaped spots of light. (For purposes of illustration, not all markers are denoted with reference numerals in FIGS. 13-15.)

The multi-sensing position indicator 296 may be comprised of at least one optical machine-discernible shape or pattern of light such that one or more spatial distances may be determined to at least one remote surface by the projecting device 100. Moreover, the multi-sensing position indicator 296 may be comprised of at least one optical machine-discernible shape or pattern of light such that another projecting device (not shown) can determine the relative spatial position, orientation, and/or shape of the position indicator 296. Note that these two such conditions are not necessarily mutually exclusive. The multi-sensing position indicator 296 may be comprised of at least one optical machine-discernible shape or pattern of light such that one or more spatial distances may be determined to at least one remote surface by the projecting device 100, and another projecting device can determine the relative spatial position, orientation, and/or shape of the position indicator 296.

FIG. 15 shows a detailed elevation view of the position indicator 296 on image plane 290 (which is an imaginary plane used to illustrate the position indicator). The position indicator 296 is comprised of a plurality of reference markers MR1-MR5, wherein each reference marker has a unique optical machine-discernible shape or pattern of light. Thus, the position indicator 296 may include at least one reference marker that is uniquely identifiable such that another projecting device can determine a position, orientation, and/or shape of the position indicator 296.

A position indicator may include at least one optical machine-discernible shape or pattern of light that has a one-fold rotational symmetry and/or is asymmetrical such that a rotational orientation can be determined on at least one remote surface. In the current embodiment, the position indicator 296 includes at least one reference marker MR1 having a one-fold rotational symmetry and is asymmetrical. In fact, position indicator 296 includes a plurality of reference markers MR1-MR5 that have one-fold rotational symmetry and are asymmetrical. The term “one-fold rotational symmetry” denotes a shape or pattern that only appears the same when rotated 360 degrees. For example, the “U” shaped reference marker MR1 has a one-fold rotational symmetry since it must be rotated a full 360 degrees on the image plane 290 before it appears the same. Hence, at least a portion of the position indicator 296 may be optical machine-discernible and have a one-fold rotational symmetry such that the position, orientation, and/or shape of the position indicator 296 can be determined on at least one remote surface. The position marker 296 may include at least one reference marker MR1 having a one-fold rotational symmetry such that the position, orientation, and/or shape of the position indicator 296 can be determined on at least one remote surface. The position marker 296 may include at least one reference marker MR1 having a one-fold rotational symmetry such that another projecting device can determine a position, orientation, and/or shape of the position indicator 296.

### Some Alternative Position Indicators

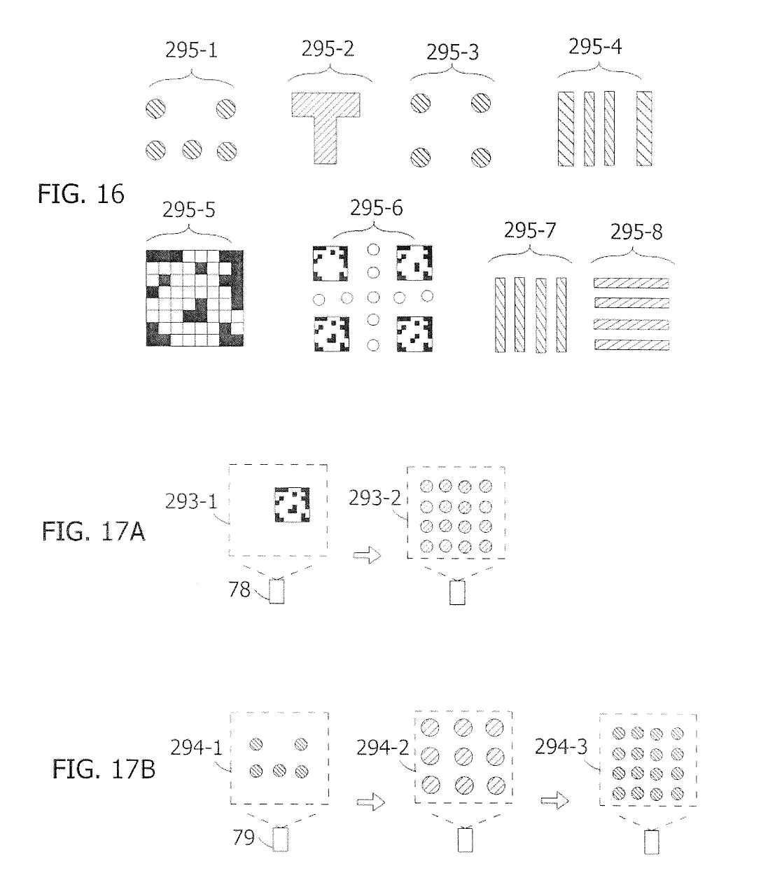

FIGS. 16, 17A, and 17B show examples of alternative illuminated position indicators that may be utilized by alternative projecting devices. Generally speaking, a position indicator may be comprised of any shape or pattern of light having any light wavelength, including visible light (e.g., red, green, blue, etc.) and/or invisible light (e.g., infrared, ultraviolet, etc.). The shape or pattern of light may be symmetrical or asymmetrical, with one-fold or multi-fold rotational symmetry. All of the disclosed position indicators may provide a handheld projecting device with optical machine-discernible information, such as, but not limited to, defining the position, orientation, and/or shape of remote surfaces, remote objects, and/or projected images from other devices.

For example, FIG. 16 presents an alternative “U”-shaped position indicator 295-1 having a coarse pattern for rapid 3D depth and image sensing (e.g., as in game applications). Other alternative patterns include an asymmetrical “T”-shaped position indicator 295-2 and a symmetrical square-shaped position indicator 295-3 having a multi-fold (4-fold) rotational symmetry. Yet other alternatives include a 1D barcode position indicator 295-4, a 2D barcode position indicator 295-5 (such as a QR code), and a multi barcode position indicator 295-6 comprised of a plurality of barcodes and fiducial markers. Wherein, some embodiments of the position indicator may be comprised of at least one of an optical machine-readable pattern of light that represents data, a 1D barcode, or a 2D barcode providing information (e.g., text, coordinates, image description, internet URL, etc.) to other projecting devices. Finally, a vertical striped position indicator 295-7 and a horizontal striped position indicator 295-8 may be illuminated separately or in sequence.

At least one embodiment of the projecting device may sequentially illuminate a plurality of position indicators having unique patterns of light on at least one remote surface. For example, FIG. 17A shows a handheld projecting device 78 that illuminates a first barcode position indicator 293-1 for a predetermined period of time (e.g., 0.01 second), providing optical machine-readable information to other handheld projecting devices (not shown). Then a brief time later (e.g., 0.02 second), the device illuminates a second 3D depth-sensing position indicator 293-2 for a predetermined period of time (e.g., 0.01 second), providing 3D depth sensing. The device 78 may then sequentially illuminate a plurality of position indicators 293-1 and 293-2, providing optical machine-readable information to other handheld projecting devices and 3D depth sensing of at least one remote surface.

In another example, FIG. 17B shows an image position indicator 294-1, a low-resolution 3D depth sensing position indicator 294-2, and a high-resolution 3D depth sensing position indicator 294-3. A handheld projecting device 79 may then sequentially illuminate a plurality of position indicators 294-1, 294-2, and 294-3, providing image sensing and multi-resolution 3D depth sensing of at least one remote surface.

3D Spatial Depth Sensing with Position Indicator

Now returning to FIG. 13 of the current embodiment, projecting device 100 is shown illuminating the multi-sensing position indicator 296 on remote surfaces 224-226. (For purposes of illustration, the indicator 296 of FIGS. 13-14 has been simplified, while FIG. 15 shows a detailed view.)

In an example 3D spatial depth sensing operation, device 100 and projector 150 first illuminate the surrounding environment with position indicator 296, as shown. Then while the position indicator 296 appears on remote surfaces 224-226, the device 100 may enable the image sensor 156 to take a “snapshot” or capture one or more image frames of the spatial view forward of sensor 156.

So thereshown in FIG. 14 is an elevation view of an example captured image frame 310 of the position indicator 296, wherein fiducial markers MR1 and MK are illuminated against an image background 314 that appears dimly lit. (For purposes of illustration, the observed position indicator 296 has been simplified.)

The device may then use computer vision functions (such as the depth analyzer 133 shown earlier in FIG. 3) to analyze the image frame 310 for 3D depth information. Namely, a positional shift will occur with the fiducial markers, such as markers MK and MR1, within the image frame 310 that corresponds to distance (as discussed earlier in FIG. 5).

FIG. 13 shows device 100 may compute one or more spatial surface distances to at least one remote surface, measured from device 100 to markers of the position indicator 296. As illustrated, the device 100 may compute a plurality of spatial surface distances SD1, SD2, SD3. SD4, and SD5, along with distances to substantially all other remaining fiducial markers within the position indicator 296 (as shown earlier in FIG. 15).

With known surface distances, the device 100 may further compute the location of one or more surface points that reside on at least one remote surface. For example, device 100 may compute the 3D positions of surface points SP2, SP4, and SP5, and other surface points to markers within position indicator 296.

Then with known surface points, the projecting device 100 may compute the position, orientation, and/or shape of remote surfaces and remote objects in the environment. For example, the projecting device 100 may aggregate surface points SP2, SP4, and SP4 (on remote surface 226) and generate a geometric 2D surface and 3D mesh, which is an imaginary surface with surface normal vector SN3. Moreover, other surface points may be used to create other geometric 2D surfaces and 3D meshes, such as geometrical surfaces with normal vectors SN1 and SN2. Finally, the device 100 may use the determined geometric 2D surfaces and 3D meshes to create geometric 3D objects that represent remote objects, such as a user hand (not shown) in the vicinity of device 100. Whereupon, device 100 may store in data storage the surface points, 2D surfaces, 3D meshes, and 3D objects for future reference, such that device 100 is spatially aware of its environment.

### Method for Illuminating the Position Indicator

Turning to FIGS. 19-21, computer implemented methods are presented that describe the 3D depth sensing process for the projecting device, although alternative methods may be used as well. Specifically, FIG. 19 is a flowchart of a computer implemented method that enables the illumination of at least one position indicator (as shown in FIG. 13, reference numeral 296) along with capturing at least one image of the position indicator, although alternative methods may be considered. The method may be implemented, for example, in the image grabber (reference numeral 132 of FIG. 3) and executed by at least one control unit (reference numeral 110 of FIG. 3). The method may be continually invoked (e.g., every 1/30 second) by a high-level method (such as step S104 of FIG. 18).

Beginning with step S140, the projecting device initially transmits a data message, such as an “active indicator” message to other projecting devices that may be in the vicinity. The purpose assures that other devices can synchronize their image capturing process with the current device. For example, the projecting device may create an “active indicator” message (e.g., Message Type=“Active Indicator”, Timestamp=“12:00:00”, Device Id=“100”, Image=“Dog”, etc.) and transmit the message using its communication interface (reference numeral 116 of FIG. 3).

Then in step S142, the projecting device enables its image sensor (reference numeral 156 of FIG. 3) to capture an ambient image frame of the view forward of the image sensor. The device may store the ambient image frame in the image frame buffer (reference numeral 142 of FIG. 3) for future image processing.

In step S144, the projecting device waits for a predetermined period of time (e.g. 0.01 second) so that other possible projecting devices in the vicinity may synchronize their light sensing activity with this device.

Then in step S146, the projecting device activates or increases the brightness of an illuminated position indicator. In the current device embodiment (of FIG. 3), as shown by step S147-1, the device may render indicator graphics in a display frame in the indicator graphic buffer (reference numeral 145 of FIG. 3), where graphics may be retrieved from a library of indicator graphic data, as shown in step S147-2. Then in step S147-3, the device may transfer the display frame to an indicator projector (such as the infrared display input of the color-IR image projector 150 of FIG. 3) causing illumination of a position indicator (such as infrared position indicator 296 of FIG. 13).

Continuing to step S148, while the position indicator is lit, the projecting device enables its image sensor (reference numeral 156 of FIG. 3) to capture a lit image frame of the view forward of the image sensor. The device may store the lit image frame in the image frame buffer (reference numeral 142 of FIG. 3) as well.

In step S150, the projecting device waits for a predetermined period of time (e.g., 0.01 second) so that other potential devices in the vicinity may successfully capture a lit image frame as well.

In step S152, the projecting device deactivates or decreases the brightness of the position indicator so that it does not substantially appear on surrounding surfaces. In the current device embodiment (of FIG. 3), as shown by step S153-1, the device may render a substantially “blacked out” or blank display frame in the indicator graphic buffer (reference numeral 145 of FIG. 3). Then in step S153-2, the device may transfer the display frame to an indicator projector (such as the infrared display input of the color-IR image projector 150 of FIG. 3) causing the position indicator to be substantially dimmed or turned off.

Continuing to step S154, the projecting device uses image processing techniques to optionally remove unneeded graphic information from the collected image frames. For example, the device may conduct image subtraction of the lit image frame (from step S148) and the ambient image frame (from step S142) to generate a contrast image frame. Whereby, the contrast image frame may be substantially devoid of ambient light and content, such walls and furniture, while any captured position indicator remains intact (as shown by image frame 310 of FIG. 14). Also, the projecting device may assign metadata (e.g., frame id=15, time=“12:04:01” frame type=“contrast”, etc.) to the contrast image frame for easy lookup, and store the contrast image frame in the image frame buffer (reference numeral 142 of FIG. 3) for future reference.

Finally, in step S156 (which is an optional step), if the projecting device determines that more position indicators need to be sequentially illuminated, the method returns to step S144 to illuminate another position indicator. Otherwise, the method ends. In the current embodiment of the projecting device (reference numeral 100 of FIG. 3), step S156 may be removed, as the current embodiment illuminates only one position indicator (as shown in FIG. 15).

### Method for 3D Spatial Depth Sensing

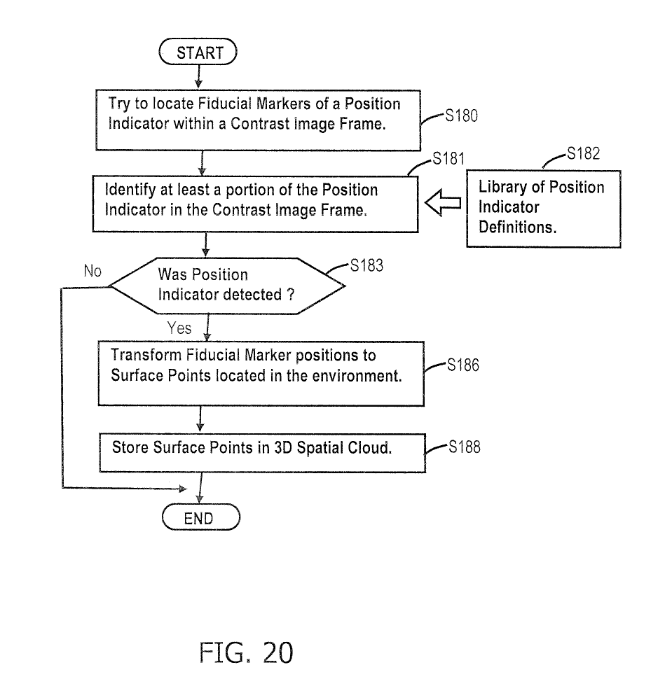

Turning now to FIG. 20, presented is a flowchart of a computer implemented method that enables the projecting device to compute a 3D depth map using an illuminated position indicator, although alternative methods may be considered as well. The method may be implemented, for example, in the depth analyzer (reference numeral 133 of FIG. 3) and executed by at least one control unit (reference numeral 110 of FIG. 3). The method may be continually invoked (e.g., every 1/30 second) by a high-level method (such as step S106 of FIG. 18).

Starting with step S180, the projecting device analyzes at least one captured image frame, such as a contrast image frame (from step S154 of FIG. 19), located in the image frame buffer (reference numeral 142 of FIG. 3). For example, the device may analyze the contrast image frame, where illuminated patterns may be recognized by variation in brightness. This may be accomplished with computer vision techniques (e.g., edge detection, pattern recognition, image segmentation, etc.) adapted from current art.

The projecting device may then attempt to locate at least one fiducial marker (or marker blob) of a position indicator within the contrast image frame. The term “marker blob” refers to an illuminated shape or pattern of light appearing within a captured image frame. Whereby, one or more fiducial reference markers (as denoted by reference numeral MR1 of FIG. 14) may be used to determine the position, orientation, and/or shape of the position indicator within the contrast image frame. That is, the projecting device may attempt to identify any located fiducial marker (e.g., marker id=1, marker location=[10,20]; marker id=2, marker location=[15, 30]; etc.).

The projecting device may also compute the positions (e.g., sub-pixel centroids) of potentially located fiducial markers of the position indicator within the contrast image frame. For example, computer vision techniques for determining fiducial marker positions, such as the computation of “centroids” or centers of marker blobs, may be adapted from current art.

In step S181, the projecting device may try to identify at least a portion of the position indicator within the contrast image frame. That is, the device may search for at least a portion of a matching position indicator pattern in a library of position indicator definitions (e.g., as dynamic and/or predetermined position indicator patterns), as indicated by step S182. The fiducial marker positions of the position indicator may aid the pattern matching process. Also, the pattern matching process may respond to changing orientations of the pattern within 3D space to assure robustness of pattern matching. To detect a position indicator, the projecting device may use computer vision techniques (e.g., shape analysis, pattern matching, projective geometry, etc.) adapted from current art.

In step S183, if the projecting device detects a position indicator, the method continues to step S186. Otherwise, the method ends.

In step S186, the projecting device may transform one or more image-based, fiducial marker positions into physical 3D locations outside of the device. For example, the device may compute one or more spatial surface distances to one or more markers on one or more remote surfaces outside of the device (such as surface distances SD1-SD5 of FIG. 13). Spatial surface distances may be computed using computer vision techniques (e.g., triangulation, etc.) for 3D depth sensing (as described earlier in FIG. 5). Moreover, the device may compute 3D positions of one or more surface points (such as surface points SP2, SP4, and SP5) residing on at least one remote surface, based on the predetermined pattern and angles of light rays that illuminate the position indicator (such as indicator 296 of FIG. 13).

In step S188, the projecting device may assign metadata to each surface point (from step S186) for easy lookup (e.g., surface point id=10, surface point position=[10,20,50], etc.). The device may then store the computed surface points in the 3D spatial cloud (reference numeral 144 of FIG. 3) for future reference. Whereupon, the method ends.

### Method for Detecting Remote Surfaces and Remote Objects

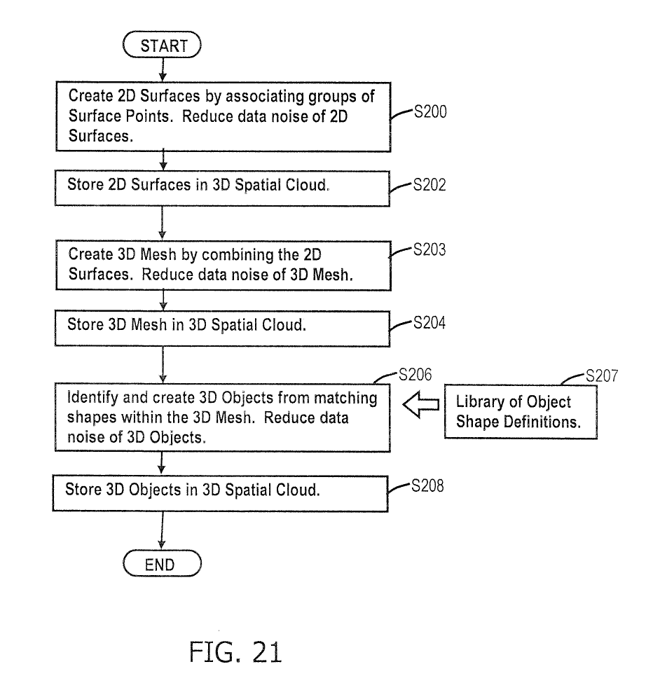

Turning now to FIG. 21, a flowchart is presented of a computer implemented method that enables the projecting device to compute the position, orientation, and shape of remote surfaces and remote objects in the environment of the device, although alternative methods may be considered. The method may be implemented, for example, in the surface analyzer (reference numeral 134 of FIG. 3) and executed by at least one control unit (reference numeral 110 of FIG. 3). The method may be continually invoked (e.g., every 1/30 second) by a high-level method (such as step S108 of FIG. 18).

Beginning with step S200, the projecting device analyzes the geometrical surface points (from the method of FIG. 20) that reside on at least one remote surface. For example, the device constructs geometrical 2D surfaces by associating groups of surface points that are, but not limited to, located near each or coplanar. The 2D surfaces may be constructed as geometric polygons in 3D space. Data noise or inaccuracy of outlier surface points may be smoothed away or removed.

In step S202, the projecting device may assign metadata to each computed 2D surface (from step S200) for easy lookup (e.g., surface id=30, surface type=planar, surface position=[10,20,5; 15,20,5; 15,30,5]; etc.). The device stores the generated 2D surfaces in the 3D spatial cloud (reference numeral 144 of FIG. 3) for future reference.

In step S203, the projecting device may create one or more geometrical 3D meshes from the collected 2D surfaces (from step S202). A 3D mesh is a polygon approximation of a surface, often constituted of triangles, that represents a planar or a non-planar remote surface. To construct a mesh, polygons or 2D surfaces may be aligned and combined to form a seamless, geometrical 3D mesh. Open gaps in a 3D mesh may be filled. Mesh optimization techniques (e.g., smoothing, polygon reduction, etc.) may be adapted from current art. Positional inaccuracy (or jitter) of a 3D mesh may be noise reduced, for example, by computationally averaging a plurality of 3D meshes continually collected in real-time.

In step S204, the projecting device may assign metadata to one or more 3D meshes for easy lookup (e.g., mesh id=1, timestamp=“12:00:01 AM”, mesh vertices==[10,20,5; 10,20,5; 30,30,5; 10,30,5]; etc.). The projecting device may then store the generated 3D meshes in the 3D spatial cloud (reference numeral 144 of FIG. 3) for future reference.

Next, in step S206, the projecting device analyzes at least one 3D mesh (from step S204) for identifiable shapes of physical objects, such as a user hand, etc. Computer vision techniques (e.g., 3D shape matching) may be adapted from current art to match shapes (i.e., predetermined object models of user hand, etc., as in step S207). For each matched shape, the device may generate a geometrical 3D object (e.g., object model of user hand) that defines the physical object's location, orientation, and shape. Noise reduction techniques (e.g., 3D object model smoothing, etc.) may be adapted from current art.

In step S208, the projecting device may assign metadata to each created 3D object (from step S206) for easy lookup (e.g., object id=1, object type=hand, object position=[100,200,50 cm], object orientation=[30,20,10 degrees], etc.). The projecting device may store the generated 3D objects in the 3D spatial cloud (reference numeral 144 of FIG. 3) for future reference. Whereupon, the method ends.

### Keystone Distortion

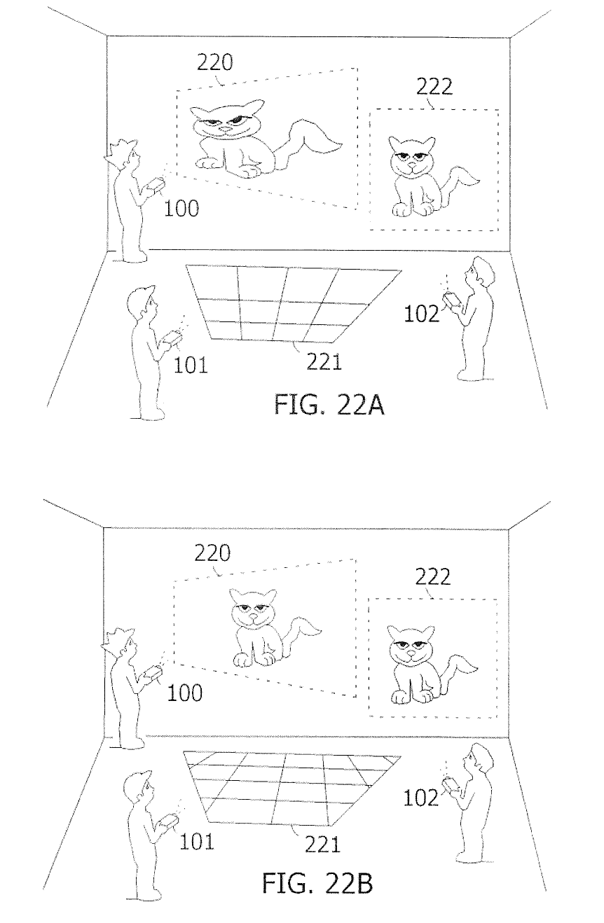

FIG. 22A shows a perspective view of three projecting devices 100-102 creating visible images on remote surfaces. As can be seen, visible images 220 and 221 suffer from keystone distortion (e.g., wedge-shaped image), while visible image 223 has no keystone distortion. This problem often stems from a low projection angle on a projection surface.

Turning now to FIG. 22B, a perspective view is shown of the same three projecting devices 100-102 in the same locations (as in FIG. 22A), except now all three visible images 220-222 are keystone corrected and brightness adjusted such that the images show little distortion and are uniformly lit, as discussed below

### Computing Location of the Projection Region

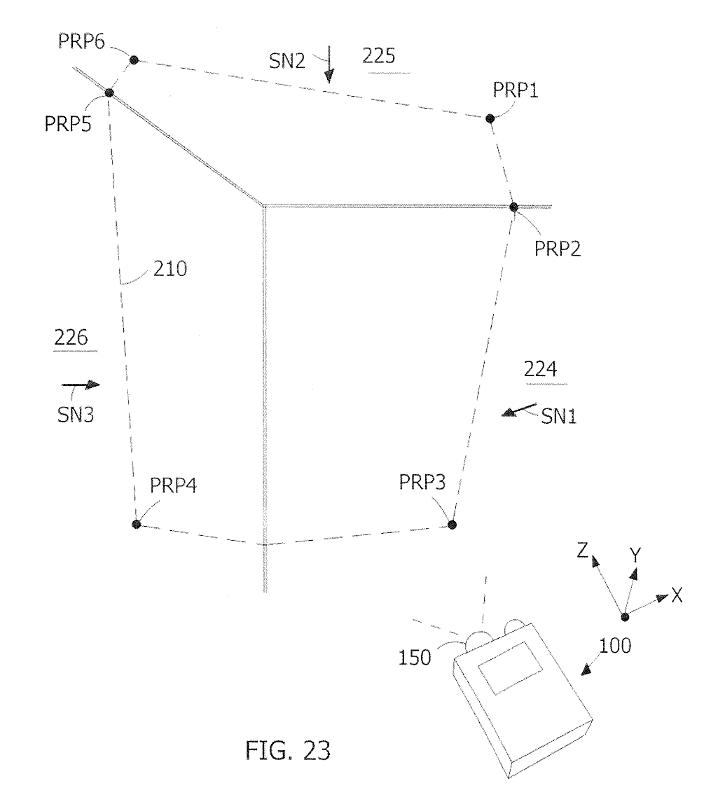

FIG. 23 shows a perspective view of a projection region 210, which is the geometrical region that defines a full-sized, projected image from projector 150 of the projecting device 100. Device 100 is spatially aware of the position, orientation, and shape of nearby remote surfaces (as shown earlier in FIG. 13), where surfaces 224-226 have surface normal vectors SN1-SN3. Further, device 100 may be operable to compute the location, orientation, and shape of the projection region 210 in respect to the position, orientation, and shape of one or more remote surfaces, such as surfaces 224-226. Computing the projection region 210 may require knowledge of the projector's 150 predetermined horizontal light projection angle (as shown earlier in FIG. 7, reference numeral PA) and vertical light projection angle (not shown).

So in an example operation, device 100 may pre-compute (e.g., prior to image projection) the full-sized projection region 210 using input parameters that may include, but not limited to, the predetermined light projection angles and the location, orientation, and shape of remote surfaces 224-226 relative to device 100. Such geometric functions (e.g., trigonometry, projective geometry, etc.) may be adapted from current art. Whereby, device 100 may create projection region 210 comprised of the computed 3D positions of region points PRP1-PRP6, and store region 210 in the spatial cloud (reference numeral 144 of FIG. 3) for future reference.

Reduced Distortion of Visible image on Remote Surfaces

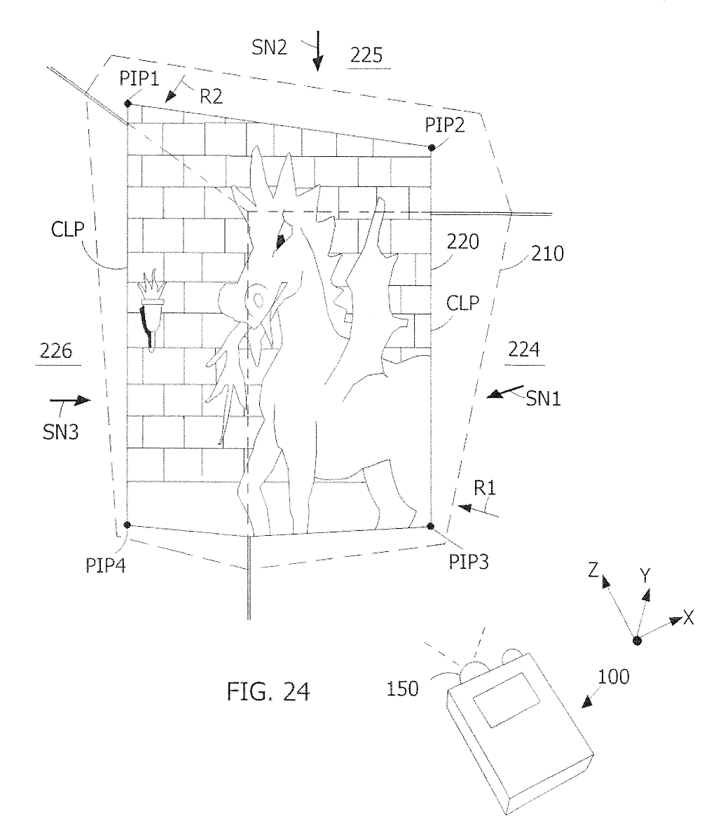

FIG. 24 shows a perspective view of the projecting device 100 that is spatially aware of the position, orientation, and shape of at least one remote surface in its environment, such as surfaces 224-226 (as shown earlier in FIG. 13) having surface normal vectors SN1-SN3.

Moreover, device 100 with image projector 150 may compute and utilize the position, orientation, and shape of its projection region 210, prior to illuminating a projected visible image 220 on surfaces 224-226.

Whereby, the handheld projecting device 100 may create at least a portion of the projected visible image 210 that is substantially uniformly lit and/or substantially devoid of image distortion on at least one remote surface. That is, the projecting device 100 may adjust the brightness of the visible image 220 such that the projected visible image appears substantially uniformly lit on at least one remote surface. For example, a distant image region R1 may have the same overall brightness level as a nearby image region R2, relative to device 100. The projecting device 100 may use image brightness adjustment techniques (e.g., pixel brightness gradient adjustment, etc.) adapted from current art.

Moreover, the projecting device 100 may modify the shape of the visible image 220 such that at least a portion of the projected visible image appears as a substantially undistorted shape on at least one remote surface. That is, the projecting device 100 may clip away at least a portion of the image 220 (as denoted by clipped edges CLP) such that the projected visible image appears as a substantially undistorted shape on at least one remote surface. As can be seen, the image points PIP 1-PIP4 define the substantially undistorted shape of visible image 220. Device 100 may utilize image shape adjust methods (e.g., image clipping, black color fill of background, etc.) adapted from current art.

Finally, the projecting device 100 may inverse warp or pre-warp the visible image 220 (prior to image projection) in respect to the position, orientation, and/or shape of the projection region 210 and remote surfaces 224-226. The device 100 then modifies the visible image such that at least a portion of the visible image appears substantially devoid of distortion on at least one remote surface. The projecting device 100 may use image modifying techniques (e.g., transformation, scaling, translation, rotation, etc.) adapted from current art to reduce image distortion.

Method for Reducing Distortion of Visible image

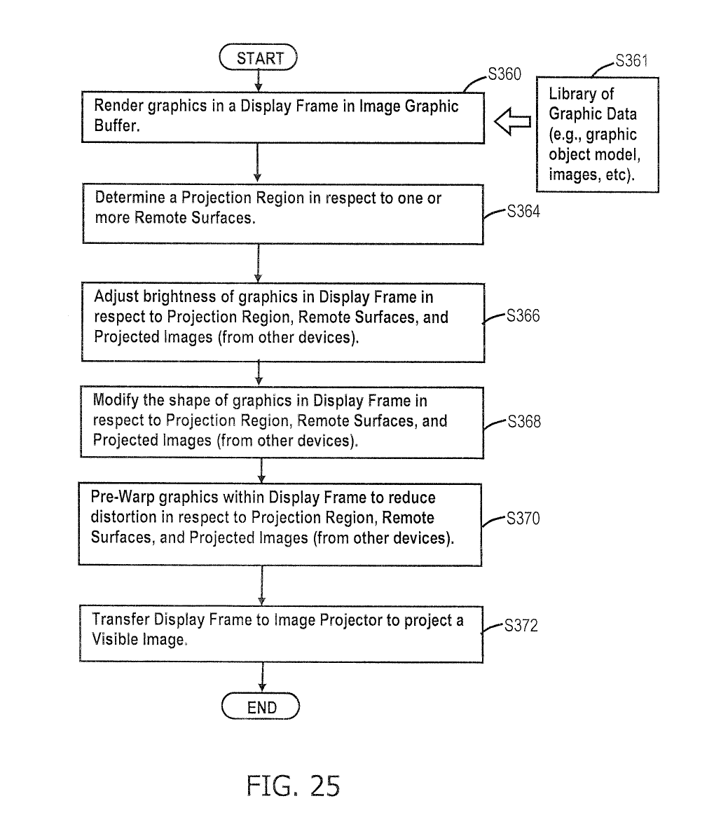

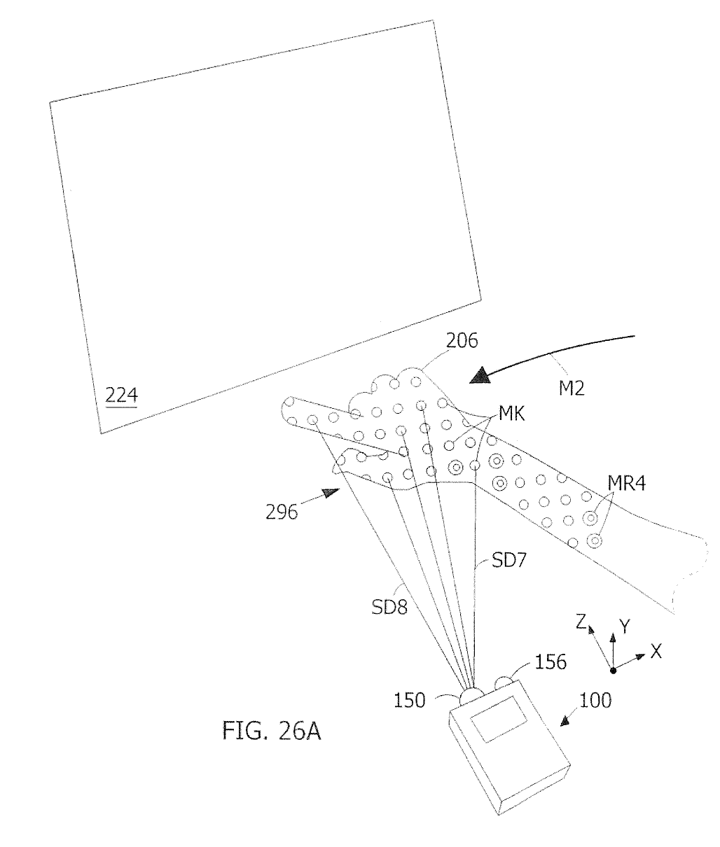

FIG. 25 presents a flowchart of a computer implemented method that enables a handheld projecting device to modify a visible image such that, but not limited to, at least a portion of the visible image is substantially uniformly lit, and/or substantially devoid of image distortion on at least one remote surface, although alternative methods may be considered as well. The method may be implemented, for example, in the graphics engine (reference numeral 135 of FIG. 3) and executed by at least one control unit (reference numeral 110 of FIG. 3). The method may be continually invoked (e.g., every 1/30 second for display frame animation) by a high-level method (such as step S116 of FIG. 18) and/or an application (e.g., reference numeral 138 of FIG. 3).

So starting with step S360, the projecting device receives instructions from an application (such as a video game) to render graphics within a graphic display frame, located in the image graphic buffer (reference numeral 143 of FIG. 3). Graphic content may be retrieved from a library of graphic data (e.g., an object model of castle and dragon, video, images, etc.), as shown by step S361. Graphic rendering techniques (e.g., texture mapping, gouraud shading, graphic object modeling, etc.) may be adapted from current art.

Continuing to step S364, the projecting device then pre-computes the position, orientation, and shape of its projection region in respect to at least one remote surface in the vicinity of the device. The projection region may be the computed geometrical region for a full-sized, projected image on at least one remote surface.

In step S366, the projecting device adjusts the image brightness of the previously rendered display frame (from step S360) in respect to the position, orientation, and/or shape of the projection region, remote surfaces, and projected images from other devices. For example, image pixel brightness may be boosted in proportion to the projection surface distance, to counter light intensity fall-off with distance. The following pseudo code may be used to adjust image brightness: where P is a pixel, and D is a projection surface distance to the pixel P on at least one remote surface:

scalar=(1/(maximum distance to all pixels P)²)

for each pixel P in the display frame . . . pixel brightness (P)=(surface distance D to pixel P)²×scalar×pixel brightness (P)

For example, in detail, the projecting device's control unit may determine a brightness condition of a visible image such that the brightness condition of the visible image adapts to the position, orientation, and/or shape of at least one remote surface. The projecting device's control unit may modify a visible image such that at least a portion of the visible image appears substantially uniformly lit on at least one remote surface, irrespective of the position, orientation, and/or shape of the at least one remote surface.

In step S368, the projecting device modifies the shape (or outer shape) of the rendered graphics within the display frame in respect to the position, orientation, and/or shape of the projection region, remote surfaces, and projected images from other devices. Image shape modifying techniques (e.g., clipping out an image shape and rendering its background black, etc.) may be adapted from current art.

For example, in detail, the projecting device's control unit may modify a shape of a visible image such that the shape of the visible image appears substantially undistorted on at least one more remote surface. The projecting device's control unit may modify a shape of a visible image such that the shape of the visible image adapts to the position, orientation, and/or shape of at least one remote surface. The projecting device's control unit may modify a shape of a visible image such that the visible image does not substantially overlap another projected visible image (from another handheld projecting device) on at least one remote surface.

In step S370, the projecting device then inverse warps or pre-warps the rendered graphics within the display frame based on the position, orientation, and/or shape of the projection region, remote surfaces, and projected images from other devices. The goal is to reduce or eliminate image distortion (e.g., keystone, barrel, and/or pincushion distortion, etc.) in respect to remote surfaces and projected images from other devices. This may be accomplished with image processing techniques (e.g., inverse coordinate transforms, Nomography, projective geometry, scaling, rotation, translation, etc.) adapted from current art.

For example, in detail, the projecting device's control unit may modify a visible image based upon one or more surface distances to an at least one remote surface, such that the visible image adapts to the one or more surface distances to the at least one remote surface. The projecting device's control unit may modify a visible image based upon the position, orientation, and/or shape of an at least one remote surface such that the visible image adapts to the position, orientation, and/or shape of the at least one remote surface. The projecting device's control unit may determine a pre-warp condition of a visible image such that the pre-warp condition of the visible image adapts to the position, orientation, and/or shape of at least one remote surface. The projecting device's control unit may modify a visible image such that at least a portion of the visible image appears substantially devoid of distortion on at least one remote surface.

Finally, in step S372, the projecting device transfers the fully rendered display frame to the image projector to create a projected visible image on at least one remote surface.

Hand Gesture Sensing with Position Indicator

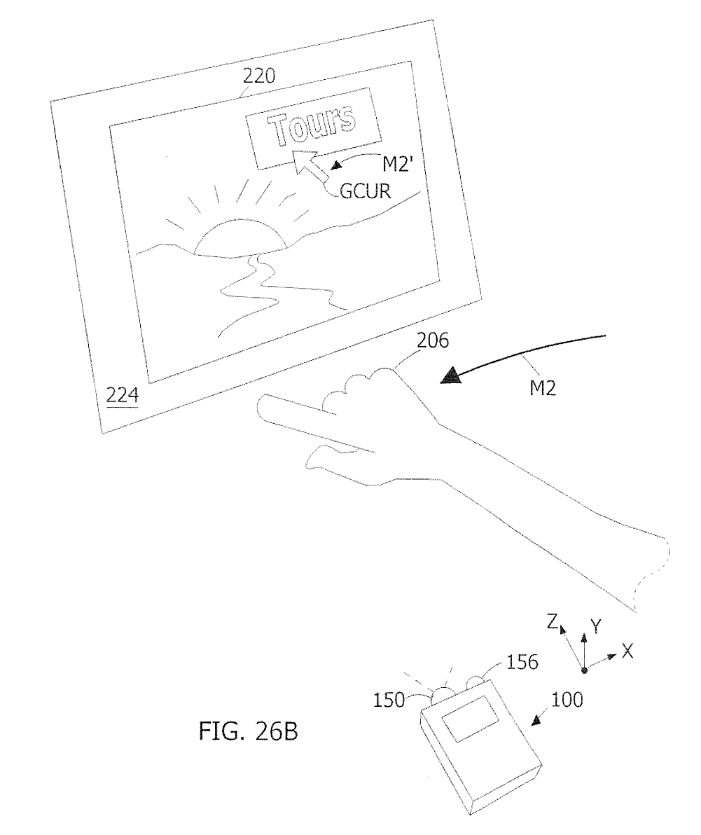

Turning now to FIG. 26A, thereshown is a perspective view (of position indicator light) of the handheld projecting device 100, while a user hand 206 is making a hand gesture in a leftward direction (as denoted by move arrow M2).

For the 3D spatial depth sensing to operate, device 100 and projector 150 illuminate the surrounding environment with a position indicator 296, as shown. Then while the position indicator 296 appears on the user hand 206, the device 100 may enable image sensor 156 to capture an image frame of the view forward of sensor 156. Subsequently, the device 100 may use computer vision functions (such as the depth analyzer 133 shown earlier in FIG. 3) to analyze the image frame for fiducial markers, such as markers MK and reference markers MR4. (To simplify the illustration, all illuminated markers are not denoted.)

Device 100 may further compute one or more spatial surface distances to at least one surface where markers appear. For example, the device 100 may compute the surface distances SD7 and SD8, along with other distances (not denoted) to a plurality of illuminated markers, such as markers MK and MR4, covering the user hand 206. Device 100 then creates and stores (in data storage) surface points, 2D surfaces, 3D meshes, and finally, a 3D object that represents hand 206 (as defined earlier in methods of FIGS. 20-21).

The device 100 may then complete hand gesture analysis of the 3D object that represents the user hand 206. If a hand gesture is detected, the device 100 may respond by creating multimedia effects in accordance to the hand gesture.

For example, FIG. 26B shows a perspective view (of visible image light) of the handheld projecting device 100, while the user hand 206 is making a hand gesture in a leftward direction. Upon detecting a hand gesture from user hand 206, the device 100 may modify the projected visible image 220, generate audible sound, and/or create haptic vibratory effects in accordance to the hand gesture. In this case, the visible image 220 presents a graphic cursor (GCUR) that moves (as denoted by arrow M2′) in accordance to the movement (as denoted by arrow M2) of the hand gesture of user hand 206. Understandably, alternative types of hand gestures and generated multimedia effects in response to the hand gestures may be considered as well.

### Method for Hand Gesture Sensing

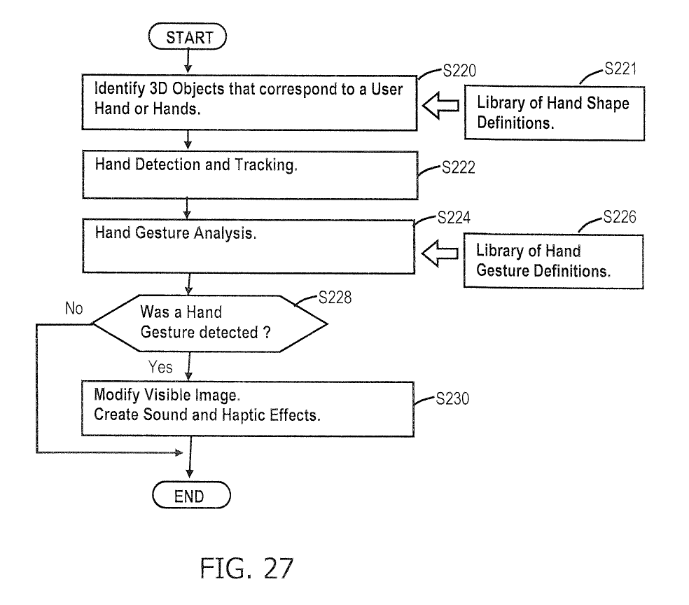

Turning now to FIG. 27, a flowchart of a computer implemented method is presented that describes hand gesture sensing in greater detail, although alternative methods may be considered. The method may be implemented, for example, in the gesture analyzer (reference numeral 137 of FIG. 3) and executed by at least one control unit (reference numeral 110 of 3). The method may be continually invoked (e.g., every 1/30 second) by a high-level method (such as step S111 of FIG. 18).

Starting with step S220, the projecting device identifies each 3D object (as computed by the method of FIG. 21) that represents a remote object, which was previously stored in data storage (e.g., reference numeral 144 of FIG. 3). That is, the device may take each 3D object and search for a match in a library of hand shape definitions (e.g., as predetermined 3D object models of a hand in various poses), as indicated by step S221. Computer vision techniques and gesture analysis methods (e.g., pattern and 3D shape matching, i.e. Hausdorff distance) may be adapted from current art to identify the user's hand or hands.

In step S222, the projecting device further tracks any identified user hand or hands (from step S220). The projecting device may accomplish hand tracking by extracting spatial features of the 3D object that represents a user hand (e.g., such as tracking an outline of the hand, finding convexity defects between thumb/fingers, etc.) and storing in data storage a history of hand tracking data (reference numeral 146 of FIG. 3). Whereby, position, orientation, shape, and/or velocity of the user hand/or hands may be tracked over time.

In step S224, the projecting device completes gesture analysis of the previously recorded user hand tracking data. That is, the device may take the recorded hand tracking data and search for a match in a library of hand gesture definitions (e.g., as predetermined 3D object/motion models of thumbs up, hand wave, open hand, pointing hand, leftward moving hand, etc.), as indicated by step S226. This may be completed by gesture matching and detection techniques (e.g., hidden Markov model, neural network, finite state machine, etc.) adapted from current art.

In step S228, if the projecting device detects and identifies a hand gesture, the method continues to step S230. Otherwise, the method ends.

Finally, in step S230, in response to the detected hand gesture being made, the projecting device may generate multimedia effects, such as the generation of graphics, sound, and/or haptic effects, in accordance to the type, position, and/or orientation of the hand gesture.

For example, in detail, the projecting device's control unit may modify a visible image being projected based upon the position, orientation, and/or shape of an at least one remote object such that the visible image adapts to the position, orientation, and/or shape of the at least one remote object. The projecting device's control unit may modify a visible image being projected based upon a detected hand gesture such that the visible image adapts to the hand gesture.

Touch Hand Gesture Sensing with Position Indicator

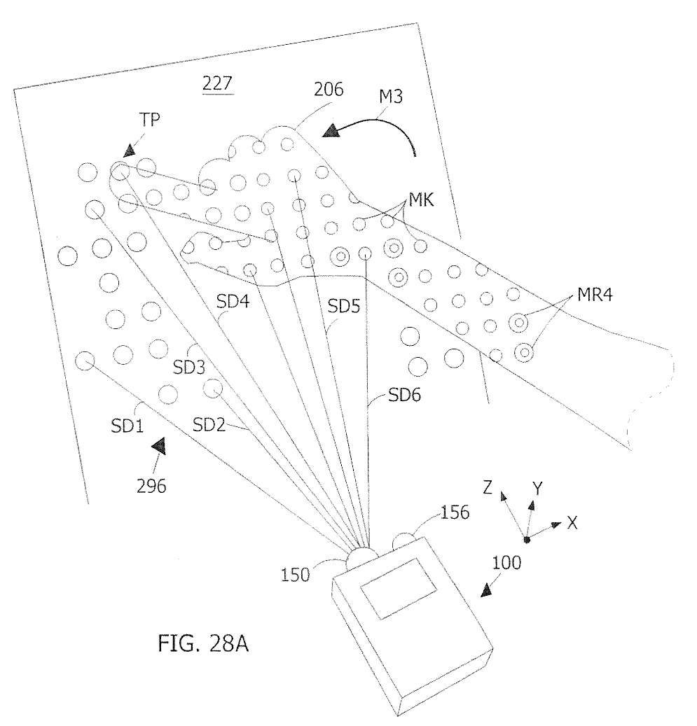

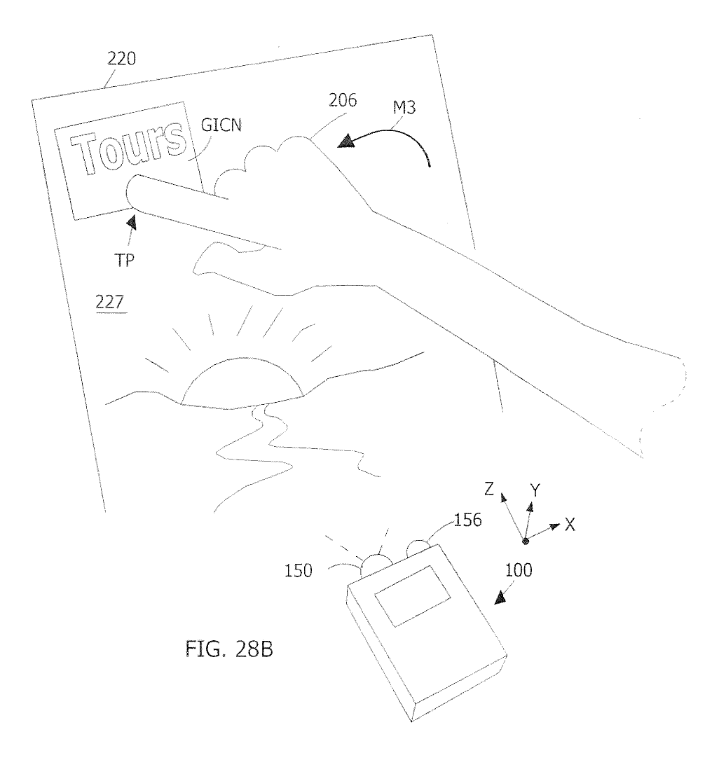

Turning now to FIG. 28A, thereshown is a perspective view (of position indicator light) of the handheld projecting device 100 shown illuminating a position indicator 296 on a user's hand 206 and remote surface 227. The user hand 206 is making a touch hand gesture (as denoted by arrow M3), wherein the hand 206 touches the surface 227 at touch point TP. As can be seen, the position indicator's 296 markers, such as markers MK and reference markers MR4, may be utilized for 3D depth sensing of the surrounding surfaces. (To simplify the illustration, all illuminated markers are not denoted.)

In operation, device 100 and projector 150 illuminate the environment with the position indicator 296. Then while the position indicator 296 appears on the user hand 206 and surface 227, the device 100 may enable the image sensor 156 to capture an image frame of the view forward of sensor 156 and use computer vision functions (such as the depth analyzer 133 and surface analyzer 134 of FIG. 3) to collect 3D depth information.

Device 100 may further compute one or more spatial surface distances to the remote surface 227, such as surface distances SD1-SD3. Moreover, device 100 may compute one or more surface distances to the user hand 206, such as surface distances SD4-SD6. Subsequently, the device 100 may then create and store (in data storage) 21) surfaces, 3D meshes, and 3D objects that represent the hand 206 and remote surface 227. Then using computer vision techniques, device 100 may be operable to detect when a touch hand gesture occurs, such as when hand 206 moves and touches the remote surface 227 at touch point TP. The device 100 may then respond to the touch hand gesture by generating multimedia effects in accordance to a touch hand gesture at touch point TP on remote surface 227.

For example, FIG. 28B shows a perspective view (of visible image light) of the projecting device 100, while the user hand 206 is making a touch hand gesture (as denoted by arrow M3), wherein the hand 206 touches surface 227 at touch point TP. Whereby, upon detecting the touch hand gesture, device 100 may modify the projected visible image 220, generate audible sound, and/or create haptic vibratory effects in accordance to the touch hand gesture. In this case, a graphic icon GICN reading “Tours” may be touched and modified in accordance to the hand touch at touch point TP. For example, after the user touches icon GICN, the projected visible image 220 may show “Prices” for all tours available. Understandably, alternative types of touch hand gestures and generated multimedia effects in response to touch hand gestures may be considered as well.

### Method for Touch Hand Gesture Sensing

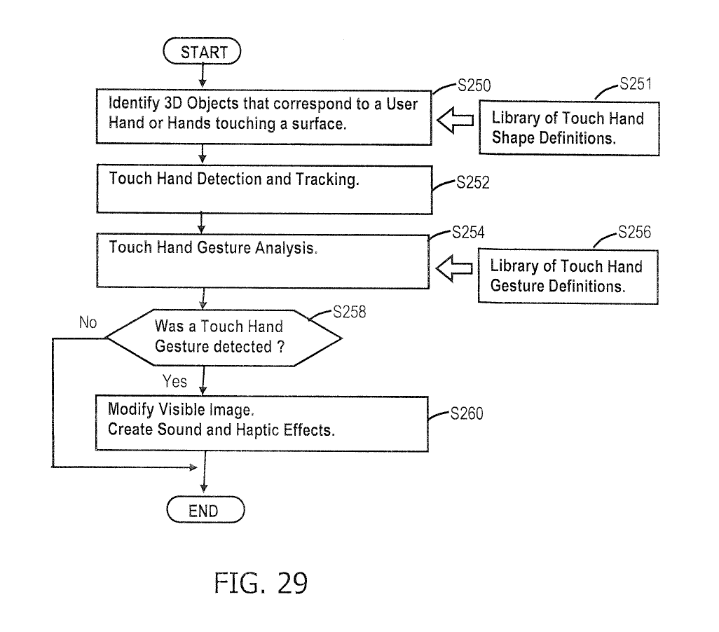

Turning now to FIG. 29, a flowchart of a computer implemented method is presented that details touch hand gesture sensing, although alternative methods may be considered. The method may be implemented, for example, in the gesture analyzer (reference numeral 137 of FIG. 3) and executed by at least one control unit (reference numeral 110 of FIG. 3). The method may be continually invoked (e.g., every 1/30 second) by a high-level method (such as step S111 of FIG. 18).

Starting with step S250, the projecting device identifies each 3D object (as detected by the method of FIG. 21) previously stored in data storage (e.g., reference numeral 144 of FIG. 3) that represents a user's hand touch. That is, the device may take each 3D object and search for a match in a library of touch hand shape definitions (e.g., of predetermined 3D object models of a hand touching a surface in various poses), as indicated by step S251. Computer vision techniques and gesture analysis methods (e.g., 3D shape matching) may be adapted from current art to identify a user's hand touch.

In step S252, the projecting device further tracks any identified user hand touch (from step S250). The projecting device may accomplish touch hand tracking by extracting spatial features of the 3D object that represents a user hand touch (e.g., such as tracking the outline of the hand, finding vertices or convexity defects between thumb/fingers, and locating the touched surface and touch point, etc.) and storing in data storage a history of touch hand tracking data (reference numeral 146 of FIG. 3). Whereby, position, orientation, and velocity of the user's touching hand/or hands may be tracked over time.

In step S254, the projecting device completes touch gesture analysis of the previously recorded touch hand tracking data. That is, the device may take the recorded touch hand tracking data and search for a match in a library of touch gesture definitions (e.g., as predetermined object/motion models of index finger touch, open hand touch, etc.), as indicated by step S256. This may be completed by gesture matching and detection techniques (e.g., hidden Markov model, neural network, finite state machine, etc.) adapted from current art.

In step S258, if the projecting device detects and identifies a touch hand gesture, the method continues to step S250. Otherwise, the method ends.

Finally, in step S250, in response to the detected touch hand gesture being made, the projecting device may generate multimedia effects, such as the generation of graphics, sound, and/or haptic effects, that correspond to the type, position, and orientation of the touch hand gesture.

For example, in detail, the projecting device's control unit may modify a visible image being projected based upon the detected touch hand gesture such that the visible image adapts to the touch hand gesture. The projecting device's control unit may modify a visible image being projected based upon a determined position of a touch hand gesture on a remote surface such that the visible image adapts to the determined position of the touch hand gesture on the remote surface.

### Interactive Images for Multiple Projecting Devices

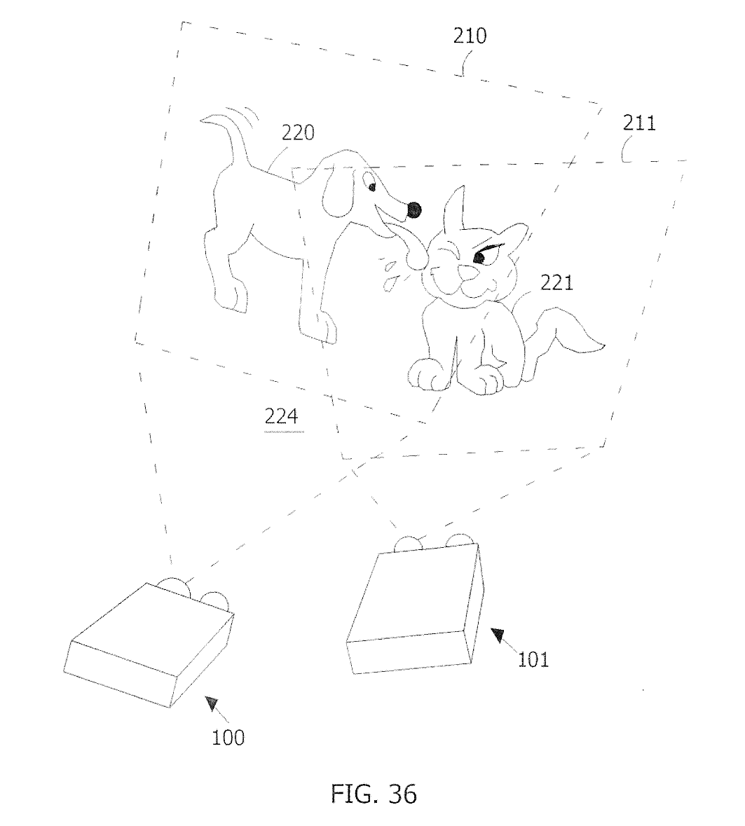

Turning briefly ahead to FIG. 36, a perspective view is shown of two projecting devices 100 and 101 with interactive images. In particular, first projecting device 100 creates a first visible image 220 (of a dog), while second projecting device 101 creates a second visible image 221 (of a cat). The second device 101 may be constructed similar to the first device 100 (as shown in FIG. 3). Wherein, devices 100 and 101 may each include communication interface (as shown in FIG. 3, reference numeral 118) for data communication.

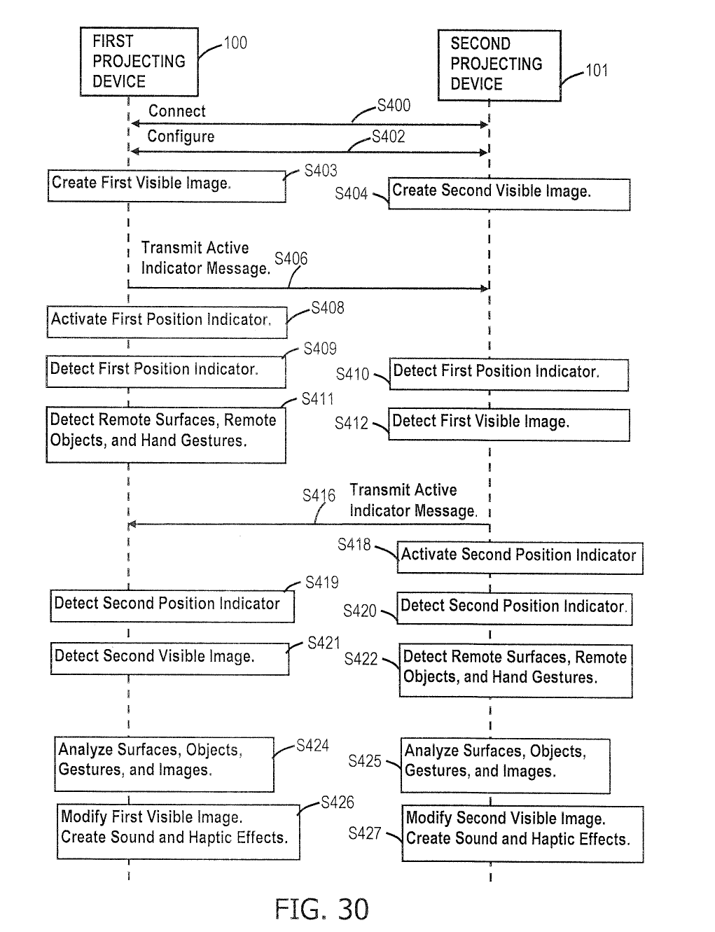

So now referring back to FIG. 30, a high-level sequence diagram is presented of an image sensing operation with handheld projecting devices 100 and 101.

Start-Up:

Beginning with step S400, first device 100 and second device 101 discover each other by communicating signals using their communication interfaces (reference numeral 118 in FIG. 3). That is, first and second devices 100 and 101 may wirelessly connect (or by wire) for data communication (e.g., Bluetooth, wireless USB, etc.). Then in step S402, devices 100 and 101 may configure and exchange data settings so that both devices can interoperate. Finally, in step S403, the first device 100 projects the first visible image, and in step S404, the second device 101 projects the second visible image (as discussed earlier in FIG. 36).

First Phase:

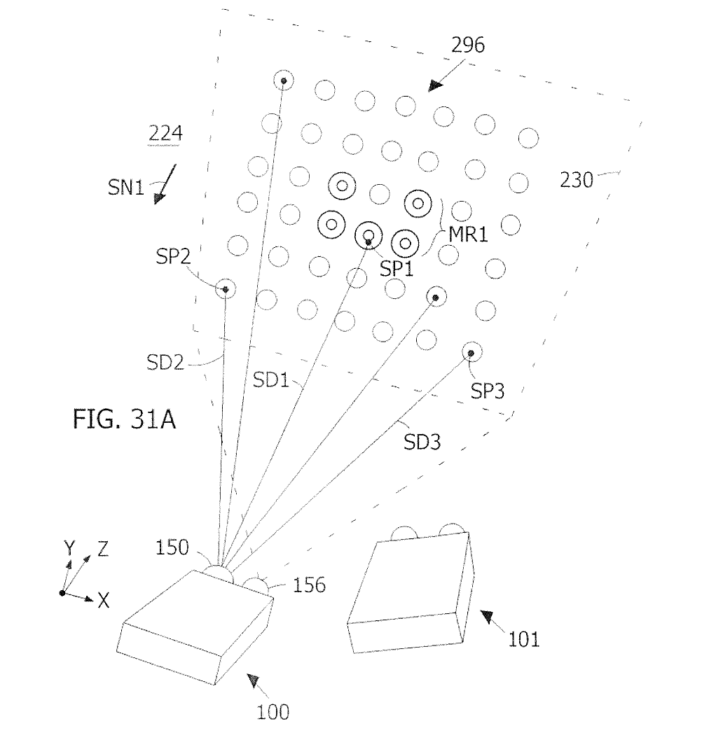

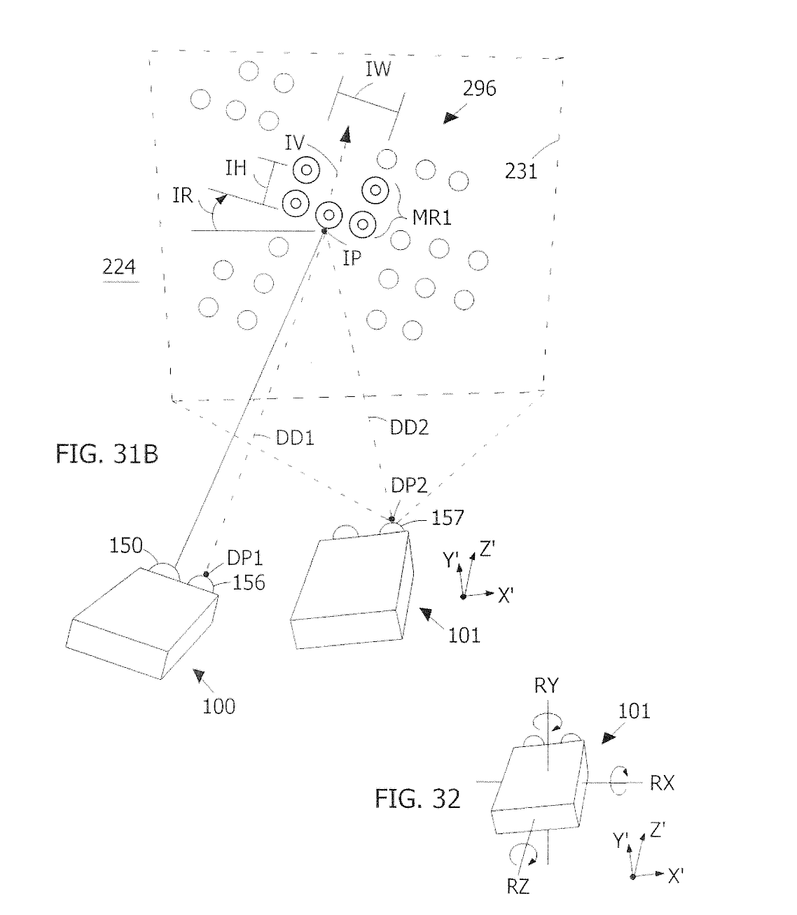

In step S406, devices 100 and 101 start the first phase of operation. To begin, the first device 100 may create and transmit a data message, such as an “active indicator” message (e.g., Message Type=“Active Indicator”, Timestamp=“12:00:00”, Device Id=“100”, Image=“Dog licking”, Image Outline=[5,20; 15,20; 15,30; 5,30], etc.) that may contain image related data about the first device 100, including a notification that its position indicator is about to be illuminated.

Whereby, in step S408, the first device 100 may illuminate a first position indicator for a predetermined period of time (e.g., 0.01 seconds) so that other devices may observe the indicator. So briefly turning to FIG. 31A, thereshown is device 100 illuminating position indicator 296 on remote surface 224.

Then at steps S409-412 of FIG. 30, both first and second devices 100 and 101 may attempt to view the first position indicator. In steps S409 and S411, first device 100 may enable its image sensor, capture and analyze at least one image frame for a detectable position indicator, and try to detect a remote surface. So turning briefly to FIG. 31A, thereshown is the first device 100 and detected position indicator 296 in image sensor's 156 view region 230. First device 100 may then transform the detected indicator 296 into remote surface-related information (e.g., surface position, orientation, etc.) that corresponds to at least one remote surface 224. In addition, first device 100 may analyze the remote surface information and perhaps detect remote objects and user hand gestures in the vicinity.

Then at steps S410 and S412 of FIG. 30, the second device 101 may receive the “active indicator” message from the first device 100. Whereupon, second device 101 may enable its image sensor, capture and analyze at least one image frame for a detectable position indicator, and try to detect a projected visible image. So turning briefly to FIG. 31B, thereshown is second device 101 and detected position indicator 296 in image sensor's 157 view region 231. Second device 101 may then transform the detected indicator 296 into image-related information (e.g., image position, orientation, size, etc.) that corresponds to the first visible image of the first device 100.

Second Phase:

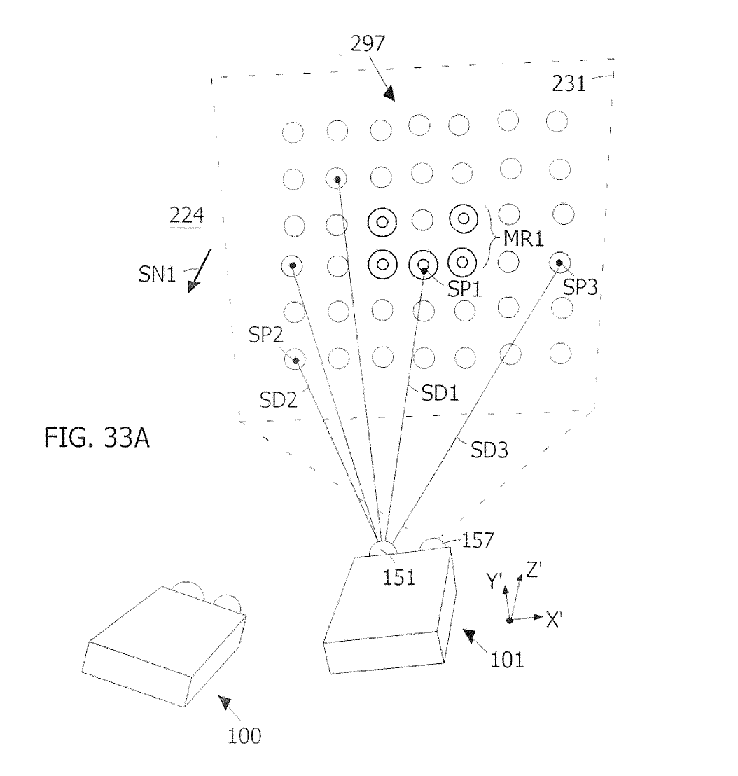

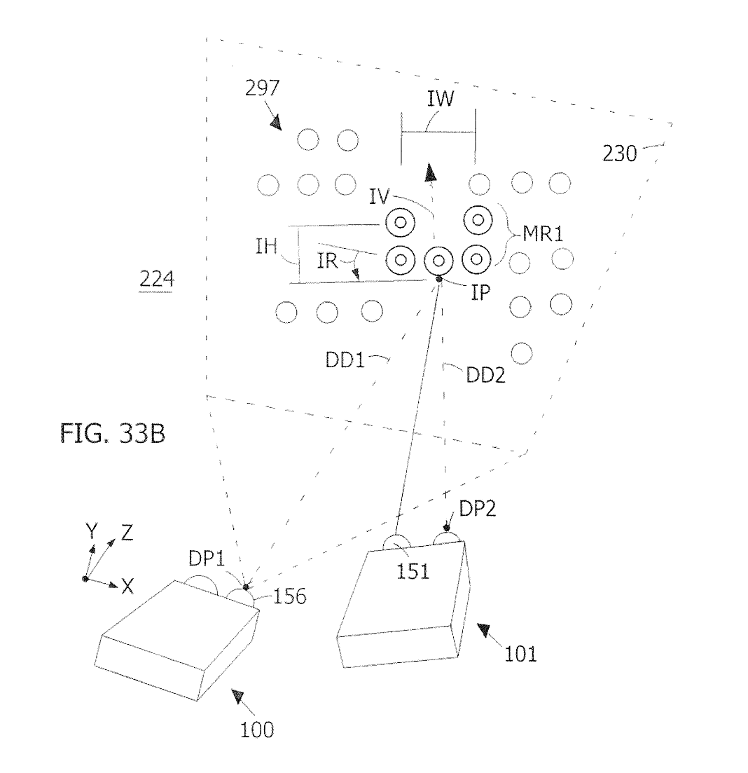

Now in step S416, devices 100 and 101 begin the second phase of operation. To start, the second device 101 may create and transmit a data message, such as an “active indicator” message (e.g., Message Type=“Active Indicator”, Timestamp=“12:00:02”, Device Id=“101”, Image=“Cat sitting”, Image Outline=[5,20; 15,20; 15,30; 5,30], etc.) that may contain image related data about the second device 101, including a notification that its position indicator is about to be illuminated.

Whereby, at step S418, second device 101 may now illuminate a second position indicator for a predetermined period of time (e.g., 0.01 seconds) so that other devices may observe the indicator. So briefly turning to FIG. 33A, thereshown is second device 101 illuminating position indicator 297 on remote surface 224.

Then at steps S419-422 of FIG. 30, both first and second devices 100 and 101 may attempt to view the second position indicator. In steps S420 and S421, second device 101 may enable its image sensor, capture and analyze at least one image frame for a detectable position indicator, and try to detect a remote surface. So turning briefly to FIG. 33A, thereshown is the second device 101 and the detected position indicator 297 in image sensor's 157 view region 231. Second device 101 may then transform the detected indicator 297 into remote surface related information (e.g., surface position, orientation, etc.) that corresponds to at least one remote surface 224. In addition, second device 101 may analyze the remote surface information and perhaps detect remote objects and user hand gestures in the vicinity.

Then at steps S419 and S421 of FIG. 30, the first device 100 may receive the “active indicator” message from the second device 101. Whereupon, first device 100 may enable its image sensor, capture and analyze at least one image frame for a detectable position indicator, and try to detect a projected visible image. So turning briefly to FIG. 33B, thereshown is first device 100 and detected position indicator 297 in image sensor's 156 view region 230. First device 100 may then transform the detected indicator 297 into image-related information (e.g., image position, orientation, shape, etc.) that corresponds to the second visible image of the second device 101.

Subsequently, in steps S424 and S425, the first and second devices 100 and 101 may analyze their acquired environment information (from steps S406-S422), such as spatial information related to remote surfaces, remote objects, hand gestures, and projected images from other devices.

Then in step S426, the first device 100 may present multimedia effects in response to the acquired environment information (e.g., surface location, image location, image content, etc.) of the second device 101. For example, first device 100 may create a graphic effect (e.g., modify its first visible image), a sound effect (e.g., play music), and/or a vibratory effect (e.g., where first device vibrates) in response to the detected second visible image of the second device 101, including any detected remote surfaces, remote objects, and hand gestures.

In step S427, second device 101 may also present multimedia sensory effects in response to received and computed environmental information (e.g., surface location, image location, image content, etc.) of the first device 100. For example, second device 101 may create a graphic effect (e.g., modify its second visible image), a sound effect (e.g., play music), and/or a vibratory effect (e.g., where second device vibrates) in response to the detected first visible image of the first device 100, including any detected remote surfaces, remote objects, and hand gestures.

Moreover, the devices continue to communicate. That is, steps S406-S427 may be continually repeated so that both devices 100 and 101 may share, but not limited to, their image-related information. As a result, devices 100 and 101 remain aware of each other's projected visible image. The described image sensing method may be readily adapted for operation of three or more projecting devices. Fixed or variable time slicing techniques, for example, may be used for synchronizing image sensing among devices.

Understandably, alternative image sensing methods may be considered that use, but not limited to, alternate data messaging, ordering of steps, and different light emit/sensing approaches. Various methods may be used to assure that a plurality of devices can discern a plurality of position indicators, such as but not limited to:

1) A first and second projecting device respectively generate a first and a second position indicator in a substantially mutually exclusive temporal pattern; wherein, when the first projecting device is illuminating the first position indicator, the second projecting device has substantially reduced illumination of the second position indicator (as described in FIG. 30.)

2) In an alternative approach, a first and second projecting device respectively generate a first and second position indicator at substantially the same time; wherein, the first projecting device utilizes a captured image subtraction technique to optically differentiate and detect the second position indicator. Computer vision techniques (e.g., image subtraction, brightness analysis, etc.) may be adapted from current art.

3) In another approach, a first and second projecting device respectively generate a first and second position indicator, each having a unique light pattern; wherein, the first device utilizes an image pattern matching technique to optically detect the second position indicator. Computer vision techniques (e.g., image pattern matching, etc.) may be adapted from current art.

Image Sensing with Position Indicators

So turning now to FIGS. 31A-36, thereshown are perspective views of an image sensing method for first projecting device 100 and second projecting device 101, although alternative methods may be considered as well. The second device 101 may be constructed and function similar to the first device 100 (as shown in FIG. 3). Wherein, devices 100 and 101 may each include communication interface (reference numeral 118 of FIG. 3) for data communication. For illustrative purposes, some of the position indicators are only partially shown in respect to the position indicator of FIG. 15.

First Phase:

So starting with FIG. 31A, in an example image sensing operation of devices 100 and 101, the first device 100 may illuminate (e.g., for 0.01 second) its first position indicator 296 on surface 224. Subsequently, first device's 100 image sensor 156 may capture an image frame of the first position indicator 296 within view region 230. The first device 100 may then use its depth analyzer and surface analyzer (reference numerals 133 and 134 of FIG. 3) to transform the captured image frame of the position indicator 296 (with reference marker MR1) into surface points, such as surface points SP1-SP3 with surface distances SD1-SD3, respectively. Moreover, first device 100 may compute the position, orientation, and/or shape of at least one remote surface, such as remote surface 224 having surface normal vector SN 1.

Then in FIG. 31B, the second device 101 may also try to observe the first position indicator 296. Second device's 101 image sensor 157 may capture an image frame of the first position indicator 296 within view region 231. Wherein, the second device 101 may analyze the captured image frame and try to locate the position indicator 296. If at least a portion of indicator 296 is detected, the second device 101 may compute various metrics of indicator 296 within the image frame, such as, but not limited to, an indicator position IP, an indicator width IW, an indicator height IH, and/or an indicator rotation IR. Indicator position IP may be a computed position (e.g., IP=[40.32, 50.11] pixels) based on, for example, at least one reference marker, such as marker MR1. Indicator width IW may be a computed width (e.g., IW=10.45 pixels). Indicator height IH may be a computed height (e.g., IH=8.26 pixels). Indicator rotation IR may be a computed rotation angle (e.g., IR=−20.35 degrees) based on, for example, a rotation vector IV associated with the rotation of position indicator 296 on the image frame.

Finally, the second device 101 may computationally transform the indicator metrics into 3D spatial position, orientation, and shape information. This computation may rely on computer vision functions (e.g., camera pose estimation, homography, projective geometry, etc.) adapted from current art. For example, the second device 101 may compute its device position DP2 (e.g., DP2=[100,−200,200] cm) relative to indicator 296 and/or device position DP1. The second device 101 may compute its device spatial distance DD2 (e.g., DD2=300 cm) relative to indicator 296 and/or device position DP1. The first position indicator 296 may have a one-fold rotational symmetry such that the second device 101 can determine a rotational orientation of the first position indicator 296. That is, the second device 101 may compute its orientation as device rotation angles (as shown by reference numerals RX, RY, RZ of FIG. 32) relative to position indicator 296 and/or device 100.

As a result, referring briefly to FIG. 36, the second device 101 may transform the collected spatial information described above and compute the position, orientation, and shape of the projected visible image 220 of the first device 100, which will be discussed in more detail below.

Second Phase:

Then turning back to FIG. 33A to continue the image sensing operation, the first device 100 may deactivate its first position indicator, and the second device 101 may illuminate (e.g., for 0.01 second) its second position indicator 297 on surface 224. Subsequently, second device's 101 image sensor 157 may capture an image frame of the illuminated position indicator 297 within view region 231. The second device 101 may then use its depth analyzer and surface analyzer (reference numerals 133 and 134 of FIG. 3) to transform the captured image frame of the position indicator 297 (with reference marker MR1) into surface points, such as surface points SP1-SP3 with surface distances SD1-SD3, respectively. Moreover, second device 101 may compute the position, orientation, and/or shape of at least one remote surface, such as remote surface 224 having surface normal vector SN1.

Then in FIG. 33B, the first device 100 may also try to observe position indicator 297. First device's 100 image sensor 156 may capture an image frame of the illuminated position indicator 297 within view region 230. Wherein, the first device 100 may analyze the captured image frame and try to locate the position indicator 297. If at least a portion of indicator 297 is detected, the first device 100 may compute various metrics of indicator 297 within the image frame, such as, but not limited to, an indicator position IP, an indicator width IW, an indicator height IH, and/or an indicator rotation IR based on, for example, a rotation vector IV.

The first device 100 may then computationally transform the indicator metrics into 3D spatial position, orientation, and shape information. Again, this computation may rely on computer vision functions (e.g., camera pose estimation, homography, projective geometry, etc.) adapted from current art. For example, the first device 100 may compute its device position DP1 (e.g., DP1=[0,−200,250] cm) relative to indicator 297 and/or device position DP2. The first device 100 may compute its device spatial distance DD1 (e.g., DD1=320 cm) relative to indicator 297 and/or device position DP2. The second position indicator 297 may have a one-fold rotational symmetry such that the first device 100 can determine a rotational orientation of the second position indicator 297. That is, first device 100 may compute its orientation as device rotation angles (not shown, but analogous to reference numerals RX, RY, RZ of FIG. 32) relative to indicator 297 and/or device 101.

As a result, referring briefly to FIG. 36, the first device 100 may transform the collected spatial information described above and compute the position, orientation, and shape of the projected visible image 221 of the second device 101, which will be discussed in more detail below.

Method for Image Sensing with a Position Indicator

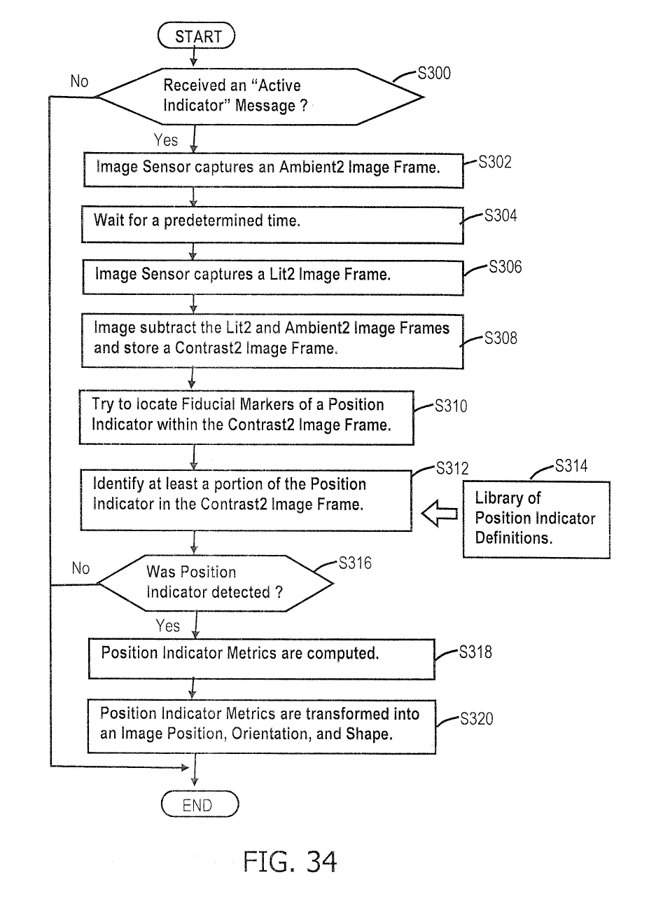

Turning now to FIG. 34, presented is a flowchart of a computer implemented method that enables a projecting device to determine the position, orientation, and/or shape of a projected visible image from another device using a position indicator, although alternative methods may be considered as well. The method may be implemented, for example, in the position indicator analyzer (reference numeral 136 of FIG. 3) and executed by at least one control unit (reference numeral 110 of FIG. 3). The method may be continually invoked (e.g., every 1/30 second) by a high-level method (such as step S112 of FIG. 18). The projecting device is assumed to have a communication interface (such as reference numeral 118 of FIG. 3) for data communication.

Starting with step S300, if the projecting device and its communication interface has received a data message, such as an “active indicator” message from another projecting device, the method continues to step S302. Otherwise, the method ends. An example “active indicator” message may contain image related data (e.g., Message Type=“Active Indicator”, Timestamp=“12:00:02”, Device Id=“101”, Image=“Cat sitting”, Image Outline=[10,20; 15,20; 15,30; 10,30], etc.), including a notification that a position indicator is about to be illuminated.

In step S302, the projecting device enables its image sensor (reference numeral 156 of FIG. 3) to capture an ambient2 image frame of the view forward of the image sensor. The device may store the ambient2 image frame in the image frame buffer (reference numeral 142 of FIG. 3) for future image processing.

In step S304, the projecting device waits for a predetermined period of time (e.g., 0.015 second) until the other projecting device (which sent the “active indicator” message from step S300) illuminates its position indicator.

In step S306, once the position indicator (of the other device) has been illuminated, the projecting device enables its image sensor (reference numeral 156 of FIG. 3) to capture a lit2 image frame of the view forward of the image sensor. The device stores the lit2 image frame in the image frame buffer (reference numeral 142 of FIG. 3) as well.

Continuing to step S308, the projecting device uses image processing techniques to optionally remove unneeded graphic information from the collected image frames. For example, the device may conduct image subtraction of the lit2 image frame (from step S306) and the ambient2 image frame (from step S302) to generate a contrast2 image frame. Whereby, the contrast2 image frame may be substantially devoid of ambient light and content, such walls and furniture, while capturing any position indicator that may be in the vicinity. The projecting device may assign metadata (e.g., frame id=25, frame type=“contrast2”, etc.) to the contrast2 image frame for easy lookup, and store the contrast2 image frame in the image frame buffer (reference numeral 142 of FIG. 3) for future reference.

Then in step S310, the projecting device analyzes at least one captured image frame, such as the contrast2 image frame (from step S308), located in the image frame buffer (reference numeral 142 of FIG. 3). The device may analyze the contrast2 image frame for an illuminated pattern of light. This may be accomplished with computer vision techniques (e.g. edge detection, segmentation, etc.) adapted from current art.

The projecting device then attempts to locate at least one fiducial marker or “marker blob” of a position indicator within the contrast2 image frame. A “marker blob” is a shape or pattern of light appearing within the contrast2 image frame that provides positional information. One or more fiducial reference markers (such as denoted by reference numeral MR1 of FIG. 14) may be used to determine the position, orientation, and/or shape of the position indicator within the contrast2 image frame. Wherein, the projecting device may define for reference any located fiducial markers (e.g., marker id=1, marker location=[10,20]; marker id=2, marker location[15,30]; etc.).

The projecting device may also compute the position (e.g., in sub-pixel centroids) of any located fiducial markers of the position indicator within the contrast2 image frame. For example, computer vision techniques for determining fiducial marker positions, such as the computation of “centroids” or centers of marker blobs, may be adapted from current art.

Then in step S312, the projecting device attempts to identify at least a portion of the position indicator within the contrast2 image frame. That is, the projecting device may search for a matching pattern in a library of position indicator definitions (e.g., containing dynamic and/or predetermined position indicator patterns), as indicated by step S314. The pattern matching process may respond to changing orientations of the position indicator within 3D space to assure robustness of pattern matching. To detect a position indicator, the projecting device may use computer vision techniques (e.g., shape analysis, pattern matching, projective geometry, etc.) adapted from current art.

In step S316, if the projecting device detects at least a portion of the position indicator, the method continues to step S318. Otherwise, the method ends.

In step S318, the projecting device may discern and compute position indicator metrics (e.g., indicator height, indicator width, indicator rotation angle, etc.) by analyzing the contrast2 image frame containing the detected position indicator.

Continuing to step S320, the projecting device computationally transforms the position indicator metrics (from step S318) into 3D spatial position and orientation information. This computation may rely on computer vision functions (e.g., coordinate matrix transformation, projective geometry, homography, and/or camera pose estimation, etc.) adapted from current art. For example, the projecting device may compute its device position relative to the position indicator and/or another device. The projecting device may compute its device spatial distance relative to the position indicator and/or another device. Moreover, the projecting device may further compute its device rotational orientation relative to the position indicator and/or another device.

The projecting device may be further aware of the position, orientation, and/or shape of at least one remote surface in the vicinity of the detected position indicator (as discussed in FIG. 21).

Finally the projecting device may compute the position, orientation, and/or shape of another projecting device's visible image utilizing much of the above computed information. This computation may entail computer vision techniques (e.g., coordinate matrix transformation, projective geometry, etc.) adapted from current art.

### Image Sensing and Projection Regions

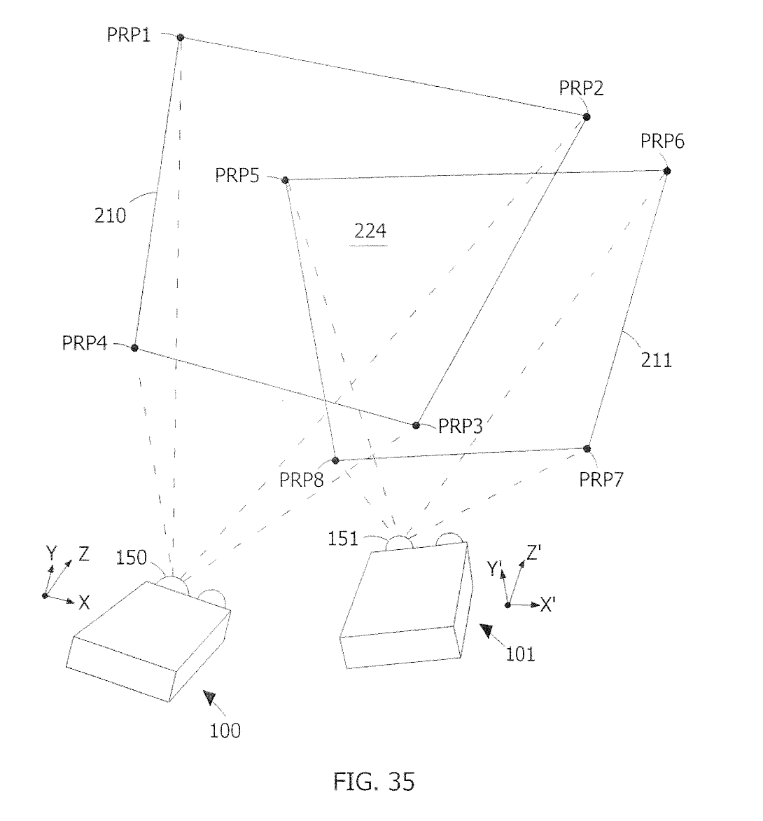

FIG. 35 shows a perspective view of devices 100 and 101 that are spatially aware of their respective projection regions 210 and 211 on remote surface 224. As presented, device 100 may compute its projection region 210 for projector 150, and device 101 may compute its projection region 211 for projector 151 (e.g., as described earlier in FIGS. 23-25). Device 100 may compute the position, orientation, and shape of projection region 210 residing on at least one remote surface, such as region points PRP1, PRP2, PRP3, and PRP4. Moreover, device 101 may further compute the position, orientation, and shape of projection region 211 residing on at least one remote surface, such as region points PRP5, PRP6, PRP7, and PRP8.

Image Sensing with Interactive Images

Finally, FIG. 36 shows a perspective view of handheld projecting devices 100 and 101 with visible images that appear to interact. First device 100 has modified a first visible image 220 (of a licking dog) such that the first visible image 220 appears to interact with a second visible image 221 (of a sitting cat). Subsequently, the second device 101 has modified the second visible image 221 (of the cat squinting at the dog) such that the second visible image 221 appears to interact with the first visible image 220. The devices 100 and 101 with visible images 220 and 221 may continue to interact (such as displaying the dog leaping over the cat).

Also, for purposes of illustration only, the non-visible outlines of projection regions 210 and 211 are shown and appear distorted on surface 224. Yet the handheld projecting devices 100 and 101 create visible images 220 and 221 that remain substantially undistorted and uniformly lit on one or more remote surfaces 224 (as described in detail in FIGS. 23-25). For example, the first device 100 may modify the first visible image 220 such that at least a portion of the first visible image 220 appears substantially devoid of distortion on the at least one remote surface 224. Moreover, the second device 101 may modify the second visible image 221 such that at least a portion of the second visible image 221 appears substantially devoid of distortion on the at least one remote surface 224.

Alternative embodiments may have more than two projecting devices with interactive images. Hence, a plurality of handheld projecting devices can respectively modify a plurality of visible images such that the visible images appear to interact on one or more remote surfaces; wherein, the visible images may be substantially uniformly lit and/or substantially devoid of distortion on the one or more remote surfaces.

Image Sensing with a Combined Image

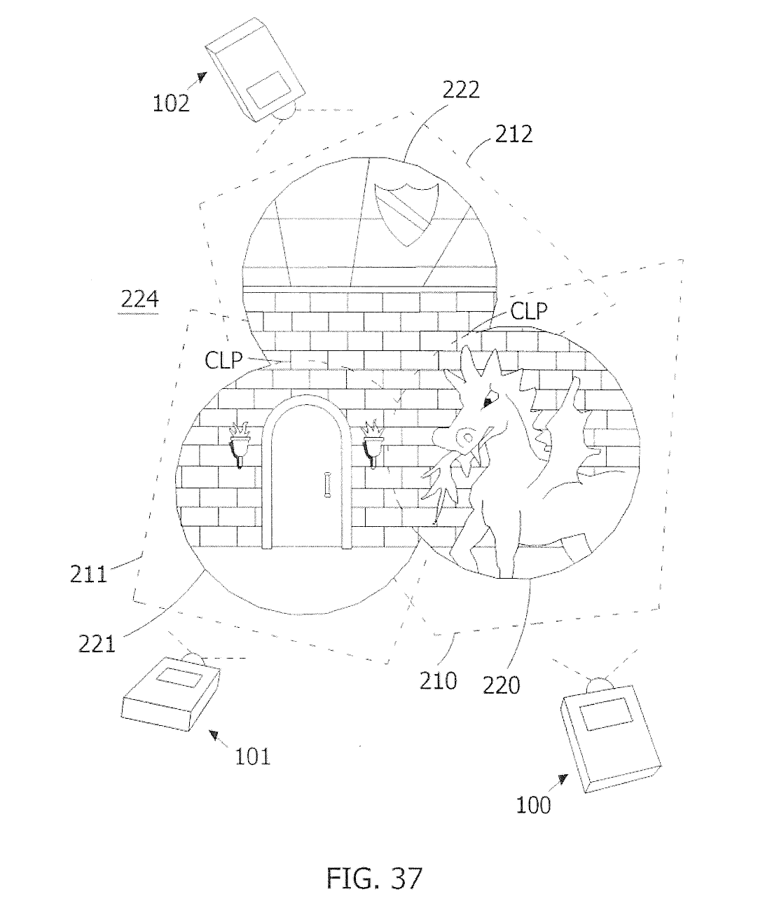

Turning now to FIG. 37, a perspective view is shown of a plurality of handheld projecting devices 100, 101, and 102 that can respectively modify their projected visible images 220, 221, and 222 such that an at least partially combined visible image is formed on one or more remote surfaces 224; wherein, the at least partially combined visible image may be substantially devoid of overlap, substantially uniformly lit, and/or substantially devoid of distortion on the one or more remote surfaces.

During operation, devices 100-102 may compute spatial positions of the overlapped projection regions 210-212 and clipped edges CLP using geometric functions (e.g., polygon intersection functions, etc.) adapted from current art. Portions of images 221-222 may be clipped away from edges CLP to avoid image overlap by using image shape modifying techniques (e.g., black colored pixels for background, etc.). Images 220-222 may then be modified using image transformation techniques (e.g., scaling, rotation, translation, etc.) to form an at least partially combined visible image. Images 220-222 may also be substantially undistorted and uniformly lit on one or more remote surfaces 224 (as described earlier in FIGS. 23-25), including on multi-planar and non-planar surfaces.

### Color-IR-Separated Handheld Projecting Device

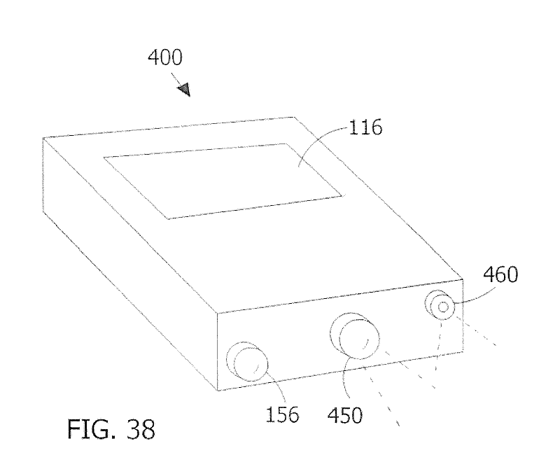

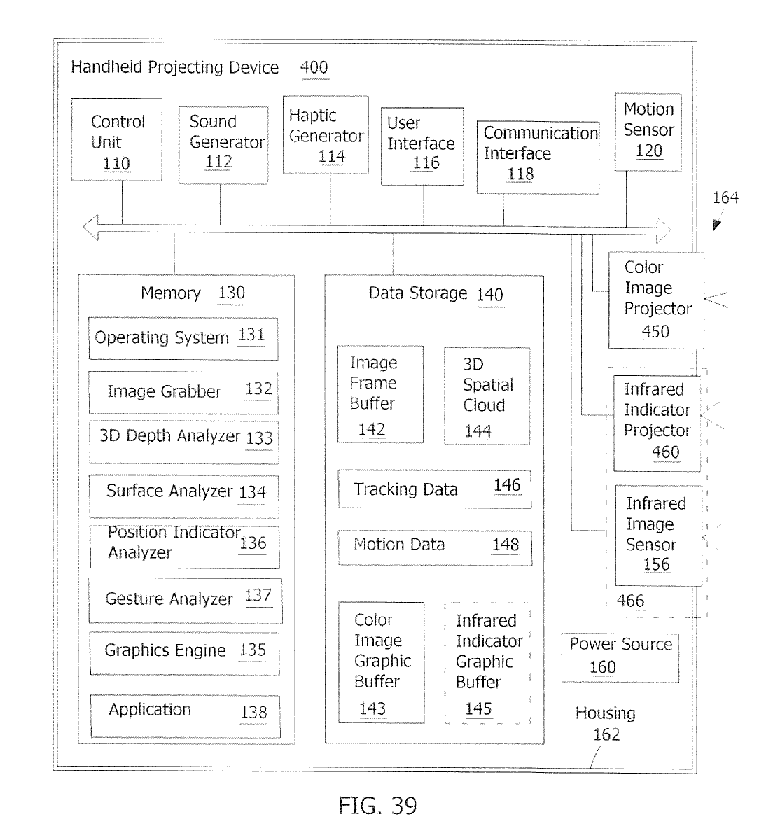

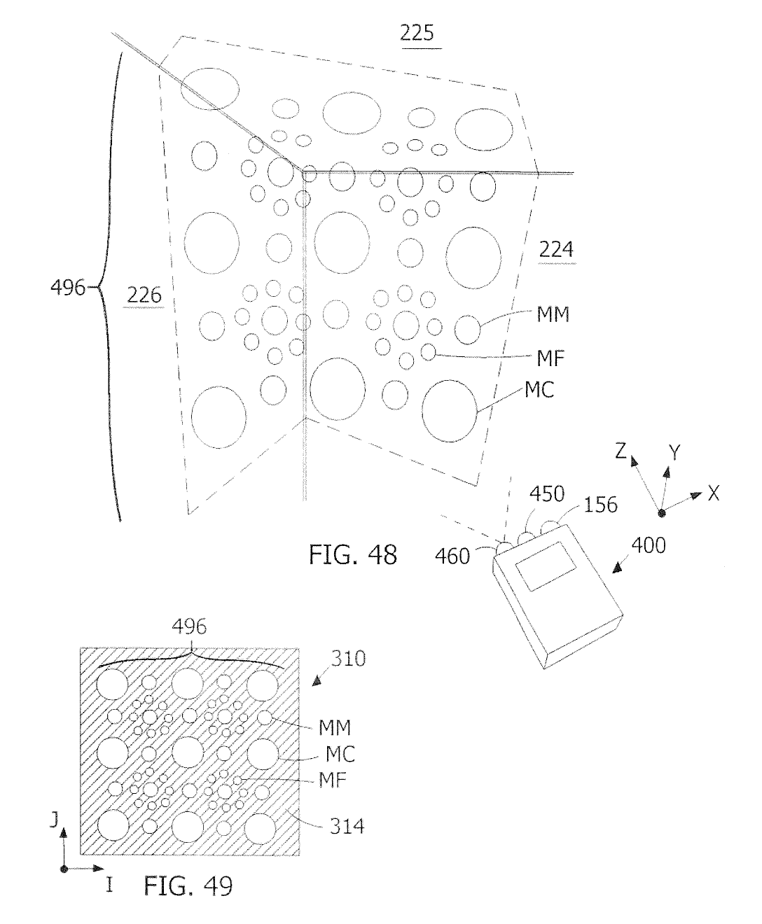

Turning now to FIG. 38, a perspective view of a second embodiment of the disclosure is presented, referred to as a color-IR-separated handheld projecting device 400. Though projecting device 400 is similar to the previous projecting device (as shown earlier in FIGS. 1-37), there are some modifications.

Whereby, similar parts use similar reference numerals in the given Figures. As FIGS. 38 and 39 show, the color-IR-separated projecting device 400 may be similar in construction to the previous color-IR projecting device (as shown in FIGS. 1 and 3) except for, but not limited to, the following: the previous color-IR image projector has been replaced with a color image projector 450; an infrared indicator projector 460 has been added to the device 400; and the previous position indicator has been replaced with a multi-resolution position indicator 496 as shown in FIG. 48.

So turning to FIG. 39, a block diagram is presented of components of the color-IR-separated handheld projecting device 400, which may be comprised of, but not limited to, outer housing 162, control unit 110, sound generator 112, haptic generator 114, user interface 116, communication interface 118, motion sensor 120, color image projector 450, infrared indicator projector 460, infrared image sensor 156, memory 130, data storage 140, and power source 160. Most of these components may be constructed and function similar to the previous embodiment's components (as defined in FIG. 3). However, two components shall be discussed in greater detail.

### Color Image Projector

In FIG. 39, located at a front end 164 of device 400 is the color image projector 450, which can, but not limited to, project a “full-color” (e.g., red, green, blue) visible image on a remote surface. Projector 450 may be operatively coupled to the control unit 110 such that the control unit 110, for example, may transmit graphic data to projector 450 for display. Projector 450 may be of compact size, such as a pico projector. Projector 450 may be comprised of a DLP-, a LCOS-, or a laser-based image projector, although alternative image projectors may be considered as well.

### Infrared Indicator Projector

Also shown in FIG. 39, located at the front end 164 of device 400 is the infrared indicator projector 460, operable to generate at least one infrared position indicator on a remote surface. The indicator projector 460 may be operatively coupled to the control unit 110 such that the control unit 110, for example, may transmit graphic data or modulate a signal to projector 460 for display of a position indicator. Projector 460 may be comprised of, but not limited to, at least one of an infrared light emitting diode, an infrared laser diode, a DLP-based infrared projector, a LCOS-based infrared projector, or a laser-based infrared projector that generates at least one infrared pattern of light. In certain embodiments, the infrared indicator projector 460 and infrared image sensor 156 may be integrated to form a 3D depth camera 466 (as denoted by the dashed line), often referred to as a ranging, lidar, time-of-flight, stereo pair, or RGB-D camera, which creates a 3D spatial depth light view. In some embodiments, the color image projector 450 and the infrared indicator projector 460 may be integrated and integrally form a color-IR image projector.

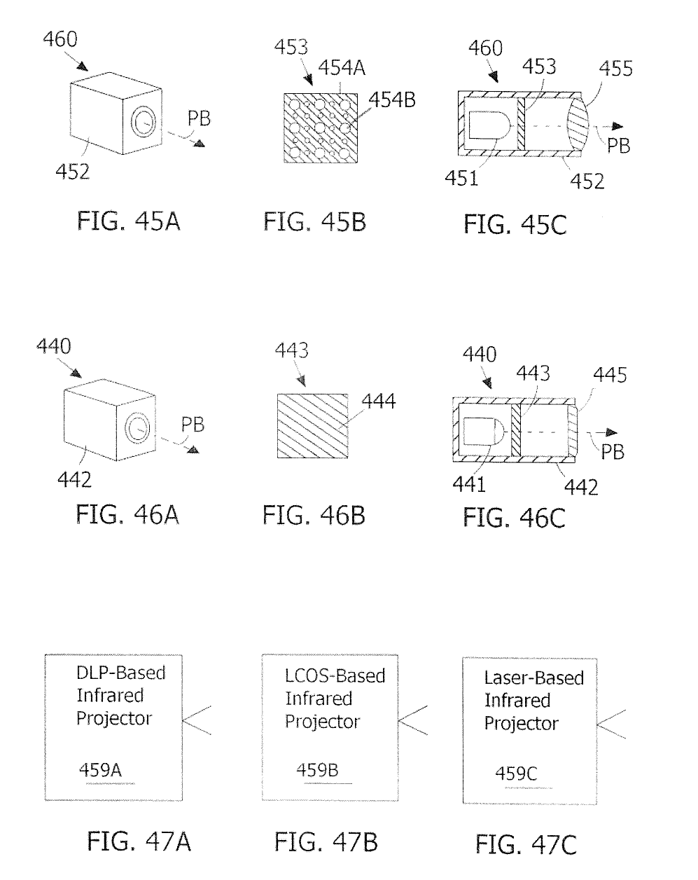

FIGS. 45A-47C show some examples of infrared indicator projectors. For the current embodiment, a low cost indicator projector 460 in FIGS. 45A-45C may be used.

Turning to FIG. 45A, a perspective view shows the low cost indicator projector 460 generating light beam PB from its housing 452 (e.g., 8 mm W×8 mm H×20 mm D). FIG. 45C shows a section view of projector 460 comprised of a light source 451, a light filter 453, and an optical element 455. FIG. 45B shows an elevation view of filter 453, which may be constructed of a light transmissive substrate (e.g., clear plastic sheet) comprised of at least one light transmissive region 454B and at least one light blocking region 454A (e.g., formed by printed ink, embossing, etching, etc.). In FIG. 45C, light source 451 may be comprised of at least one infrared light source (e.g., infrared LED, infrared laser diode, etc.), although other types of light sources may be utilized. Optical element 455 may be comprised of a lens, although other types of optical elements (e.g., complex lens, transparent cover, refractive- and/or diffractive-optical elements) may be used. In operation, light source 451 may emit light filtered by filter 453, transmitted by optical element 455, and thrown forward as beam PB creating a position indicator, such as position indicator 496 of FIG. 48.

Turning to FIG. 46A, a perspective view is shown of an alternative coherent indicator projector 440 that creates light beam PB from its housing 442. FIG. 46C shows a section view of projector 440 comprised of a coherent light source 441, an optical medium 443, and an optical element 445. FIG. 46B shows an elevation view of optical medium 443 comprised of one or more light transmitting elements 444 (e.g., optical diffuser, holographic optical element, diffraction grating, and/or diffractive optical element, etc.). Then in FIG. 46C, light source 441 may be comprised of at least one infrared laser light source (e.g., infrared laser diode, etc.), although other types of light sources may be used. Optical element 445 may comprised of a protective cover, although other types of optical elements (e.g., diffractive and/or refractive optical elements, etc.) may be used. In operation, light source 441 may emit light that is transmitted by medium 443 and optical element 455, creating beam PB that may illuminate a position indicator, such as position indicator 496 of FIG. 48.

Finally, some alternative indicator projectors may be operable to sequentially illuminate a plurality of position indicators having unique patterns of light. For example, U.S. Pat. No. 8,100,540, entitled “Light array projection and sensing system”, describes a projector able to sequentially illuminate patterns of light, the disclosure of which is incorporated here by reference.

FIGS. 47A-47C show other alternative indicator projectors, which are operable to generate dynamic, infrared images. FIG. 47A shows a DLP-based infrared projector 459A; FIG. 47B shows an LCOS-based infrared projector 459B; and FIG. 47C shows a laser-based infrared projector 459C.

### Computer Implemented Methods of the Projecting Device

Turning to FIG. 39, the projecting device 400 may include memory 130 that may contain various computer functions defined as computer implemented methods having computer readable instructions, such as, but not limited to, operating system 131, image grabber 132, depth analyzer 133, surface analyzer 134, position indicator analyzer 136, gesture analyzer 137, graphics engine 135, and application 138. These functions may be constructed and function similar to the previous embodiment's functions (as defined in FIG. 3 and elsewhere).

### Computer Readable Data of the Projecting Device

FIG. 39 also shows data storage 140 may contain various collections of computer readable data (or data sets), such as, but not limited to, image frame buffer 142, 3D spatial cloud 144, tracking data 146, color image graphic buffer 143, infrared indicator graphic buffer 145, and motion data 148. Again, these readable data sets may be constructed and function similar to the previous embodiment's data sets (as defined in FIG. 3 and elsewhere). However, the indicator graphic buffer 145 may be optional, as it may not be required for some low cost, indicator projectors (e.g., shown in FIG. 45A or 46A).

### Configurations for 3D Depth Sensing

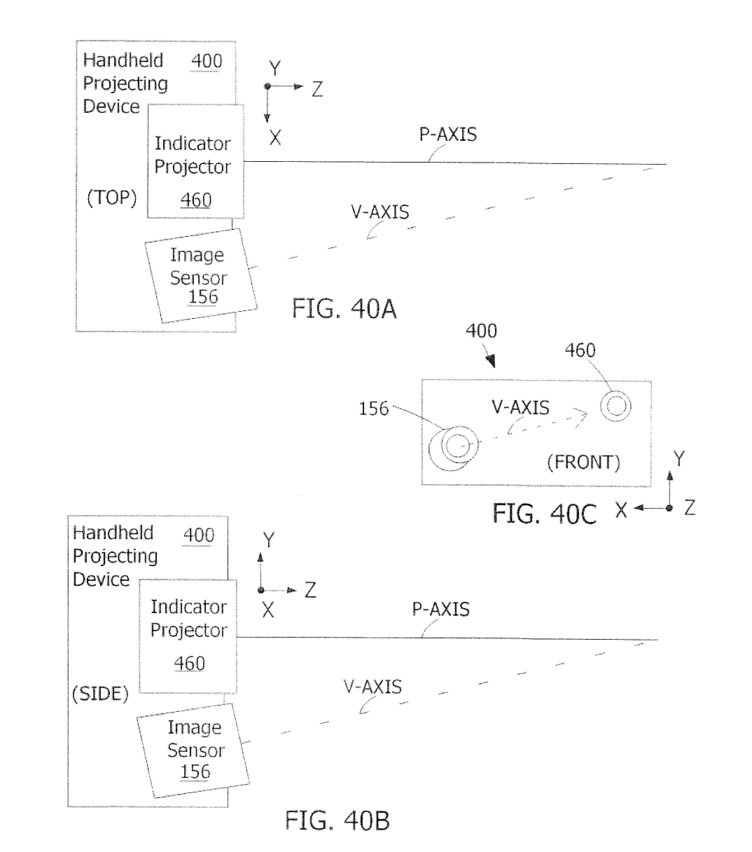

Turning now to FIGS. 40A-40C, there presented are diagrammatic views of an optional configuration of the projecting device 400 for improving the precision and breadth of 3D distance ranging, although alternative configurations may be considered as well. The infrared indicator projector 460 and infrared image sensor 156 are affixed to device 400 at predetermined locations.

FIG. 40A is a top view that shows image sensor's 156 view axis V-AXIS and the indicator projector's 460 projection axis P-AXIS are non-parallel along at least one dimension and may substantially converge forward of device 400. The image sensor 156 may be tilted (e.g., 2 degrees) on the x-z plane, increasing sensing accuracy. FIG. 40B is a side view that shows image sensor 156 may also be tilted (e.g., 1 degree) on the y-z plane, further increasing sensing accuracy. Whereby, FIG. 40C is a front view that shows the image sensor's 156 view axis V-AXIS and the infrared indicator projector's 460 projection axis P-AXIS are non-parallel along at least two dimensions and may substantially converge forward of device 400. Some alternative configurations may tilt the indicator projector 460, or not tilt both the indicator projector 460 and image sensor 156.

### Configurations of Light Projection and Viewing

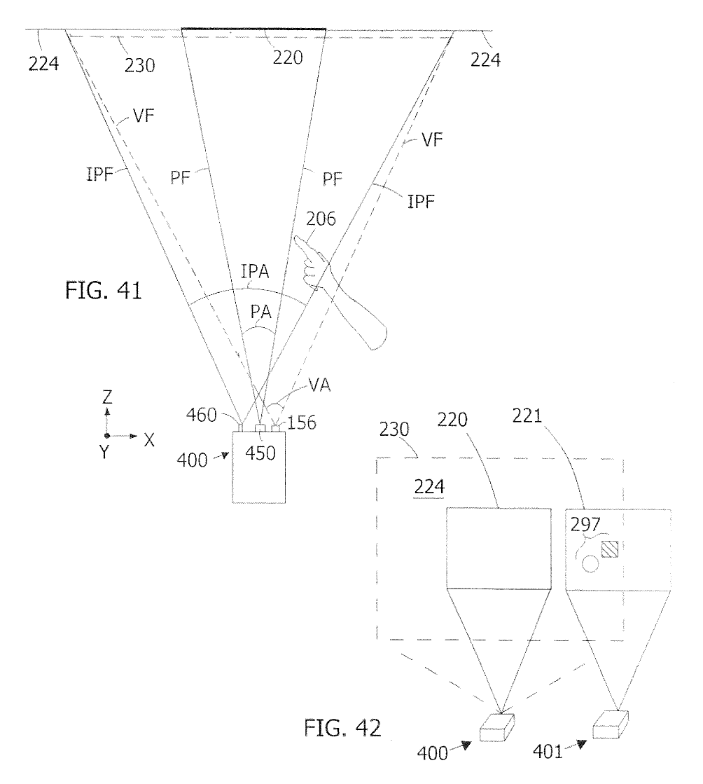

FIGS. 41-44 discuss apparatus configurations for light projection and light viewing by handheld projecting devices, although other alternative configurations may be used as well.

### First Configuration—Wide Infrared Projection and Wide View

Turning now to FIG. 41, thereshown is a top view of a first configuration of the projecting device 400, along with color image projector 450, infrared indicator projector 460, and infrared image sensor 156. Color image projector 450 may illuminate a visible image 220 on remote surface 224, such as a wall. Projector 450 may have a predetermined visible light projection angle PA creating a projection field PF. Moreover, indicator projector 460 illuminates invisible infrared light on remote surface 224. Indicator projector 460 may have a predetermined infrared light projection angle IPA creating an infrared projection field IPF. As shown, the indicator projector's 460 infrared light projection angle IPA (e.g., 70 degrees) may be substantially larger than the image projector's 450 visible light projection angle PA (e.g., 30 degrees).

Further affixed to device 400, the image sensor 156 may have a predetermined light view angle VA where remote objects, such as user hand 206, may be observable within view field VF. As illustrated, the image sensor's 156 view angle VA (e.g., 70 degrees) may be substantially larger than the image projector's 450 visible light projection angle PA (e.g., 30 degrees). The image sensor 156 may be implemented, for example, using a wide-angle camera lens or fish-eye lens. In some embodiments, the image sensor's 156 view angle VA (e.g., 70 degrees) may be at least twice as large as the image projector's 450 visible light projection angle PA (e.g., 30 degrees). Such a configuration enables remote objects (such as user hand 206 making a hand gesture) to enter the view field VF and infrared projection field IPF without entering the visible light projection field PF. An advantageous result occurs: No visible shadows may appear on the visible image 220 when the user hand 206 enters the view field VF and infrared projection field IPF.

FIG. 42 shows a perspective view of two projecting devices 400 and 401 (of similar construction to device 400 of FIG. 41), side by side. First device 400 illuminates its visible image 220, while the second device 401 illuminates its visible image 221 and an infrared position indicator 297, on surface 224. Then in an example operation, device 400 may enable its image sensor (not shown) to observe the wide view region 230 containing the position indicator 297. An advantageous result occurs: The projected visible images 220 and 221 may be juxtaposed or even separated by a space on surface 224, yet the first device 400 can determine the position, orientation, and/or shape of indicator 297 and image 221 of the second device 401.

### Alternative Second Configuration—Infrared Projection and View

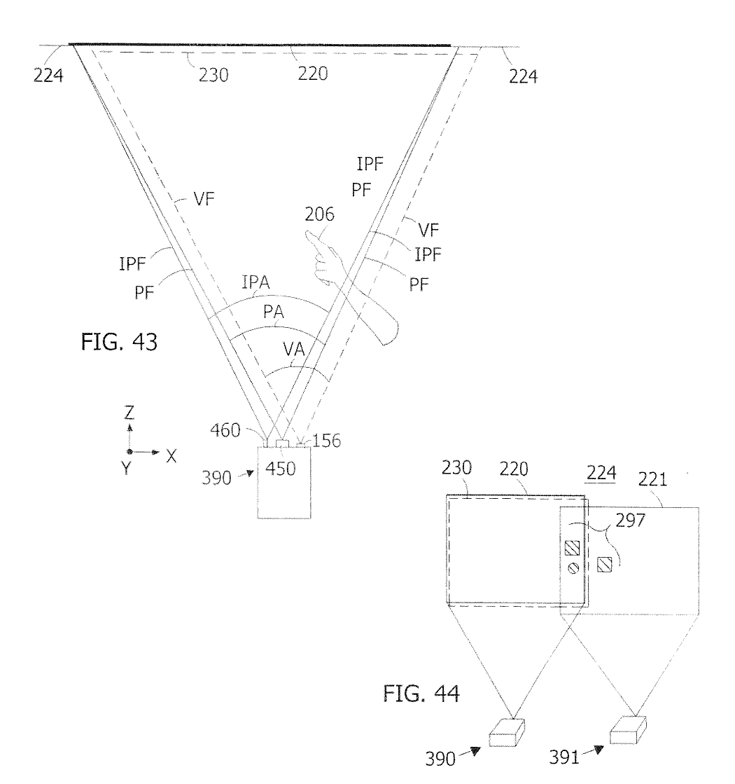

Turning now to FIG. 43, thereshown is a top view of a second configuration of an alternative projecting device 390, along with color image projector 450, infrared indicator projector 460, and infrared image sensor 156. Color image projector 450 illuminates visible image 220 on remote surface 224, such as a wall. Projector 450 may have a predetermined visible light projection angle PA creating a visible projection field PF. Moreover, infrared indicator projector 460 illuminates invisible infrared light on remote surface 224. Indicator projector 460 may have a predetermined infrared light projection angle IPA creating an infrared projection field IPF. As shown, the indicator projector's 460 infrared light projection angle IPA (e.g., 40 degrees) may be substantially similar to the image projector's 450 visible light projection angle PA (e.g., 40 degrees).

Further, image sensor 156 may have a predetermined light view angle VA and view field VF such that a view region 230 and remote objects, such as user hand 206, may be observable by device 390. As illustrated, the image sensor's 156 view angle VA (e.g., 40 degrees) may be substantially similar to the image projector's 450 projection angle PA and indicator projector's 460 projection angle IPA (e.g., 40 degrees). Such a configuration enables remote objects (such as a user hand 206 making a hand gesture) to enter the view field VF and projection fields PF and IPF at substantially the same time.

FIG. 44 shows a perspective view of two projecting devices 390 and 391 (of similar construction to device 390 of FIG. 43), side by side. First device 390 illuminates visible image 220, while second device 391 illuminates second visible image 221 and an infrared position indicator 297, on surface 224. Then in an example operation, device 390 may enable its image sensor (not shown) to observe view region 230 containing the position indicator 297. An advantageous result occurs: The first device 390 can determine the position, orientation, and/or shape of indicator 297 and image 221 of the second device 391.

### Illuminated Multi-Resolution Position Indicator

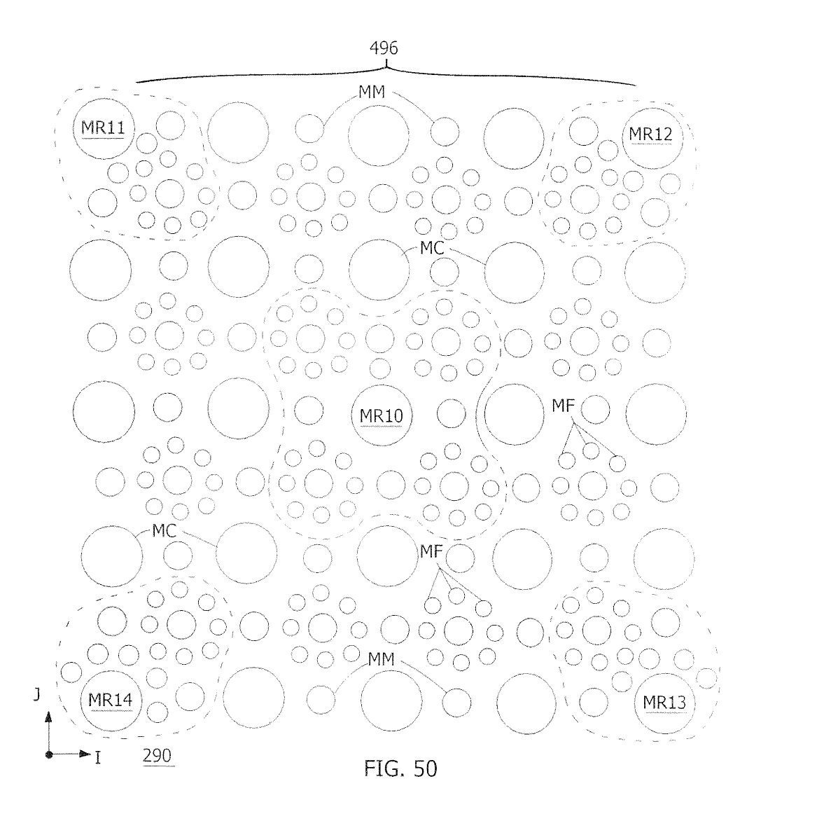

FIG. 48 shows a perspective view (with no user shown) of the handheld projecting device 400 illuminating the multi-resolution position indicator 496 onto multi-planar, remote surfaces 224-226. As presented, position indicator 496 is comprised of a predetermined infrared pattern of light projected by infrared indicator projector 460. Whereby, the infrared image sensor 156 may observe the position indicator 496 on surfaces 224-226. (For purposes of illustration, the position indicator 496 has been simplified in FIGS. 48-49, while FIG. 50 shows a more detailed view of position indicator 496.)

Continuing with FIG. 48, the multi-resolution position indicator 496 has similar capabilities to the previous multi-sensing position indicator (as shown in FIGS. 13-15). For the multi-resolution position indicator 496 includes a pattern of light that provides both surface aware and image aware information to device 400, but also provides multi-resolution, spatial sensing. Loosely packed, coarse-sized fiducial markers, such as coarse markers MC, may provide enhanced depth sensing accuracy (e.g., due to centroid accuracy) to remote surfaces. Moreover, densely packed, fine-sized fiducial markers, such as fine markers MF and medium markers MM, may provide enhanced surface resolution accuracy (e.g., due to high density across field of view) to remote surfaces.

FIG. 50 shows a detailed elevation view of the multi-resolution position indicator 496 on image plane 290 (which is shown only for purposes of illustration). As presented, each reference marker MR10, MR11, MR12, MR13, or MR14 provides a unique optical machine-discernible pattern of light. (For purposes of illustration, the imaginary dashed lines define the perimeters of reference markers MR10-MR14.)

The multi-resolution position indicator 496 may be comprised of at least one optical machine-discernible shape or pattern of light that is asymmetrical and/or has a one-fold rotational symmetry, such as reference marker MR10. Wherein, at least a portion of the position indicator 496 may be optical machine-discernible such that a position, rotational orientation, and/or shape of the position indicator 496 may be determined on a remote surface.

The multi-resolution position indicator 496 may be comprised of at least one optical machine-discernible shape or pattern of light such that one or more spatial distances may be determined to at least one remote surface and another handheld projecting device can determine the relative spatial position, rotational orientation, and/or shape of position indicator 496. Finally, the multi-resolution position indicator 496 may be comprised of a plurality of optical machine-discernible shapes of light with different sized shapes of light for enhanced spatial measurement accuracy.

Turning back to FIG. 48, during an example spatial sensing operation, device 400 and projector 460 may first illuminate the surrounding environment with position indicator 496, as shown. While the position indicator 496 appears on remote surfaces 224-226, the device 400 may enable image sensor 156 to capture an image frame of the view forward of sensor 156.

So thereshown in FIG. 49 is an elevation view of an example captured image frame 310 of the position indicator 496, wherein markers MC, MM, and MF are illuminated against an image background 314. (For purposes of illustration, the position indicator 496 appearance has been simplified in FIG. 49.)

### Operations of the Color-IR-Separated Handheld Projecting Device

The operations and capabilities of the color-IR-separated handheld projecting device 400, shown in FIGS. 38-50, may be substantially similar to the operations and capabilities of the previous embodiment of the color-IR handheld projecting device (shown in FIGS. 1-37). That is, the handheld projecting device 400 of FIGS. 38-50 may be surface aware, object aware, and/or image aware. For the sake of brevity, the reader may refer back to the previous embodiment's description of operations and capabilities to appreciate the device's advantages.

### Color-Interleave Handheld Projecting Device

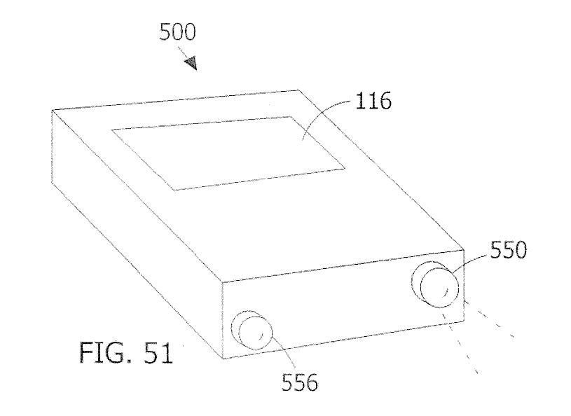

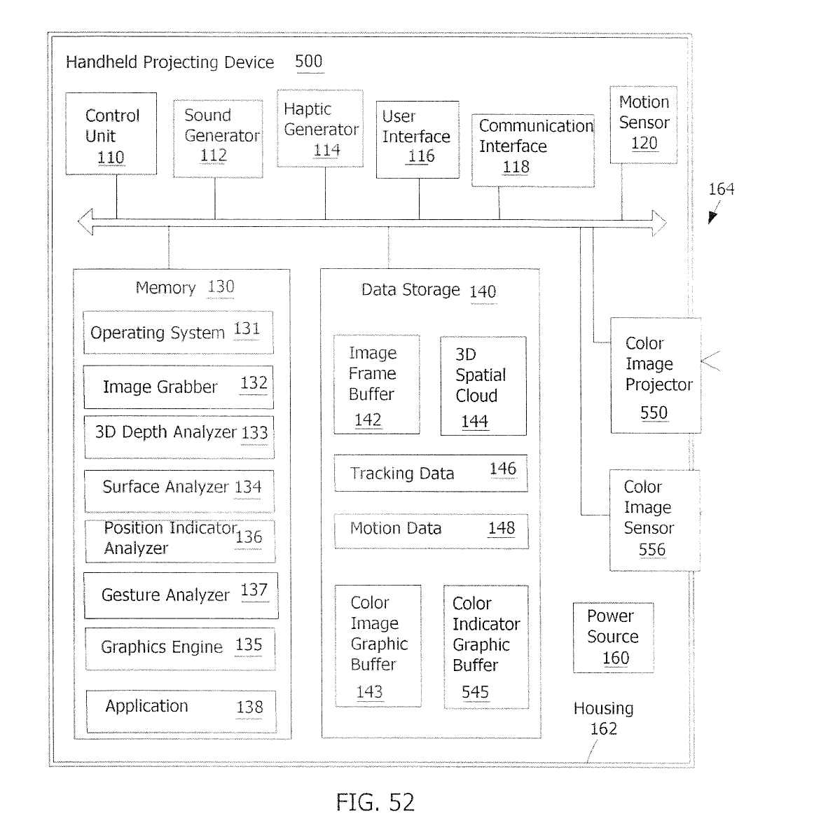

Turning now to FIG. 51, a perspective view of a third embodiment of the disclosure is presented, referred to as a color-interleave handheld projecting device 500, which may use visible light for its 3D depth and image sensing abilities. Though the projecting device 500 is similar to the previous color-IR projecting device (as shown earlier in FIGS. 1-37), there are some modifications.

Whereby, similar parts use similar reference numerals in the given Figures. As FIGS. 51 and 52 show, the color-interleave handheld projecting device 500 may be similar in construction to the previous color-IR projecting device (as shown in FIG. 1 and FIG. 3) except for, but not limited to, the following: the color-IR image projector has been replaced with a color image projector 550; the infrared image sensor has been replaced with a color image sensor 556, and the infrared indicator graphic buffer has been replaced with a color indicator graphic buffer 545, as shown in FIG. 52.

So turning to FIG. 52, a block diagram is presented of the components of the color-interleave handheld projecting device 500, which may be comprised of, but not limited to, outer housing 162, control unit 110, sound generator 112, haptic generator 114, user interface 116, communication interface 118, motion sensor 120, color image projector 550, color image sensor 556, memory 130, data storage 140, and power source 160. Most of the components may be constructed and function similar to the previous embodiment's components (as defined in FIG. 3). However, some components shall be discussed in greater detail.

### Color Image Projector

In FIG. 52, affixed to a front end 164 of device 500 is the color image projector 550, which may be operable to, but not limited to, project a “full-color” visible image (e.g., red, green, blue) and a substantially user-imperceptible position indicator of visible light on a nearby surface. Projector 550 may be operatively coupled to the control unit 110 such that the control unit 110, for example, may transmit graphic data to projector 550 for display. Projector 550 may be of compact size, such as a pico projector. Color image projector 550 may be comprised of a DLP-, a LCOS-, or a laser-based image projector, although alternative image projectors may be used as well. Advantages exist for the color image projector 550 to have a display frame refresh rate substantially greater than 100 Hz (e.g., 240 Hz) such that a substantially user-imperceptible position indicator of visible light may be generated, in some alternative embodiments, a color image projector and a color indicator projector may be integrated and integrally form the color image projector 550.

### Color Image Sensor

Also shown in FIG. 52, affixed to device 500 is the color image sensor 556, which is operable to detect a spatial view of at least visible light outside of device 100. Moreover, image sensor 556 may be operable to capture one or more image frames (or light views). Image sensor 556 is operatively coupled to control unit 110 such that control unit 110, for example, may receive and process captured image data. Color image sensor 556 may be comprised of at least one of a photo diode-, a photo detector-, a photo detector array-, a complementary metal oxide semiconductor (CMOS)-, a charge coupled device (CCD)-, or an electronic camera-based image sensor that is sensitive to at least visible light, although other types, combinations, and/or numbers of image sensors may be considered. In the current embodiment, the color image sensor 556 may be a CMOS- or CCD-based video camera that is sensitive to at least visible light (e.g., red, green, and blue). Advantages exist for the color image sensor 556 to have a shutter speed substantially less than 1/100 second (e.g., 1/240 second) such that a substantially user-imperceptible position indicator of visible light may be detected.

### Color Indicator Graphic Buffer

Also shown in FIG. 52, the color indicator graphic buffer 545 may provide data storage for visible (e.g., red, green, blue, etc.) indicator graphic information for projector 550. For example, application 138 may render off-screen graphics, such as a position indicator or barcode, in buffer 545 prior to visible light projection by projector 550.

### Operations of the Color-Interleave Handheld Projecting Device

Operations and capabilities of the color-interleave handheld projecting device 500, shown in FIGS. 51-53, may be substantially similar to the operations and capabilities of the previous embodiment of the color-IR handheld projecting device (shown in FIGS. 1-37). That is, the handheld projecting device 500 may be surface aware, object aware, and/or image aware. However, there are some operational differences.

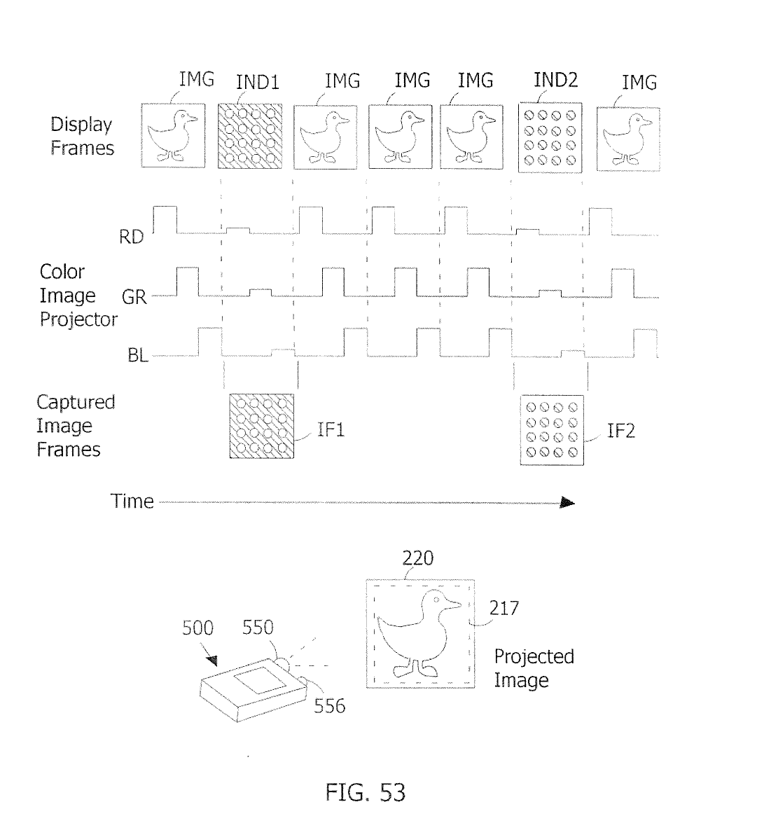

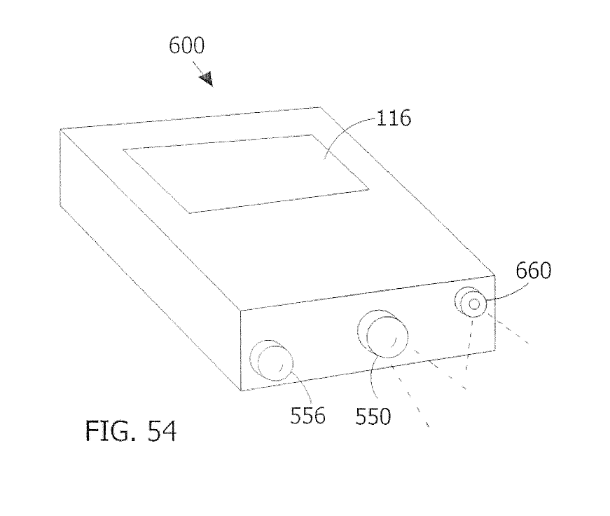

FIG. 53 presents a diagrammatic view of device 500 in operation, where a sequence of projected display frames and captured image frames occur over time. The projected display frames IMG, IND1, IND2 may be sequentially projected with visible light by the color image projector 550, creating a “full-color” visible image 220 and a substantially user-imperceptible position indicator 217. As can be seen, the image display frames IMG each contain color image graphics (e.g. a yellow duck). However, interleaved with frames IMG are indicator display frames IND1 and IND2, each containing indicator graphics (e.g., dark gray and black colored position indicators). Device 500 may achieve display interleaving by rendering image display frames IMG (in the image graphic buffer 143 of FIG. 52) and indicator display frames IND1 and IND2 (in the indicator graphic buffer 545 of FIG. 52). Whereupon, device 500 may transfer the display frames IMG, IND1, and IND2 to the color image projector (reference numeral 550 of FIG. 52) in a time coordinated, sequential manner (e.g., every 1/240 second for a color image projector having a 240 Hz display frame refresh rate).

Projector 550 may then convert the display frames IMG, IND1, and IND2 into light signals RD (red), GR (green), and BL (blue) integrated over time, creating the “full-color” visible image 220 and position indicator 217. Moreover, the graphics of one or more indicator display frames (e.g., reference numerals IND1 and IND2) may be substantially reduced in light intensity, such that when the one or more indicator display frames are illuminated, a substantially user-imperceptible position indicator 217 of visible light is generated. Further, the graphics of a plurality of indicator display frames (e.g., reference numerals IND1 and IND2) may alternate in light intensity, such that when the plurality of indicator display frames are sequentially illuminated, a substantially user-imperceptible position indicator 217 of visible light is generated.

Device 500 may further use its color image sensor 556 to capture at least one image frame IF1 (or IF2) at a discrete time interval when the indicator display frame IND1 (or IND2) is illuminated by the color image projector 550. Thus, device 500 may use computer vision analysis (e.g., as shown earlier in FIGS. 19-20) to detect a substantially user-imperceptible position indicator 217 of visible light.

### Color-Separated Handheld Projecting Device

Turning now to FIG. 54, a perspective view of a fourth embodiment of the disclosure is presented, referred to as a color-separated handheld projecting device 600, which may use visible light for its 3D depth and image sensing abilities. Though the projecting device 600 is similar to the previous color-interleave projecting device (as shown in FIGS. 51-53), there are some modifications.

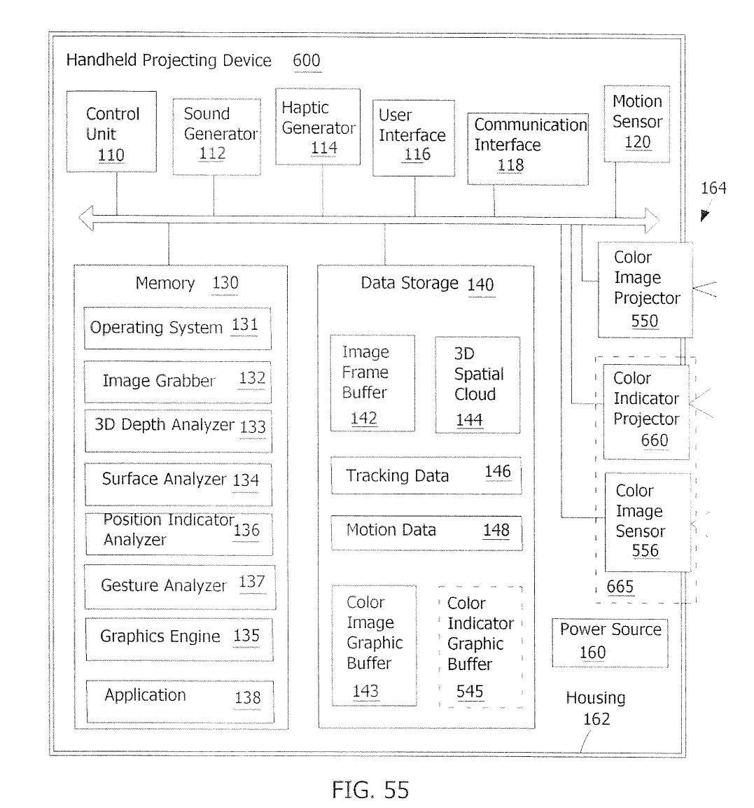

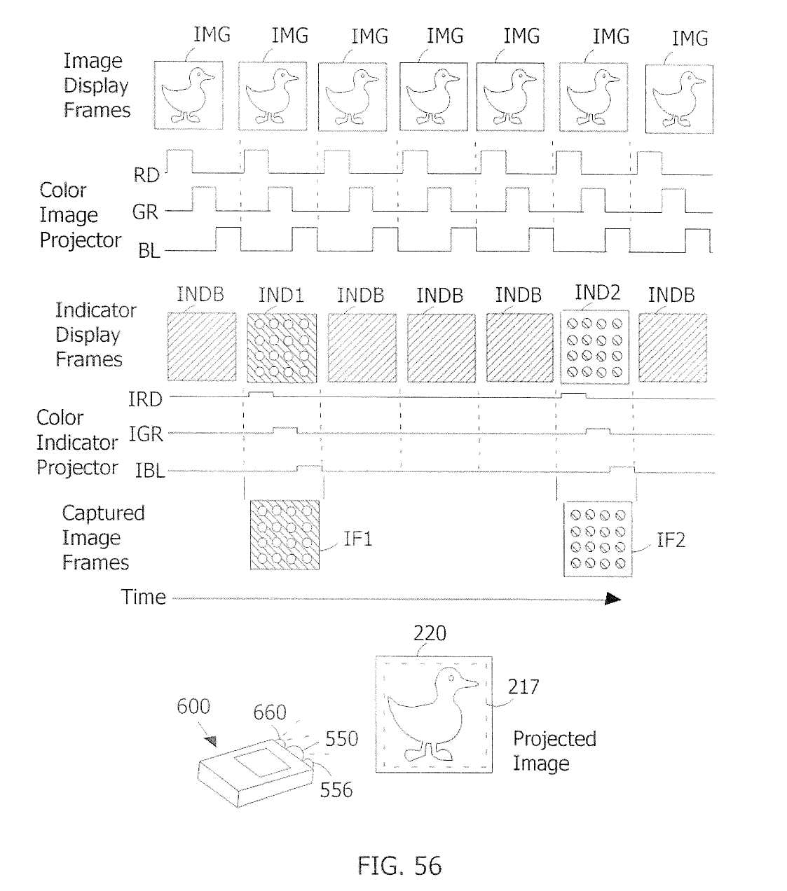

Similar parts use similar reference numerals in the given Figures. As shown by FIGS. 54 and 55, the color-separated handheld projecting device 600 may be similar in construction to the previous color-interleave projecting device (as shown in FIG. 51 and FIG. 52) except for, but not limited to, the following: a color indicator projector 660 has been added.

So turning to FIG. 55, a block diagram is shown of components of the color-separated handheld projecting device 500, which may be comprised of, but not limited to, outer housing 162, control unit 110, sound generator 112, haptic generator 114, user interface 116, communication interface 118, motion sensor 120, color image projector 550, color indicator projector 660, color image sensor 556, memory 130, data storage 140, and power source 160. Most of the components may be constructed and function similar to the previous embodiment's components (as defined in FIG. 52). However, some components shall be discussed in greater detail.

### Color Indicator Projector

In FIG. 55, affixed to a front end 164 of device 600 is the color indicator projector 660, which may be operable to, but not limited to, illuminate a position indicator of at least visible light (e.g., red, green, and/or blue) on a nearby surface. Indicator projector 660 may be operatively coupled to the control unit 110 such that the control unit 110, for example, may transmit indicator graphic data to projector 660 for display. Color indicator projector 660 may be comprised of, but not limited to, at least one of a light emitting diode, a laser diode, a DLP-based projector, a LCOS-based projector, or a laser-based projector that generates at least one visible pattern of light. Advantages exist for the indicator projector 660 to have a display frame refresh rate substantially greater than 100 Hz (e.g., 240 Hz) such that a substantially user-imperceptible position indicator of visible light may generated. In certain embodiments, the indicator projector 660 and color image sensor 556 may be integrated to form a 3D depth camera 665 (as denoted by the dashed line). In some embodiments, the color image projector 550 and the color indicator projector 660 may be integrated and integrally form a color image projector.

### Operations of the Color-Separated Handheld Projecting Device

Operations and capabilities of the color-separated handheld projecting device 600, shown in FIGS. 54-56, may be substantially similar to the operations and capabilities of the previous embodiment of the color-interleave handheld projecting device (shown in FIGS. 51-53). That is, the handheld projecting device 600 may be surface aware, object aware, and/or image aware. However, there are some operational differences.

FIG. 56 presents a diagrammatic view of device 600 in operation, where a sequence of projected display frames and captured image frames occur over time. The image display frames IMG may be sequentially projected by the color image projector 550 using visible light to create a “full-color” visible image 220. Moreover, the indicator display frames IND1, IND2, and INDB may be sequentially projected by the color indicator projector 660 using visible light to create a substantially user-imperceptible position indicator 217. As can be seen, the image display frames IMG each contain image graphics (e.g., yellow duck). Interleaved with frames IMG are indicator display frames IND1 and IND2, each containing indicator graphics (e.g., dark gray and black colored position indicators), while frame INDB includes no visible graphics (e.g., colored black). Device 600 may achieve display interleaving by rendering image frames IMG (in graphic buffer 143 of FIG. 55) and indicator frames IND1, IND2, INDB (in graphic buffer 545 of FIG. 55). Whereupon, device 600 may transfer image frames IMG to the color image projector 550 (i.e., every 1/240 second) and indicator frames IND1, IND2, INDB to the color indicator projector 660 (i.e., every 1/240 second) in a time coordinated manner.

Image projector 550 may then convert image frames IMG into light signals RD, GR, and BL, integrated over time to create the “full-color” visible image 220. Interleaved in time, indicator projector 660 may convert indicator frames IND1, IND2, INDB into light signals IRD, IGR, and IBL for illuminating the indicator 217. The graphics of one or more indicator display frames (e.g., reference numerals IND1 and IND2) may be substantially reduced in light intensity, such that when the one or more indicator display frames are illuminated, a substantially user-imperceptible position indicator 217 of visible light is generated. Further, the graphics of a plurality of indicator display frames (e.g., reference numerals IND1 and IND2) may alternate in light intensity, such that when the plurality of indicator display frames are sequentially illuminated, a substantially user-imperceptible position indicator 217 of visible light is generated.

Device 600 may further use its color image sensor 556 to capture at least one image frame IF1 (or IF2) at a discrete time interval when the indicator display frame IND1 (or IND2) is illuminated by indicator projector 660. Thus, device 600 may use computer vision analysis (e.g., as shown earlier in FIGS. 19-20) to detect a substantially user-imperceptible position indicator 217 of visible light.

### Summary of Handheld Projecting Devices

Design advantages of the color-IR-separated projecting device (as shown in FIGS. 38-50) may include, but not limited to, reduced cost, and potential use of off-the-shelf components, such as its color image projector. In contrast, design advantages of the color-IR projecting device (as shown in FIGS. 1-37) may include, but not limited to, reduced complexity with its integrated color-IR image projector. Yet design advantages of the color-interleaved device (shown in FIGS. 51-53) and color-separated device (shown in FIGS. 54-56) may include, but not limited to, lower cost due to color image projectors and color image sensors.

Advantages exist for some projecting device embodiments that use a single position indicator for the sensing of remote surfaces, remote objects, and/or projected images from other devices. Usage of a single position indicator (e.g., as illustrated in FIG. 15, 16, or 50) may provide, but not limited to, improved power efficiency and performance due to reduced hardware operations (e.g., fewer illuminated indicators required) and fewer software steps (e.g., fewer captured images to process). Alternatively, some projecting device embodiments that use multiple position indicators (e.g., as illustrated in FIGS. 17A and 17B) may provide, but not limited to, enhanced depth sensing accuracy.

Although projectors and image sensors may be affixed to the front end of projecting devices, alternative embodiments of the projecting device may locate the image projector, indicator projector, and/or image sensor at the device top, side, and/or other device location.

Due to their inherent spatial depth sensing abilities, embodiments of the projecting device do not require a costly, hardware-based range locator. However, certain embodiments may include at least one hardware-based range locator (e.g., ultrasonic range locator, optical range locator, etc.) to augment 3D depth sensing.

Some embodiments of the handheld projecting device may be integrated with and made integral to a mobile telephone, a tablet computer, a laptop, a handheld game device, a video player, a music player, a personal digital assistant, a mobile TV, a digital camera, a robot, a toy, an electronic appliance, or any combination thereof.

Finally, the handheld projecting device embodiments disclosed herein are not necessarily mutually exclusive in their construction and operation, for some alternative embodiments may be constructed that combine, in whole or part, aspects of the disclosed embodiments.

Various alternatives and embodiments are contemplated as being within the scope of the following claims particularly pointing out and distinctly claiming the subject matter regarded as the invention.

I claim:

1. A handheld projecting device, comprising:
an outer housing sized to be held by a user;
a control unit contained within the housing;
a color image projector operatively coupled to the control unit and operable to project a visible image generated by the control unit;
an indicator projector operatively coupled to the control unit and operable to project a position indicator onto an at least one remote surface, wherein the position indicator includes at least one reference marker having a one-fold rotational symmetry;
an image sensor operatively coupled to the control unit and operable to observe a spatial view of at least a portion of the position indicator; and
a depth analyzer operable to analyze the observed spatial view of the at least the portion of the position indicator and compute one or more surface distances to the at least one remote surface,
wherein the control unit modifies the visible image based upon the one or more surface distances such that the visible image adapts to the one or more surface distances to the at least one remote surface.

2. The device of claim 1 further comprising a surface analyzer operable to analyze the one or more surface distances and compute the locations of one or more surface points that reside on the at least one remote surface, wherein a position of the at least one remote surface is computable by the control unit,
wherein the control unit modifies the visible image based upon the position of the at least one remote surface such that the visible image adapts to the position of the at least one remote surface.

3. The device of claim 1 wherein the indicator projector is a color indicator projector that projects at least visible light, and the image sensor is a color image sensor that is sensitive to at least visible light.

4. The device of claim 1 wherein the indicator projector is an infrared indicator projector that projects at least infrared light, and the image sensor is an infrared image sensor that is sensitive to at least infrared light.

5. The device of claim 4 wherein the infrared image sensor has a light view angle that is substantially larger than a visible light projection angle of the color image projector.

6. The device of claim 4 wherein the color image projector and infrared indicator projector are integrated and integrally form a color-IR image projector.

7. The device of claim 1 wherein the device sequentially illuminates a plurality of position indicators having unique patterns of light onto the at least one remote surface.

8. The device of claim 1 wherein the position indicator is comprised of at least one of an optical machine-readable pattern of light that represents data, a 1D barcode, or a 2D barcode.

9. The device of claim 2 wherein the control unit modifies a shape of the visible image such that the shape of the visible image adapts to the position of the at least one remote surface.

10. The device of claim 2 wherein the control unit modifies the visible image such that at least a portion of the visible image appears substantially devoid of distortion on the at least one remote surface.

11. The device of claim 2 wherein the control unit modifies the visible image such that at least a portion of the visible image appears substantially uniformly lit on the at least one remote surface.

12. The device of claim 2 wherein the surface analyzer is operable to analyze the position of the at least one remote surface and compute a position of an at least one remote object, and wherein the control unit modifies the visible image projected based upon the position of the at least one remote object such that the visible image adapts to the position of the at least one remote object.

13. The device of claim 12 further comprising a gesture analyzer operable to analyze the at least one remote object and detect a hand gesture, wherein the control unit modifies the visible image based upon the detected hand gesture such that the visible image adapts to the hand gesture.

14. The device of claim 13 wherein the gesture analyzer is operable to analyze the at least one remote object and the at least one remote surface and detect a touch hand gesture, wherein the control unit modifies the visible image based upon the detected touch hand gesture such that the visible image adapts to the detected touch hand gesture.

15. A first handheld projecting device, comprising:
an outer housing sized to be held by a user;
a control unit affixed to the device;
a color image projector operatively coupled to the control unit, the color image projector being operable to project a visible image generated by the control unit;
an indicator projector operatively coupled to the control unit, the indicator projector being operable to project a first position indicator onto an at least one remote surface;
an image sensor operatively coupled to the control unit, the image sensor being operable to observe a spatial view; and
a position indicator analyzer operable to analyze the observed spatial view and detect the presence of a second position indicator from a second handheld projecting device,
wherein the control unit modifies the visible image projected by the color image projector based upon the detected second position indicator such that the visible image adapts to the detected second position indicator.

16. The first device of claim 15 further comprising a depth analyzer operable to analyze the observed spatial view of an at least portion of the first position indicator and compute one or more surface distances, wherein the control unit modifies the visible image based upon the one or more surface distances such that the visible image adapts to the one or more surface distances.

17. The device of claim 15 wherein the indicator projector is a color indicator projector that projects at least visible light, and the image sensor is a color image sensor that is sensitive to at least visible light.

18. The device of claim 15 wherein the indicator projector is an infrared indicator projector that projects at least infrared light, and the image sensor is an infrared image sensor that is sensitive to at least infrared light.

19. The first device of claim 18 wherein the infrared image sensor has a light view angle that is substantially larger than a visible light projection angle of the color image projector.

20. The first device of claim 18 wherein the color image projector and the infrared indicator projector are integrated and integrally form a color-IR image projector.

21. The first device of claim 15 wherein the second position indicator has a one-fold rotational symmetry such that the first device can determine a rotational orientation of the second position indicator.

22. The first device of claim 15 further comprising a wireless transceiver operable to communicate information with the second device.

23. The device of claim 16 further comprised of a surface analyzer that is operable to analyze one or more surface distances and compute the locations of one or more surface points that reside on the at least one remote surface, wherein a position of the at least one remote surface is computable by the control unit; and
wherein the control unit modifies the visible image based upon the position of the at least one remote surface such that the visible image adapts to the position of the at least one remote surface.

24. The device of claim 23 wherein the control unit modifies a shape of the visible image such that the shape of the visible image adapts to the position of the at least one remote surface.

25. The device of claim 23 wherein the control unit modifies the visible image such that at least a portion of the visible image appears substantially devoid of distortion on the at least one remote surface.

26. The device of claim 23 wherein the control unit modifies the visible image such that at least a portion of the visible image appears substantially uniformly lit on the at least one remote surface.

27. A method of integrating the operation of a first handheld projecting device and a second handheld projecting device, comprising the steps of:
generating a first image and a first position indicator from the first handheld projecting device;
operating an image sensor of the first handheld projecting device to detect the position of an at least one remote surface based upon the position of the first position indicator;
operating an image sensor of the second handheld projecting device to detect the position of the first image based upon the position of the first position indicator;
generating a second image and a second position indicator from the second handheld projecting device;
operating an image sensor of the second handheld projecting device to detect the position of the at least one remote surface based upon the position of the second position indicator;
operating an image sensor of the first handheld projecting device to detect the position of the second image based upon the position of the second position indicator;
modifying a first image from the projector of the first handheld projecting device based upon the determined position of the at least one remote surface and the position of the second image; and
modifying a second image from a projector of the second handheld projecting device based upon the determined position of the at least one remote surface and the position of the first image.

28. The method of claim 27 further comprising the steps of:
modifying the first image of the first handheld projecting device such that the first image appears substantially devoid of distortion on the at least one remote surface;
and modifying the second image of the second handheld projecting device such that the second image appears substantially devoid of distortion on the at least one remote surface.
